(19) United States
(12) Patent Application Publication
(10) Pub. No.: US 2015/0233721 A1
(43) Pub. Date: Aug. 20, 2015

(54) COMMUNICATION SYSTEM

(71) Applicant: FUJITSU TEN LIMITED, Kobe-shi (JP)

(72) Inventors: Fumiaki KISO, Kobe-shi (JP); Daisuke YAMASAKI, Kobe-shi (JP); Minoru MAEHATA, Kobe-shi (JP); Shizuka TAMURA, Kobe-shi (JP); Yoshitaka HIRASHIMA, Kobe-shi (JP); Toshio KITAHARA, Kobe-shi (JP); Toshihiro MURATA, Kobe-shi (JP)

(21) Appl. No.: 14/622,279

(22) Filed: Feb. 13, 2015

(30) Foreign Application Priority Data
Feb. 17, 2014 (JP) 2014-027935
Nov. 14, 2014 (JP) 2014-231424

(51) Int. Cl. G01C 21/26; G01C 21/00; G06T 11/60

(52) U.S. Cl. CPC G01C 21/26; G06T 11/60; G01C 21/005

(57) ABSTRACT

An electronic system includes: a display controller that causes display, on a screen of the mobile communication terminal, of an image corresponding to a position of the mobile communication terminal on a virtual wide-area image that is a virtual image wider than a display range of the electronic apparatus; a detector that detects a positional relationship between a displayed image on the electronic apparatus and a displayed image on the mobile communication terminal; and a generator that generates a position indicating image that shows the positional relationship between the displayed image on the electronic apparatus and the displayed image on the mobile communication terminal. The display controller also causes display of the position indicating image on the screen of the mobile communication terminal.

### BACKGROUND OF THE INVENTION

1. Field of the Invention

The invention relates to a technology of communication between a mobile communication terminal and an electronic apparatus.

2. Description of the Background Art

Due to diversified functions of an electronic apparatus, recently, a user often needs to perform a complicated operation with the electronic apparatus to give a desired command. Therefore, there is a need for a technology that enables the user to easily operate the electronic apparatus.

Especially, the user sometimes needs to operate a vehicle-mounted apparatus, an electronic apparatus mounted on a vehicle, in a relatively short time period. For example, while being stopping at a red light, the user needs to operate the vehicle-mounted apparatus, paying attention to a situation around the vehicle. Therefore, the technology is especially needed that enables users to operate the vehicle-mounted apparatuses with easy operation to give various commands.

Thus, a technology that enables the electronic apparatuses to detect motions (gestures) of a hand of the user as input operations and to perform predetermined processes based on the motion of the user, is proposed. Generally, such an electronic apparatus is configured to capture and acquire an image of a specific area by a fixed camera and to detect the motions of the user based on the acquired captured images.

The electronic apparatus that detects the motions of the user, as mentioned above, is configured to detect the motions of the user performed in a limited area in order to prevent misdetection. Therefore, generally, users other than the user intended to use the electronic apparatus mainly (hereinafter referred to as “main user”) cannot operate the electronic apparatus by moving, for example, a hand.

For example, in a case where a vehicle-mounted apparatus is configured to detect motions of a hand of a driver in a driver's seat in the vehicle (e.g. motions of the hand in an area near a steering wheel), a user in a passenger's seat or in a backseat cannot operate the vehicle-mounted apparatus by moving a hand.

Therefore, there is a need for a technology that enables the user other than the main user to cause the electronic apparatus to perform predetermined processes by the motion.

Moreover, there is a case where the user other than the main user desires to see a region other than a region currently displayed as a content on the electronic apparatus. For example, when the vehicle-mounted apparatus displays a map showing a region near a current location of the vehicle (hereinafter referred to as current location), there is a case where the user other than the driver desires to see a region of the map other than the current location (e.g. region near a destination) (hereinafter referred to as “different region”). In this case, if the user scrolls the map to display the different region on the map on the vehicle-mounted apparatus, the driver cannot see the region near the current location and driving of the driver may be adversely affected.

Therefore, a technology that enables the user other than the main user to see a desired region included in the content without affecting the content displayed on the electronic apparatus, is demanded.

### SUMMARY OF THE INVENTION

According to one aspect of the invention, an electronic system includes: a display controller that causes display, on a screen of the mobile communication terminal, of an image corresponding to a position of the mobile communication terminal on a virtual wide-area image that is a virtual image wider than a display range of the electronic apparatus; a detector that detects a positional relationship between a displayed image on the electronic apparatus and a displayed image on the mobile communication terminal; and a generator that generates a position indicating image that shows the positional relationship between the displayed image on the electronic apparatus and the displayed image on the mobile communication terminal. The display controller also causes display of the position indicating image on the screen of the mobile communication terminal.

Since the image that shows the positional relationship between the displayed image on the electronic apparatus and the displayed image on the mobile communication terminal, is displayed, a user can understand the positional relationship between the displayed image on the electronic apparatus and the displayed image on the mobile communication terminal and can operate the electronic apparatus by moving the mobile communication terminal to a desired position.

Therefore, an object of the invention is to provide a technology that allows a user to cause an electronic apparatus to perform a desired process by a motion and thus to improve operability of the electronic apparatus.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an outline of a communication system in a first embodiment.

FIG. 2 illustrates a configuration of the communication system in the first embodiment.

FIG. 3 illustrates a vehicle-mounted apparatus working independently in the first embodiment.

FIG. 4 illustrates a linked operation between the vehicle-mounted apparatus and a mobile communication terminal in the first embodiment.

FIG. 5 illustrates an example of a wide-area map in the first embodiment.

FIG. 6 illustrates a flow of a process of the linked operation in the first embodiment.

FIG. 7 illustrates a flow of an initial position setting process in the first embodiment.

FIG. 8 illustrates a flow of a linked display process in the first embodiment.

FIG. 9 illustrates a linked operation between a vehicle-mounted apparatus and a mobile communication terminal in a second embodiment.

FIG. 10 illustrates a flow of an initial position setting process in a third embodiment.

FIG. 11 illustrates an example of a wide-area map in a fourth embodiment.

FIG. 12 illustrates a linked operation between a vehicle-mounted apparatus and a mobile communication terminal in a fifth embodiment.

FIG. 13 illustrates an example of a wide-area map in the fifth embodiment.

FIG. 14 illustrates a flow of a linked display process in the fifth embodiment.

FIG. 15 illustrates a configuration of a communication system in a sixth embodiment.

FIG. 16 illustrates a flow of an initial position setting process in the sixth embodiment.

FIG. 17 illustrates a setting image displayed on a vehicle-mounted apparatus in the sixth embodiment.

FIG. 18 illustrates a flow of a linked display process in the sixth embodiment.

FIG. 19 illustrates a configuration of a communication system in a seventh embodiment.

FIG. 20 illustrates a linked operation between a vehicle-mounted apparatus and a mobile communication terminal in the seventh embodiment.

FIG. 21 illustrates the linked operation between the vehicle-mounted apparatus and the mobile communication terminal in the seventh embodiment.

FIG. 22 illustrates a flow of a process of the linked operation in the seventh embodiment.

FIG. 23 illustrates a configuration of a communication system in an eighth embodiment.

FIG. 24 illustrates a flow of a process of a linked operation in the eighth embodiment.

FIG. 25A illustrates a function of displaying a position of a mobile communication terminal.

FIG. 25B illustrates the function of displaying a position of the mobile communication terminal.

FIG. 25C illustrates the function of displaying a position of the mobile communication terminal.

FIG. 26A illustrates a flow of a process that implements the function of displaying a position of the mobile communication terminal.

FIG. 26B illustrates a flow of a process that implements the function of displaying a position of the mobile communication terminal.

FIG. 27 illustrates an adjusting function of move of the mobile communication terminal and a map.

FIG. 28A illustrates a flow of a process that implements the adjusting function of move of the mobile communication terminal and the map.

FIG. 28B illustrates a flow of a process that implements the adjusting function of move of the mobile communication terminal and the map.

FIG. 29A illustrates a function of fixing a screen of the mobile communication terminal.

FIG. 29B illustrates the function of fixing the screen of the mobile communication terminal.

FIG. 30 illustrates a flow of a process that implements the function of fixing the screen of the mobile communication terminal.

FIG. 31A illustrates a function of linking scales of the vehicle-mounted apparatus and of the mobile communication terminal.

FIG. 31B illustrates the function of linking the scales of the vehicle-mounted apparatus and of the mobile communication terminal.

FIG. 32A illustrates a flow of a process that implements the function of linking the scales of the vehicle-mounted apparatus and of the mobile communication terminal.

FIG. 32B illustrates a flow of a process that implements the function of linking the scales of the vehicle-mounted apparatus and of the mobile communication terminal.

FIG. 33 illustrates a function of displaying a screen according to an inclination of the mobile communication terminal.

FIG. 34A illustrates a flow of a process that implements the function of displaying the screen according to an inclination of the mobile communication terminal.

FIG. 34B illustrates a flow of a process that implements the function of displaying the screen according to an inclination of the mobile communication terminal.

FIG. 35 illustrates a function of adjusting a size of an image on the mobile communication terminal.

FIG. 36A illustrates a flow of a process that implements the function of adjusting a size of an image on the mobile communication terminal.

FIG. 36B illustrates a flow of a process that implements the function of adjusting a size of an image on the mobile communication terminal.

FIG. 37 illustrates a function of a return operation.

FIG. 38 illustrates a flow of a process that implements the function of the return operation.

FIG. 39 illustrates a flow of a process that implements the function performed when mobile communication terminal and vehicle-mounted apparatus come into contact with each other.

FIG. 40 illustrates an outline of a communication system in a tenth embodiment.

FIG. 41 illustrates a configuration of the communication system in the tenth embodiment.

FIG. 42 illustrates a vehicle-mounted apparatus working independently in the tenth embodiment.

FIG. 43 illustrates a linked operation between the vehicle-mounted apparatus and a mobile communication terminal.

FIG. 44 illustrates a linked operation between the vehicle-mounted apparatus and a mobile communication terminal in the tenth embodiment.

FIG. 45 illustrates an example of a wide-area map in the tenth embodiment.

FIG. 46 illustrates a flow of a process of a communication system in the tenth embodiment.

FIG. 47 illustrates a flow of an initial position setting process in the tenth embodiment.

FIG. 48 illustrates a flow of a linked display process in the tenth embodiment.

FIG. 49 illustrates a state where spots are input on a vehicle-mounted apparatus in an eleventh embodiment.

FIG. 50 illustrates a linked operation between the vehicle-mounted apparatus and a mobile communication terminal in the eleventh embodiment.

FIG. 51 illustrates a configuration of a communication system in the eleventh embodiment.

FIG. 52 illustrates a flow of a process of the communication system in the eleventh embodiment.

FIG. 53 illustrates a flow of a process of the communication system in the eleventh embodiment.

FIG. 54 illustrates a linked operation between a vehicle-mounted apparatus and a mobile communication terminal in a twelfth embodiment.

FIG. 55 illustrates a configuration of a communication system in the twelfth embodiment.

FIG. 56 illustrates a flow of a process of the communication system in the twelfth embodiment.

FIG. 57 illustrates a flow of a process of the communication system in the twelfth embodiment.

FIG. 58 illustrates a linked operation between a vehicle-mounted apparatus and a mobile communication terminal in a thirteenth embodiment.

FIG. 59 illustrates a configuration of a communication system in the thirteenth embodiment.

FIG. 60 illustrates a flow of a process of the communication system in the thirteenth embodiment.

FIG. 61 illustrates a flow of a process of the communication system in the thirteenth embodiment.

FIG. 62 illustrates a linked operation between a vehicle-mounted apparatus and a mobile communication terminal in a fourteenth embodiment.

FIG. 63 illustrates a configuration of a communication system in the fourteenth embodiment.

FIG. 64 illustrates a flow of a process of the communication system in the fourteenth embodiment.

FIG. 65 illustrates a flow of a process of the communication system in the fourteenth embodiment.

FIG. 66 illustrates a content displayed on a display of a vehicle-mounted apparatus in a fifteenth embodiment.

FIG. 67 illustrates a linked operation in a sixteenth embodiment.

FIG. 68 illustrates the linked operation in the sixteenth embodiment.

FIG. 69 illustrates a linked operation in a seventeenth embodiment.

### DESCRIPTION OF THE EMBODIMENTS

Embodiments of the invention are hereinafter explained with reference to the drawings.

### 1. First Embodiment

### 1-1. Outline of System

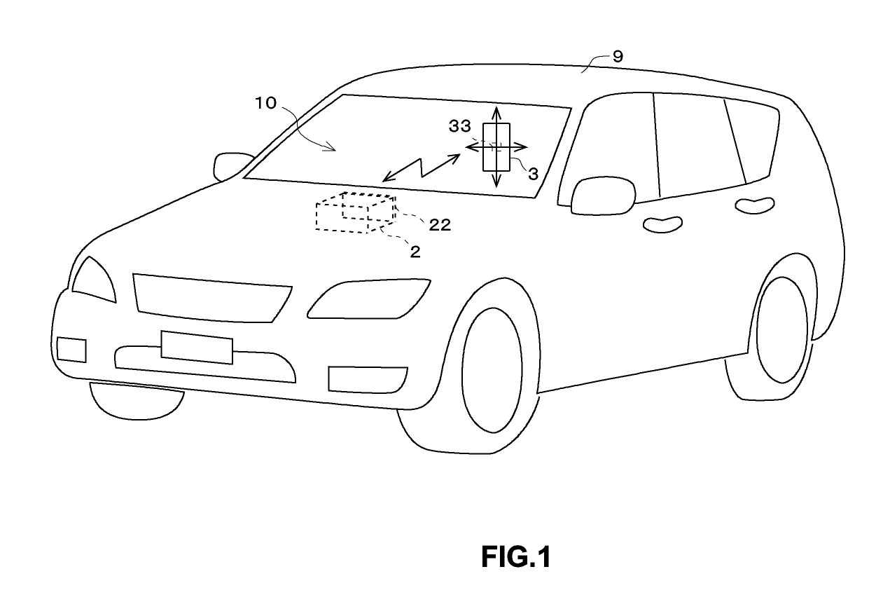

FIG. 1 illustrates an outline of a communication system 10 in this embodiment. The communication system 10 includes a vehicle-mounted apparatus 2 that is mounted on a vehicle 9, such as a car, and a mobile communication terminal 3 that is configured separately from the vehicle-mounted apparatus 2. The vehicle-mounted apparatus 2 and the mobile communication terminal 3 are configured to be linked to each other to work.

Each of the vehicle-mounted apparatus 2 and the mobile communication terminal 3 includes a wireless communication function that uses a predetermined communication method, such as Bluetooth (registered trademark). Thus, the vehicle-mounted apparatus 2 and the mobile communication terminal 3 are configured to send and receive signals to/from each other via the wireless communication. The vehicle-mounted apparatus 2 and the mobile communication terminal 3 may be physically connected by a cable and may send and receive signals to/from each other via cable communication.

The vehicle-mounted apparatus 2 is an electronic apparatus that is fixed in a cabin of the vehicle 9 and includes a display 22 that displays various images. The vehicle-mounted apparatus 2 is, for example, a navigation apparatus that includes a navigation function of providing a route leading to a destination set by a user. An intended main user of the vehicle-mounted apparatus 2 is a driver in a driver's seat of the vehicle 9. Therefore, the vehicle-mounted apparatus 2 is disposed in a dashboard located in a front side of the cabin of the vehicle 9 such that mainly the driver can see a screen of the display 22.

The mobile communication terminal 3 is a portable communication terminal that can be held and used by the user and includes a phone function. For example, the mobile communication terminal 3 is a smartphone or a mobile phone that is used daily by the user. The mobile communication terminal 3 is mainly used by a user, other than the driver, in a passenger's seat or a backseat of the vehicle 9.

The mobile communication terminal 3 includes a motion sensor 33 and is configured to detect a motion, such as a move and a rotation, of the mobile communication terminal 3. In a case where the vehicle-mounted apparatus 2 and the mobile communication terminal 3 are linked to each other to work, the motion sensor 33 of the mobile communication terminal 3 detects the motion of the mobile communication terminal 3 held and moved (hereinafter referred to as “move(d) in hand) by the user. Then, the mobile communication terminal 3 sends to the vehicle-mounted apparatus 2 a terminal signal representing the detected motion of the mobile communication terminal 3. Once receiving the terminal signal, the vehicle-mounted apparatus 2 performs a process corresponding to the motion of the mobile communication terminal 3 based on the received terminal signal. Therefore, the user can cause the vehicle-mounted apparatus 2 to perform a predetermined process by moving the mobile communication terminal 3.

A configuration and a process of the communication system 10 mentioned above are explained in detail below.

### 1-2. Configuration of System

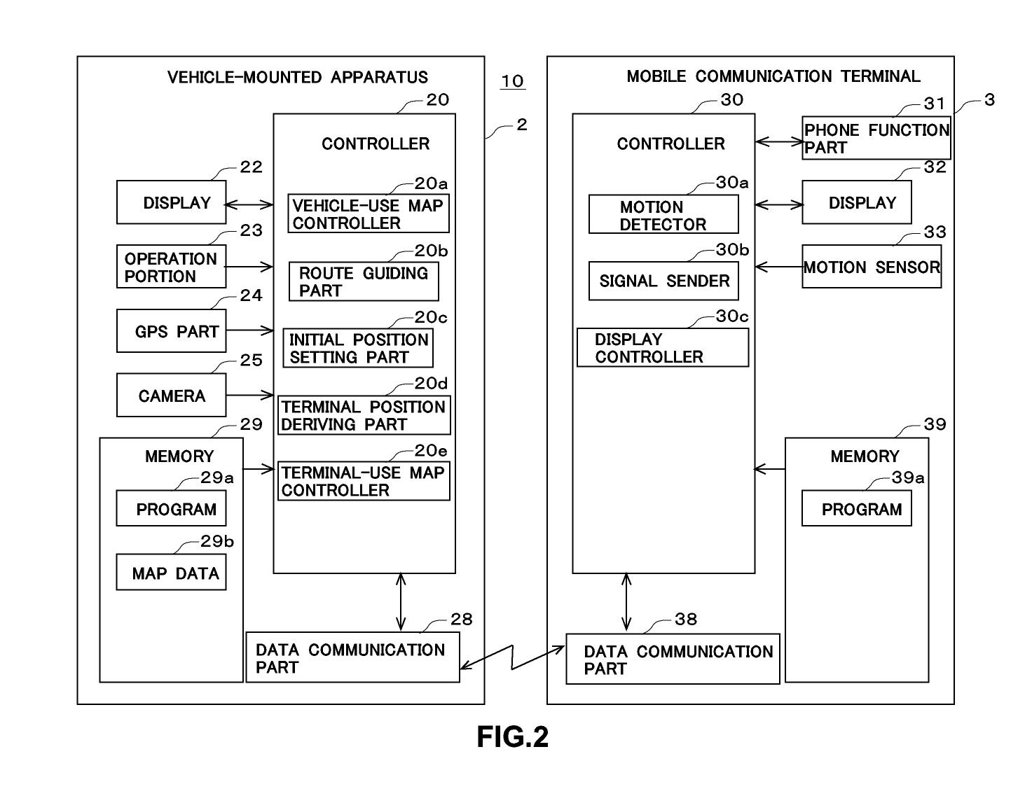

FIG. 2 illustrates the configuration of the communication system 10. A left portion of FIG. 2 illustrates a configuration of the vehicle-mounted apparatus 2 and a right portion of FIG. 2 illustrates a configuration of the mobile communication terminal 3.

The vehicle-mounted apparatus 2 includes a controller 20, the display 22, an operation portion 23, a GPS part 24, a camera 25, a data communication part 28 and a memory 29. The controller 20 is a microcomputer that includes a CPU, a RAM, a ROM and/or the like and that controls the entire vehicle-mounted apparatus 2.

The display 22 includes, for example, a liquid crystal panel and displays the various images. Moreover, the display 22 includes a touch panel and functions as an operation receiving portion that receives a user operation. In a case where the user operates the display 22 functioning as the touch panel, a signal representing a content of the user operation is input to the controller 20.

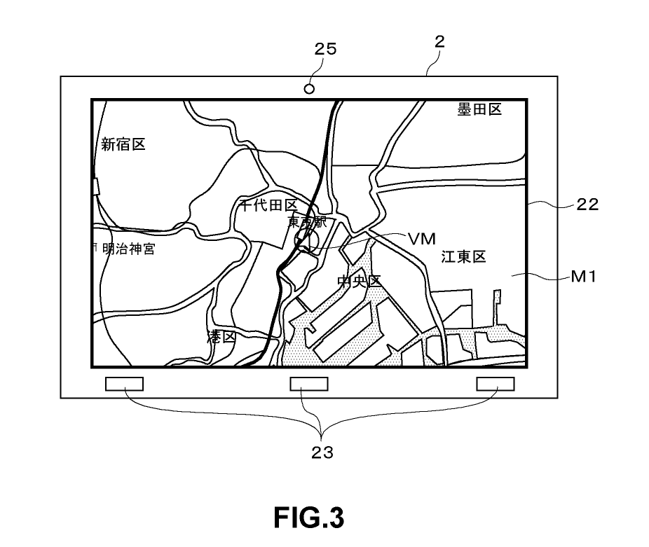

The operation portion 23 is an operation receiving portion that receives a user operation directly. The operation portion 23 includes, for example, plural operation buttons disposed below the screen of the display 22 (refer to FIG. 3). In a case where the user operates the operation portion 23, a signal representing a content of the user operation is input to the controller 20.

The GPS part 24 acquires a location where the vehicle-mounted apparatus 2 is currently located (absolute position on the earth) by receiving signals from plural GPS satellites. The vehicle-mounted apparatus 2 is mounted on the vehicle 9. Therefore, practically, the GPS part 24 acquires a location where the vehicle 9 is currently located. The location, acquired by the GPS part 24, where the vehicle 9 is currently located is hereinafter referred to as “current location.” The current location acquired by the GPS part 24 is represented, for example, by latitude and longitude and can be used also as information for defining a position of the vehicle 9 on a map.

The camera 25 includes a lens and an image sensor. The camera 25 captures an image of an object and electronically acquires the captured image. The camera 25 is provided, for example, above the screen of the display 22 (refer to FIG. 3). Therefore, the camera 25 captures an image of an object existing in front of the screen of the display 22 and acquires the captured image including the image of the object.

The data communication part 28 sends and receives signals to/from the mobile communication terminal 3 via the wireless communication based on the predetermined communication method. The data communication part 28 receives from the mobile communication terminal 3 the terminal signal representing the motion of the mobile communication terminal 3. Moreover, the data communication part 28 sends to the mobile communication terminal 3 an image to be displayed on the mobile communication terminal 3.

The memory 29 is, for example, a non-volatile memory, such as a flash memory, and stores various information. The memory 29 stores, for example, a program 29a that is executable by the controller 20 and map data 29b that is used for the navigation function and the like. Processing parts including various functions, such as the navigation function, are implemented in the controller 20 by software by the CPU of the controller 20 performing arithmetic processing based on the program 29a.

A vehicle-use map controller 20a, a route guiding part 20b, an initial position setting part 20c, a terminal position deriving part 20d and a terminal-use map controller 20e, shown in FIG. 2, are a part of the processing parts that are implemented by software by execution of the program 29a.

The vehicle-use map controller 20a generates the map used in the vehicle 9 (hereinafter referred to as vehicle-use map) that is to be displayed on the display 22 of the vehicle-mounted apparatus 2 and causes the display 22 to display the map. The vehicle-use map controller 20a generates the vehicle-use map including the current location, using the map data 29b stored in the memory 29. The vehicle-use map controller 20a controls the display 22 to display the generated vehicle-use map.

The route guiding part 20b provides the route leading to the destination. The route guiding part 20b derives the route leading to the destination from the current location, using the map data 29b stored in the memory 29 and superimposes the derived route on the vehicle-use map generated by the vehicle-use map controller 20a. Thus, the route leading to the destination is provided to the user.

Each of the initial position setting part 20c, the terminal position deriving part 20d and the terminal-use map controller 20e performs a process relating to an operation performed by linked work between the vehicle-mounted apparatus 2 and the mobile communication terminal 3. The processes that are performed by the initial position setting part 20c, the terminal position deriving part 20d and the terminal-use map controller 20e will be described later in detail.

The mobile communication terminal 3 includes a controller 30, a phone function part 31, a display 32, the motion sensor 33, a data communicating part 38 and a memory 39. The controller 30 is a microcomputer that includes a CPU, a RAM, a ROM and/or the like and controls the entire mobile communication terminal 3.

The phone function part 31 implements the phone function of the mobile communication terminal 3. The phone function part 31 converts voice of the user in conversation into electrical signals and sends the signals to a base station. Moreover, the phone function part 31 receives from the base station audio signals representing audio from a person who has conversation with the user and outputs the sound.

The display 32 includes, for example, a liquid crystal panel and displays various images. Moreover, the display 32 includes a touch panel and also functions as an operation receiving portion that receives a user operation. In a case where the user operates the display 32 functioning as the touch panel, a signal representing a content of the user operation is input to the controller 30.

The motion sensor 33 detects the motion of the mobile communication terminal 3. The motion sensor 33 is, for example, a 6-axis sensor that is configured to detect accelerations in directions of three axes and angular speeds around the three axes. More specifically, in a case of an XYZ Cartesian coordinate system, the motion sensor 33 is configured to detect a move in each direction of an X-axis, a Y-axis and a Z-axis (accelerations along the three axes) and a rotation about each of the X-axis, the Y-axis and the Z-axis (angular speeds around the three axes). In a case where an angular speed acts on an object moving at a speed, a fictitious force (the Coriolis effect) is generated. Moreover, in a case where an acceleration acts on an object, a force is generated (Newton's laws). The motion sensor 33 detects the accelerations and the angular speeds along/around the three axes based on these principles.

The data communicating part 38 sends and receives signals to/from the vehicle-mounted apparatus 2 via the wireless communication based on the predetermined communication method. The data communicating part 38 sends to the vehicle-mounted apparatus 2 the terminal signal representing the motion of the mobile communication terminal 3. Moreover, the data communicating part 38 receives the image to be displayed on the mobile communication terminal 3 from the vehicle-mounted apparatus 2.

The memory 39 is, for example, a non-volatile memory, such as a flash memory, and stores various information. The memory 39 stores, for example, a program 39a of an application that is executable by the controller 30. Processing parts including various functions are implemented in the controller 30 by software by the CPU of the controller 30 performing arithmetic processing based on the program 39a.

A motion detector 30a, a signal sender 30b and a display controller 30c, shown in FIG. 2, are a part of the processing parts that are implemented by software by execution of the program 39a.

The motion detector 30a controls the motion sensor 33 to acquire a sensor signal representing the motion of the mobile communication terminal 3 from the motion sensor 33. The sensor signal represents the accelerations and the angular speeds along/around the three axes. The signal sender 30b controls the data communicating part 38 to send the sensor signal acquired by the motion detector 30a, as the terminal signal, to the vehicle-mounted apparatus 2.

Moreover, the display controller 30c controls the display 32 to display on the display 32 the image that the data communicating part 38 receives from the vehicle-mounted apparatus 2.

The processes that are performed by the motion detector 30a, the signal sender 30b and the display controller 30c will be described later in detail.

### 1-3. Outline of Linked Operation

Next explained is an outline of an operation performed by the linked work of the vehicle-mounted apparatus 2 and the mobile communication terminal 3 (hereinafter referred to as linked operation) in the communication system 10.

FIG. 3 illustrates the vehicle-mounted apparatus 2 working independently without being linked with the mobile communication terminal 3. As shown in FIG. 3, the display 22 of the vehicle-mounted apparatus 2 displays a vehicle-use map M1.

The vehicle-use map M1 is a map showing a region including the current location (the location where the vehicle 9 is currently located). The current location is shown in a center of the vehicle-use map M1 and a host vehicle mark VM representing the current location of the vehicle 9 is positioned in the center. Therefore, the host vehicle mark VM is shown in a center of the screen of the display 22 that displays the vehicle-use map M1.

The user (mainly the driver of the vehicle 9) can see the map showing a region around the current location by seeing the vehicle-use map M1 displayed on the display 22 as described above. In a case of an example shown in FIG. 3, the current location is near “Tokyo Station” and the vehicle-use map M1 having “Tokyo Station” substantially in the center is displayed on the display 22 of the vehicle-mounted apparatus 2.

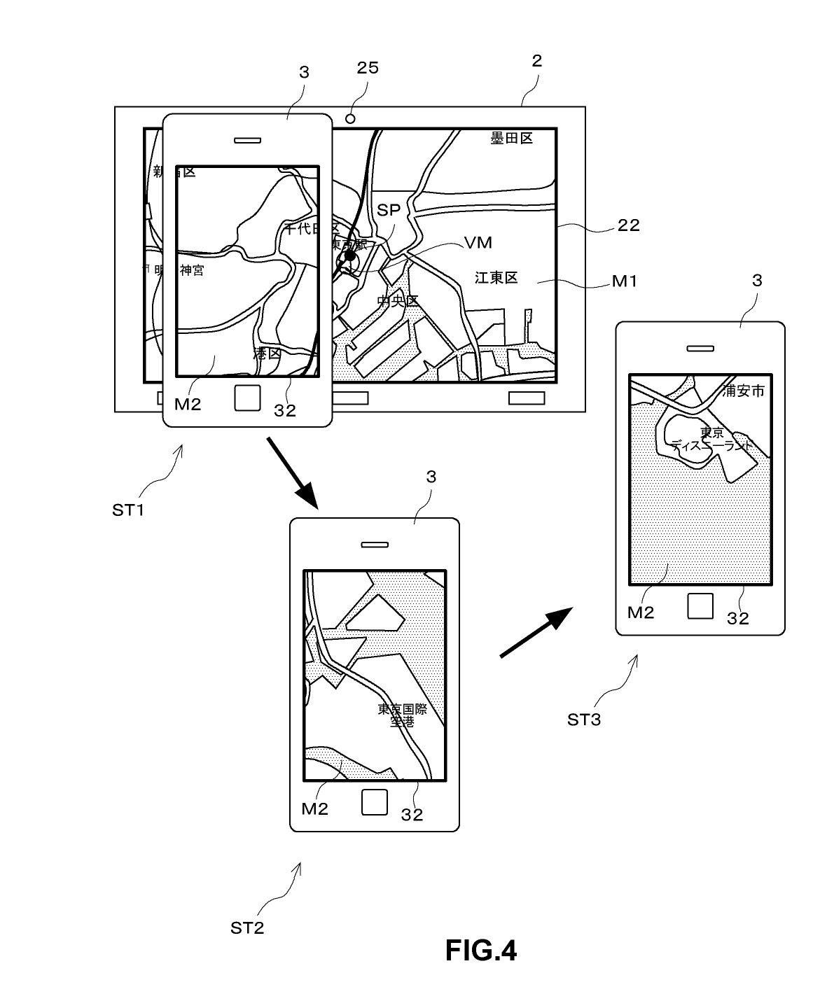

FIG. 4 illustrates the linked operation between the vehicle-mounted apparatus 2 and the mobile communication terminal 3 in a case where the current location is the same as the current location in FIG. 3. In this case, too, the display 22 of the vehicle-mounted apparatus 2 displays the vehicle-use map M1 showing the region including the current location.

On the other hand, the display 32 of the mobile communication terminal 3 displays a map showing a region different from the vehicle-use map M1 (hereinafter referred to as “terminal-use map”) M2 on a same map scale used for the vehicle-use map M1. The terminal-use map M2 is a map showing a region corresponding to a relative position of the mobile communication terminal 3 to a position of the vehicle-mounted apparatus 2. Therefore, in a case where the user moves the mobile communication terminal 3 in hand, the region included in the terminal-use map M2 displayed on the display 32 varies depending on the motion of the mobile communication terminal 3.

In a case where the mobile communication terminal 3 is moved substantially parallel to the screen of the display 22 of the vehicle-mounted apparatus 2, the mobile communication terminal 3 scrolls the terminal-use map M2 based on the motion and displays the scrolled terminal-use map M2. A scrolled amount of the terminal-use map M2 is approximately the same as an actually-moved distance of the mobile communication terminal 3. Moreover, a direction in which the terminal-use map M2 is scrolled is approximately the same as a direction in which the mobile communication terminal 3 is moved. As a result, the terminal-use map M2 showing a region corresponding to the position of the moved mobile communication terminal 3 is displayed on the mobile communication terminal 3.

For example, as shown in a state ST1, in a case where the mobile communication terminal 3 is overlapped on the screen of the display 22 of the vehicle-mounted apparatus 2, the mobile communication terminal 3 displays the terminal-use map M2 showing a region of the vehicle-use map M1 immediately under the mobile communication terminal 3, i.e., an overlapped portion of the vehicle-use map M1 displayed on the vehicle-mounted apparatus 2.

Moreover, as shown in a state ST2, in a case where the mobile communication terminal 3 is moved downward relative to the screen of the display 22 of the vehicle-mounted apparatus 2, the mobile communication terminal 3 displays the terminal-use map M2 showing a region lower (i.e. more southern) than the vehicle-use map M1 displayed on the vehicle-mounted apparatus 2. In a case of an example shown in FIG. 4, the mobile communication terminal 3 displays the terminal-use map M2 showing a region near “airport” located in the south of “Tokyo Station.”

Further, as shown in a state ST3, in a case where the mobile communication terminal 3 is moved right-downward relative to the screen of the display 22 of the vehicle-mounted apparatus 2, the mobile communication terminal 3 displays the terminal-use map M2 showing a region lower right (i.e. more southeast) from the vehicle-use map M1 displayed on the vehicle-mounted apparatus 2. In a case of an example shown in FIG. 4, the mobile communication terminal 3 displays the terminal-use map M2 showing a region near “theme park” located southeast of “Tokyo Station.”

Therefore, the user can see the map showing a desired region different from the region displayed on the display 22 of the vehicle-mounted apparatus 2, by moving the mobile communication terminal 3 in hand. Even in this case, the vehicle-use map M1 is displayed on the display 22 of the vehicle-mounted apparatus 2 and displaying of the terminal-use map M2 on the mobile communication terminal 3 has no influence on the vehicle-use map M1 on the vehicle-mounted apparatus 2. Therefore, the driver can understand the region near the current location as normal by seeing the vehicle-use map M1 displayed on the vehicle-mounted apparatus 2.

The position of the mobile communication terminal 3 is defined based on a center position of the screen of the display 22 of the vehicle-mounted apparatus 2. In other words, the center position of the screen of the display 22 is defined as a reference position SP and the position of the mobile communication terminal 3 is derived as a relative position to the reference position SP. Moreover, a moved distance and a moved direction of the mobile communication terminal 3 are derived based on the motion of the mobile communication terminal 3 detected by the motion sensor 33.

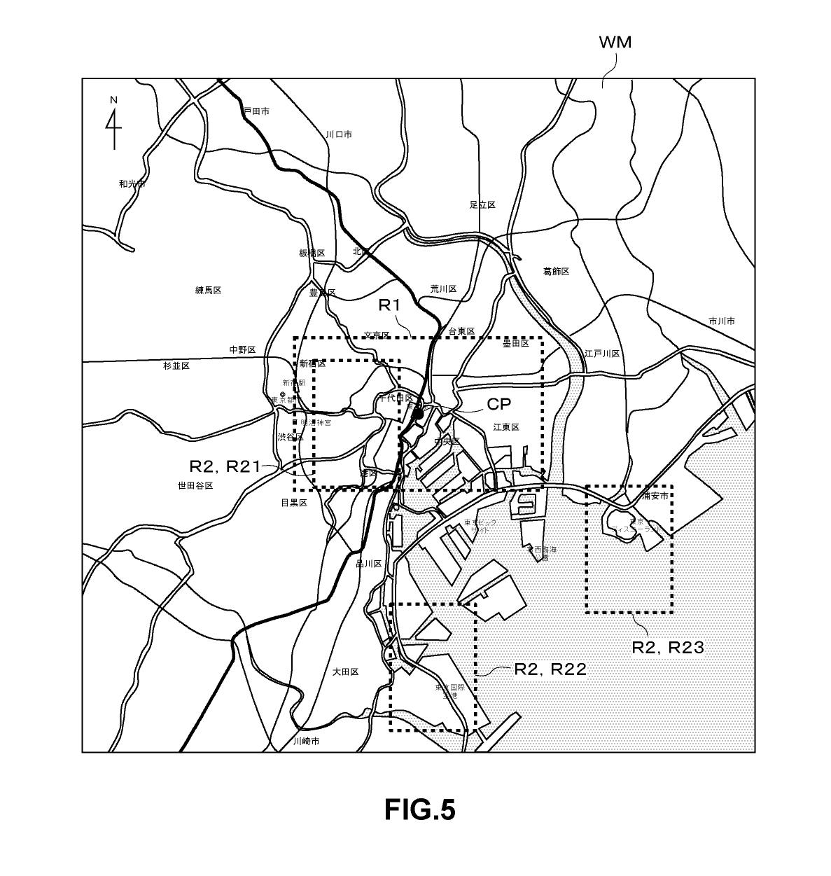

When such a terminal-use map M2 is displayed, a wide-area map that is a virtual map wider than the vehicle-use map M1 is generated. FIG. 5 illustrates an example of such a wide-area map WM. A center position CP of the wide-area map WM (hereinafter referred to as “map center”) is positioned in the center position of the screen of the display 22 of the vehicle-mounted apparatus 2 (i.e., the reference position SP). Therefore, in this embodiment, the map center CP is the current location where the vehicle 9 is currently located. The vehicle-use map M1 displayed on the vehicle-mounted apparatus 2 is generate by clipping, from the wide-area map WM, a region R1 such that the current location is in the center position of the vehicle-use map M1.

On the other hand, the terminal-use map M2 displayed on the mobile communication terminal 3 is generated by clipping, from the wide-area map WM, a region R2 corresponding to the position of the mobile communication terminal 3. The region R2 clipped from the wide-area map WM as the terminal-use map M2 is hereinafter referred to as “terminal-use map region.”

A relative position of the terminal-use map region R2 to the map center CP substantially corresponds to an actual relative position of the mobile communication terminal 3 to the reference position SP. In other words, a direction of the terminal-use map region R2 relative to the map center CP substantially corresponds to an actual direction of the mobile communication terminal 3 relative to the reference position SP. Moreover, a displayed distance from the map center CP to the terminal-use map region R2 on the map corresponds to an actual distance from the reference position SP to the mobile communication terminal 3. The displayed distance from the map center CP to the terminal-use map region R2 on the map is derived in consideration of resolution and a size of a screen of the display 32 of the mobile communication terminal 3. Thus, the mobile communication terminal 3 displays the terminal-use map M2 showing the region corresponding to the relative position of the mobile communication terminal 3 to the reference position SP.

For example, in the state ST1 shown in FIG. 4, the mobile communication terminal 3 is located on a left side of the reference position SP. Therefore, in the state ST1, a region R21 left to the map center CP of the wide-area map WM shown in FIG. 5 is clipped as the terminal-use map region R2 and is displayed as the terminal-use map M2.

Moreover, in the state ST2 shown in FIG. 4, the mobile communication terminal 3 is located lower than the reference position SP. Therefore, in the state ST2, a region R22 lower than the map center CP of the wide-area map WM shown in FIG. 5 is clipped as the terminal-use map region R2 and is displayed as the terminal-use map M2.

Further, in the state ST3 shown in FIG. 4, the mobile communication terminal 3 is located on a lower right side of the reference position SP. Therefore, in the state ST3, a region R23 lower right to the map center CP of the wide-area map WM shown in FIG. 5 is clipped as the terminal-use map region R2 and is displayed as the terminal-use map M2.

### 1-4. Flow of Linked Operation

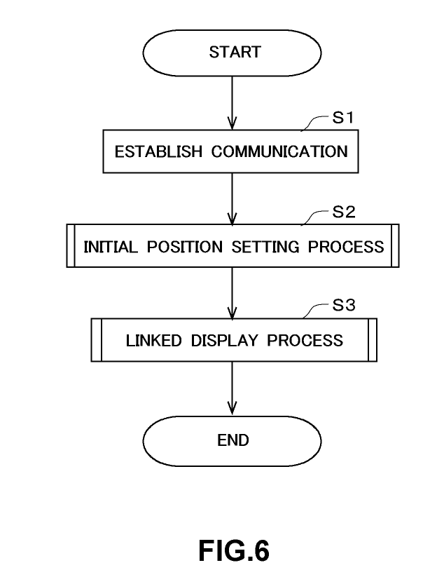

Next explained is a flow of the linked operation that is performed by the communication system 10. FIG. 6 illustrates the flow of a basic process of the linked operation. At a start point of the flow, a predetermined application for linking the mobile communication terminal 3 to the vehicle-mounted apparatus 2 has been already executed in the mobile communication terminal 3. Thus, the motion detector 30a, the signal sender 30b and the display controller 30c of the mobile communication terminal 3 are activated.

First, a negotiation for connection between the vehicle-mounted apparatus 2 and the mobile communication terminal 3 is performed and communication between the vehicle-mounted apparatus 2 and the mobile communication terminal 3 is established (a step S1). After this step, the vehicle-mounted apparatus 2 and the mobile communication terminal 3 are ready to send/receive the signals to/from each other.

Next, an initial position setting process that sets an initial position of the mobile communication terminal 3 is performed (a step S2). In the initial position setting process, the position of the mobile communication terminal 3 at the start point of the linked operation is set as the initial position.

Next, a linked display process that displays the map by linked operation between the vehicle-mounted apparatus 2 and the mobile communication terminal 3 (a step S3). The linked display process causes the mobile communication terminal 3 to display the terminal-use map M2 showing the region corresponding to the relative position of the mobile communication terminal 3 to the reference position SP, as described above.

Detailed flows of the initial position setting process and the linked display process are hereinafter described.

<1-4-1. Initial Position Setting Process>

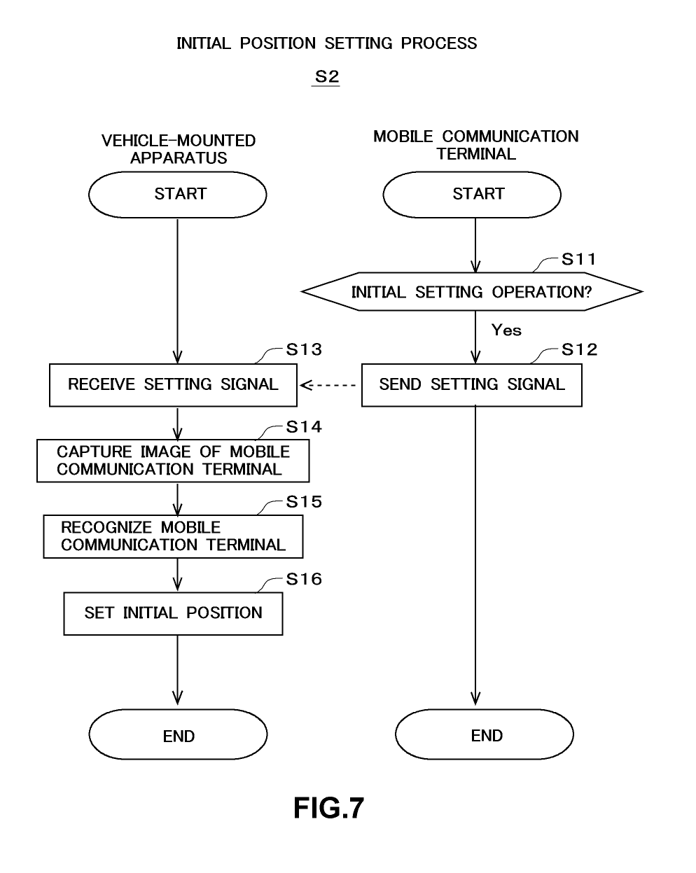

First explained is a flow of the initial position setting process (the step S2 in FIG. 6) that sets the initial position of the mobile communication terminal 3. A flow on a left side in FIG. 7 is performed by vehicle-mounted apparatus 2 and a flow on a right side in FIG. 7 is performed by the mobile communication terminal 3.

First, the signal sender 30b of the mobile communication terminal 3 determines whether or not the user has performed an initial setting operation for setting the initial position (a step S11). The user performs the initial setting operation by touching a command button on the display 32 functioning as the touch panel. The user moves the mobile communication terminal 3 to the front of the screen of the display 22 and then performs such an initial setting operation.

In a case where the initial setting operation has been performed (Yes in the step S11), the signal sender 30b controls the data communicating part 38 to send to the vehicle-mounted apparatus 2 a setting signal representing that the initial setting operation has been performed (a step S12).

The data communication part 28 of the vehicle-mounted apparatus 2 receives the setting signal sent from the mobile communication terminal 3 (a step S13). Once the data communication part 28 receives the setting signal, the initial position setting part 20c of the vehicle-mounted apparatus 2 controls the camera 25 to capture an image of the mobile communication terminal 3 located in front of the screen of the display 22 (a step S14). Thus, the initial position setting part 20c acquires the captured image including the image of the mobile communication terminal 3.

Next, the initial position setting part 20c recognizes the image of the mobile communication terminal 3 in the acquired captured image (a step S15). The initial position setting part 20c is configured to recognize the image of the mobile communication terminal 3 in the captured image by a well-known method, such as pattern matching.

Next, the initial position setting part 20c sets the initial position of the mobile communication terminal 3 based on a position of the image of the mobile communication terminal 3 in the captured image (a step S16). The initial position setting part 20c derives a direction and a degree of a difference of the actual position of the mobile communication terminal 3 from the reference position (the center position of the screen of the display 22) SP based on a difference of the position of the image of the mobile communication terminal 3 from a center in the captured image. Thus, the initial position setting part 20c sets the initial position of the mobile communication terminal 3 based on the reference position SP.

<1-4-2. Linked Display Process>

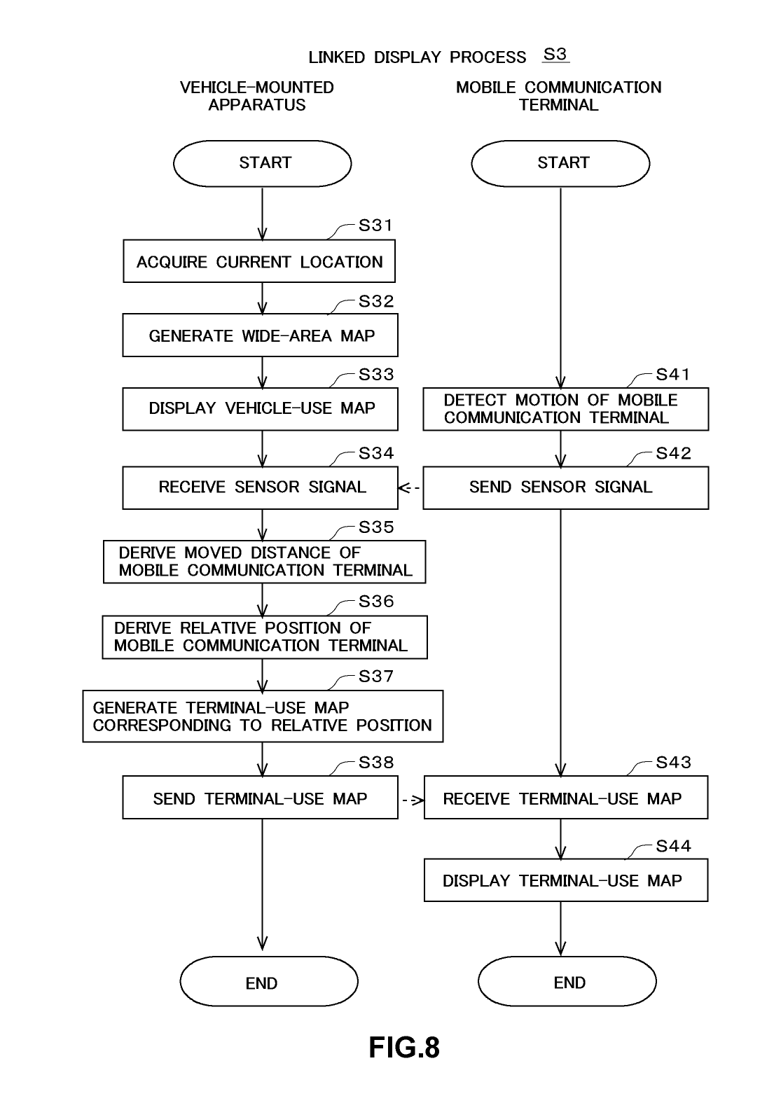

Next explained is the flow of the linked display process (the step S3 in FIG. 6) that causes the map to be displayed by linked operation between the vehicle-mounted apparatus 2 and the mobile communication terminal 3. FIG. 8 illustrates the flow of the linked display process. A flow on a left side in FIG. 8 is performed by vehicle-mounted apparatus 2 and a flow on a right side in FIG. 8 is performed by the mobile communication terminal 3. The processes shown in FIG. 8 are performed repeatedly at a predetermined cycle (e.g. 1/30 second-cycle).

First, the vehicle-use map controller 20a of the vehicle-mounted apparatus 2 controls the GPS part 24 to acquire the current location where the vehicle 9 is currently located on the map (a step S31).

Next, the vehicle-use map controller 20a generates the wide-area map WM wider than the vehicle-use map M1 (a step S32). The vehicle-use map controller 20a generates the wide-area map WM, as shown in FIG. 5, using the map data 29b stored in the memory 29, such that the current location is in the map center CP of the wide-area map WM.

Next, the vehicle-use map controller 20a generates the vehicle-use map M1 and causes the display 22 to display the generated vehicle-use map M1 (a step S33). The vehicle-use map controller 20a generates the vehicle-use map M1 by clipping the region R1 from the wide-area map WM, such that the current location of the vehicle 9 on the wide-area map WM is in the center of the region R1. The vehicle-use map controller 20a controls the display 22 to display the generated vehicle-use map M1.

Thus, the vehicle-use map M1 having the current location in the center is displayed on the vehicle-mounted apparatus 2. In a case where the destination is set, the route guiding part 20b superimposes a route leading to the destination on the vehicle-use map M1 before the vehicle-use map M1 is displayed on the display 22. As a result, the user (mainly the driver) can see a region around the current location and the route leading to the destination by seeing the vehicle-use map M1 displayed on the vehicle-mounted apparatus 2.

While the vehicle-use map M1 is displayed on the vehicle-mounted apparatus 2 as described above, the motion sensor 33 of the mobile communication terminal 3 detects the motion of the mobile communication terminal 3 (a step S41). The motion detector 30a controls the motion sensor 33 to acquire from the motion sensor 33 the sensor signal representing the motion of the mobile communication terminal 3. The sensor signal represents accelerations and angular speeds along/around the three axes.

Next, the signal sender 30b of the mobile communication terminal 3 controls the data communicating part 38 to send the sensor signal to the vehicle-mounted apparatus 2 as the terminal signal corresponding to the motion of the mobile communication terminal 3 (a step S42).

The data communication part 28 of the vehicle-mounted apparatus 2 receives the sensor signal sent from the mobile communication terminal 3 (a step S34). The terminal position deriving part 20d of the vehicle-mounted apparatus 2 derives the moved distance of the mobile communication terminal 3 along each of the three axes from a position derived in a previous linked display process (a series of the process in FIG. 8), based on the accelerations along the three axes represented by the sensor signal (a step S35).

Moreover, the terminal position deriving part 20d derives the moved distance of the mobile communication terminal 3 from the initial position along the three axes by accumulating the moved distances of the mobile communication terminal 3 derived in the linked display process repeated before. As described above, the initial position is set based on the reference position SP in the initial position setting process. Therefore, the terminal position deriving part 20d derives the relative position of the mobile communication terminal 3 to the reference position SP, based on the initial position set based on the reference position SP and the moved distance of the mobile communication terminal 3 from the initial position (a step S36).

Next, the terminal-use map controller 20e generates the terminal-use map M2 corresponding to the relative position of the mobile communication terminal 3 to the reference position SP (a step S37). The terminal-use map controller 20e sets the terminal-use map region R2 on the wide-area map WM such that the relative position of the terminal-use map region R2 to the map center CP is matched with an actual relative position of the mobile communication terminal 3 to the reference position SP. Then, the terminal-use map controller 20e generates the terminal-use map M2 by clipping the set terminal-use map region R2 from the wide-area map WM.

Next, the terminal-use map controller 20e controls the data communication part 28 to send the generated terminal-use map M2 to the mobile communication terminal 3 (a step S38). Thus, the terminal-use map controller 20e causes the terminal-use map M2 to be displayed on the mobile communication terminal 3.

The data communicating part 38 of the mobile communication terminal 3 receives the terminal-use map M2 sent from the vehicle-mounted apparatus 2 (a step S43). Once the data communicating part 38 receives the terminal-use map M2, the display controller 30c of the mobile communication terminal 3 controls the display 32 to display the terminal-use map M2 received from the vehicle-mounted apparatus 2 (a step S44). Thus, the mobile communication terminal 3 displays the terminal-use map M2 showing the region corresponding to the relative position to the reference position SP.

As described above, in the communication system 10, the mobile communication terminal 3 detects the motion of the mobile communication terminal 3 and sends to the vehicle-mounted apparatus 2 the sensor signal corresponding to the motion of the mobile communication terminal 3. The vehicle-mounted apparatus 2 receives the sensor signal from the mobile communication terminal 3 and performs a process corresponding to the motion of the mobile communication terminal 3, based on the sensor signal.

As described above, since the vehicle-mounted apparatus 2 performs the process corresponding to the motion of the mobile communication terminal 3, the user other than the main user (the driver) of the vehicle-mounted apparatus 2 can causes the vehicle-mounted apparatus 2 to perform a desired process by moving the mobile communication terminal 3.

Moreover, the display 22 of the vehicle-mounted apparatus 2 displays the vehicle-use map M1 generated by clipping the region R1 including the current location from the wide-area map WM. In addition, the terminal position deriving part 20d of the vehicle-mounted apparatus 2 derives the relative position of the mobile communication terminal 3 to the reference position SP, based on the motion of the mobile communication terminal 3. Then, the terminal-use map controller 20e of the vehicle-mounted apparatus 2 generates the terminal-use map M2 by clipping, from the wide-area map WM, the terminal-use map region R2 corresponding to the relative position of the mobile communication terminal 3. The terminal-use map controller 20e sends the terminal-use map M2 to the mobile communication terminal 3 and causes the terminal-use map M2 to be displayed on the display 32 of the mobile communication terminal 3.

Therefore, different regions of the wide-area map WM are displayed on the vehicle-mounted apparatus 2 and on the mobile communication terminal 3. The user can see the terminal-use map M2 that is a desired region on the wide-area map WM, on the display 32 of the mobile communication terminal 3 by moving the mobile communication terminal 3. Moreover, displaying of the terminal-use map M2 on the mobile communication terminal 3 has no influence on the vehicle-use map M1 on the vehicle-mounted apparatus 2.

### 2. Second Embodiment

Next, a second embodiment is explained. A configuration and processes of a communication system 10 in the second embodiment are almost the same as the configuration and the processes of the communication system 10 in the first embodiment. Therefore, a difference from the first embodiment is mainly hereinafter explained.

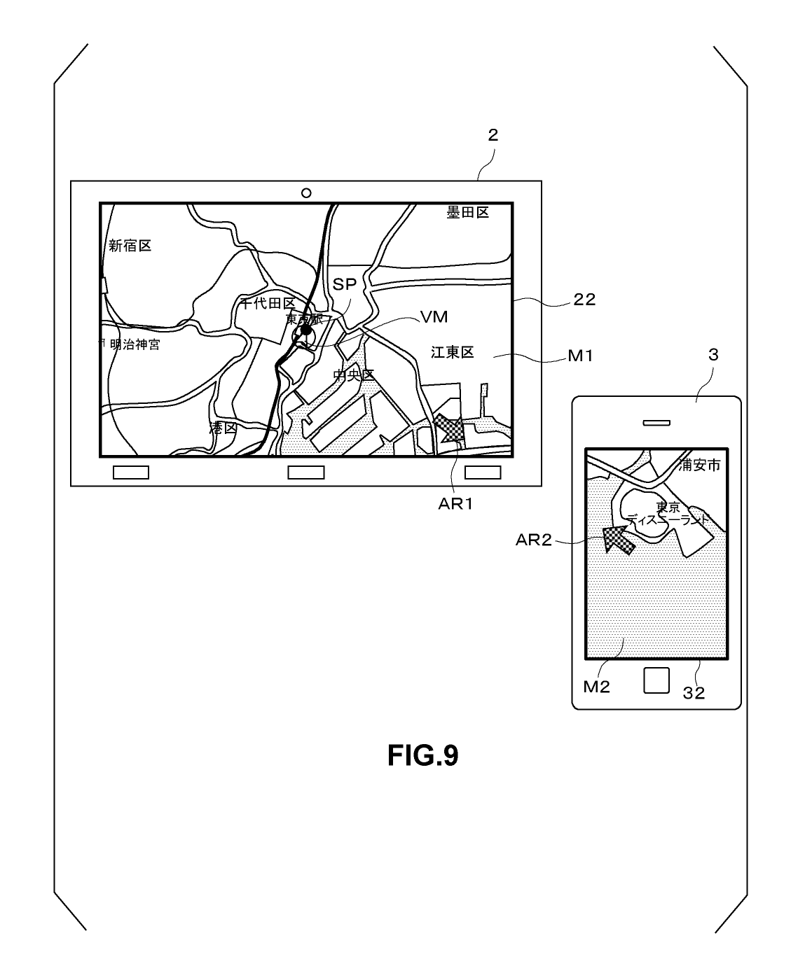

FIG. 9 illustrates a linked operation between a vehicle-mounted apparatus 2 and a mobile communication terminal 3 in a linked display process (the step S3 in FIG. 6) in the second embodiment.

In the linked display process in the second embodiment, too, a vehicle-use map M1 including a current location is displayed on the vehicle-mounted apparatus 2 and a terminal-use map M2 showing a region corresponding to a relative position of the mobile communication terminal 3 to a reference position SP is displayed on the mobile communication terminal 3. However, the vehicle-use map M1 displayed on the vehicle-mounted apparatus 2 includes an arrow mark AR1 that shows a relative direction of a region displayed as the terminal-use map M2. Moreover, the terminal-use map M2 displayed on the mobile communication terminal 3 includes an arrow mark AR2 that shows a relative direction of a region displayed as the vehicle-use map M1.

The arrow mark AR1 included in the vehicle-use map M1 shows a direction of a terminal-use map region R2 displayed as the terminal-use map M2 from a region R1 displayed as the vehicle-use map M1 on the wide-area map WM (refer to FIG. 5). Such an arrow mark AR1 is superimposed by the vehicle-use map controller 20a on the region R1 displayed as the vehicle-use map M1 when the vehicle-use map controller 20a generates the vehicle-use map M1.

In a case where a user moves the mobile communication terminal 3 in hand, the direction shown by the arrow mark AR1 is also changed based on a position of the mobile communication terminal 3. Since the arrow mark AR1 is displayed, as described above, on the vehicle-mounted apparatus 2, the user can easily understand the direction of the region shown as the terminal-use map M2 displayed on the mobile communication terminal 3.

On the other hand, the arrow mark AR 2 included in the terminal-use map M2 shows a direction of the region R1 on the vehicle-use map M1 from the terminal-use map region R2 displayed as the terminal-use map M2 on the wide-area map WM (refer to FIG. 5). Such an arrow mark AR2 is superimposed by the terminal-use map controller 20e on the terminal-use map region R2 displayed as the terminal-use map M2 when the terminal-use map controller 20e generates the terminal-use map M2.

In a case where the user moves the mobile communication terminal 3 in hand, the direction shown by the arrow mark AR2 is also changed based on the position of the mobile communication terminal 3. Since the arrow mark AR2 is displayed, as described above, on the mobile communication terminal 3, the user can easily understand the direction of the region shown as the vehicle-use map M1 displayed on the vehicle-mounted apparatus 2.

In the embodiment described above, the terminal-use map M2 displayed on the mobile communication terminal 3 includes the arrow mark AR 2 showing the direction of the region R1 displayed as the vehicle-use map M1 from the terminal-use map region R2. In addition, the terminal-use map M2 may include an arrow mark representing a direction of a destination from the terminal-use map region R2. Moreover, length of each of those arrow marks may be changed, depending on a distance to an object (the region R1 and/or a destination) shown by the arrow mark.

### 3. Third Embodiment

Next, a third embodiment is explained. A configuration and processes of a communication system 10 in the third embodiment are almost the same as the configuration and the processes of the communication system 10 in the first embodiment. Therefore, a difference from the first embodiment is mainly hereinafter explained.

In the first embodiment, the reference position SP that is a reference for determining the position of the mobile communication terminal 3 is set in the center position (the position based on the position of the vehicle-mounted apparatus 2) of the screen of the display 22 of the vehicle-mounted apparatus 2. In the third embodiment, a user who is operating a mobile communication terminal 3 can set an arbitrary position as a reference position. Therefore, a position away from a vehicle-mounted apparatus 2, such as a passenger's seat or a backseat of a vehicle 9 may be set as the reference position.

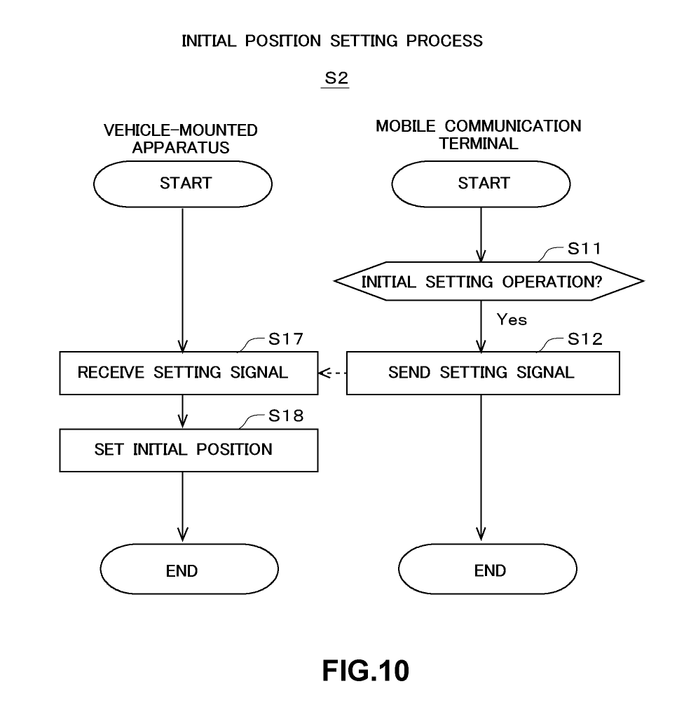

FIG. 10 illustrates a flow of an initial position setting process (the step S2 in FIG. 6) performed in the third embodiment. A flow on a left side in FIG. 10 is performed by vehicle-mounted apparatus 2 and a flow on a right side in FIG. 10 is performed by the mobile communication terminal 3.

A signal sender 30b of the mobile communication terminal 3 determines whether or not the user has performed an initial setting operation that sets an initial position (a step S11). The user performs the initial setting operation by touching a command button on a display 32 functioning as a touch panel. The user can perform such an initial setting operation at a position that the user desires to set as the reference position.

In a case where the initial setting operation has been performed (Yes in the step S11), the signal sender 30b controls a data communicating part 38 to send to the vehicle-mounted apparatus 2 a setting signal representing that the initial setting operation has been performed (a step S12).

A data communication part 28 of the vehicle-mounted apparatus 2 receives the setting signal sent from the mobile communication terminal 3 (a step S17). Once the data communication part 28 receives the setting signal, an initial position setting part 20c of the vehicle-mounted apparatus 2 sets the initial position that is a position of the mobile communication terminal 3 at that time point, as the reference position (a step S18). Thus, the position of the mobile communication terminal 3 at the time point when the user performs the initial position setting operation, is set as the reference position.

After the initial position setting process, the linked display process (the step S3 in FIG. 6) is performed in a same manner as in the first embodiment. Therefore, the terminal-use map M2 showing a region corresponding to a relative position to the reference position is displayed on the mobile communication terminal 3.

The reference position in the third embodiment is the position set in the initial operation setting process, instead of a center of the screen of the display 22. Therefore, for example, a center of the passenger's seat is set as the reference position. In a case where the mobile communication terminal 3 is moved close to the center of the passenger's seat, the terminal-use map M2 showing a region near the map center CP (i.e. the current location) is displayed on the mobile communication terminal 3. Moreover, in a case where the mobile communication terminal 3 is moved away from the center of the passenger's seat, the terminal-use map M2 showing a region away from the map center CP (i.e. the current location) is displayed on the mobile communication terminal 3.

As described in the third embodiment, since the reference position is set to a position where the mobile communication terminal 3 receives the initial setting operation performed by the user, the user can set a desired position as the reference position.

In the embodiment described above, the position where the mobile communication terminal 3 receives the initial setting operation performed by the user is set as the reference position. However, the reference position may be set to a position where the mobile communication terminal 3 performs a different process. For example, a position where the mobile communication terminal 3 executes the predetermined application for linking the mobile communication terminal 3 and the vehicle-mounted apparatus 2 or a position where the mobile communication terminal 3 is turned on may be set as the reference position.

### 4. Fourth Embodiment

Next, a fourth embodiment is explained. A configuration and processes of a communication system 10 in the fourth embodiment are almost the same as the configuration and the processes of the communication system 10 in the first embodiment. Therefore, a difference from the first embodiment is mainly hereinafter explained.

In the first embodiment, any region of the wide-area map WM may be clipped as the terminal-use map M2 corresponding to a relative position of the mobile communication terminal 3 to a reference position SP. On the other hand, in the fourth embodiment, in a case where a route leading to a destination is set, only a region including the route on a wide-area map WM is clipped as a terminal-use map M2.

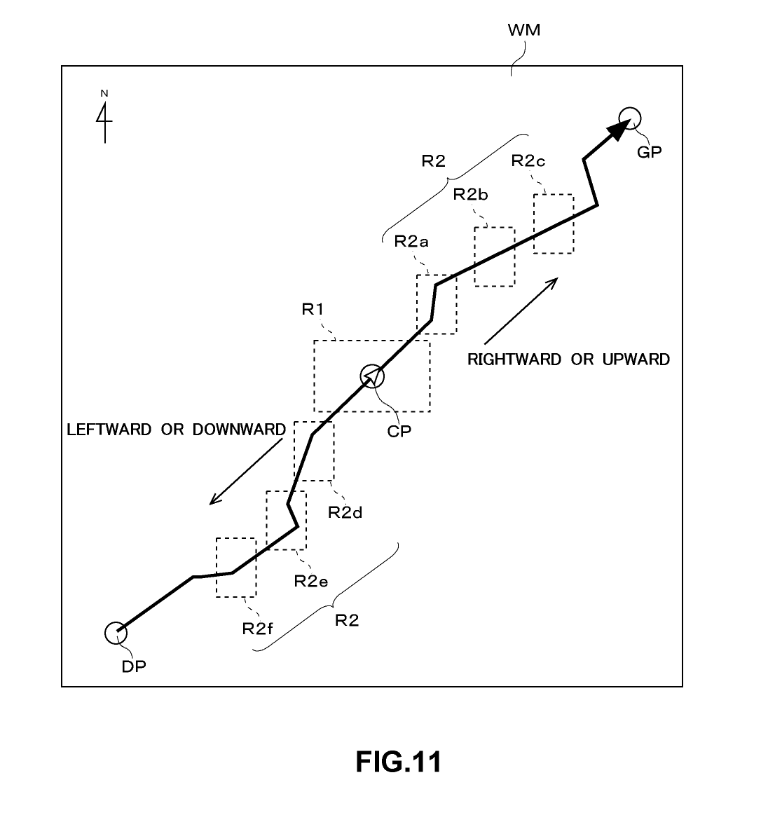

FIG. 11 illustrates an example of the wide-area map WM in the fourth embodiment. As shown in FIG. 11, the wide-area map WM includes a route GR from a point of departure (hereinafter referred to as departure point) DP to a destination GP. The route GR leads approximately right-upward on the wide-area map WM.

A current location where a vehicle 9 is currently located is set as a map center CP that is a center of the wide-area map WM. Also, in this embodiment, a vehicle-use map M1 is generated by clipping a region R1 from the wide-area map WM such that the current location is in the center, also in this embodiment.

Moreover, also in this embodiment, the terminal-use map M2 is generated by clipping a terminal-use map region R2 corresponding to the relative position of the mobile communication terminal 3 to the reference position. However, the terminal-use map region R2 is limited to the region including the route GR.

Therefore, for example, in a case where the mobile communication terminal 3 is moved rightward or upward (i.e. position closer to the destination GP) relative to the reference position, a region R2a, a region R2b or a region R2c including a position on the route GR that is existing right from the map center CP (i.e. the current location) or existing upper than the map center CP is set as the terminal-use map region R2. On the other hand, in a case where the mobile communication terminal 3 is moved leftward or downward relative to the reference position (i.e. position closer to the departure point DP), a region R2d, a region R2e or a region R2f including a position on the route GR that is existing left from the map center CP (i.e. the current position) or existing lower than the reference position is set as the terminal-use map region R2. In either case, the greater the distance between the reference position and the mobile communication terminal 3, the greater the distance from the map center CP to the terminal-use map region R2.

As a result, the user can see a map showing a desired region along the route GR by moving the mobile communication terminal 3.

The route GR leads right-upward in FIG. 11. However, in a case where the route GR leads in a different direction, a region is selected based on the direction in which the route GR leads and on a direction in which the mobile communication terminal 3 moves.

For example, the route GR leads right-downward. In a case where the mobile communication terminal 3 is moved rightward relative to the reference position, a region including a position on the route GR that is existing closer to the destination GP from the map center CP, is set as the terminal-use map region R2. On the other hand, in a case where the mobile communication terminal 3 is moved upward relative to the reference position, a region including a position on the route GR that is existing closer to the departure point DP from the map center CP, is set as the terminal-use map region R2.

In the fourth embodiment as described above, the terminal-use map region R2 that is displayed as the terminal-use map M2 is a region including the route GR on the map.

Therefore, the user can see different locations on the route GR displayed on the display 32 of the mobile communication terminal 3, by moving the mobile communication terminal 3. Moreover, the user does not need to move the mobile communication terminal 3 accurately along the route GR. If the user moves the mobile communication terminal 3 approximately along the route GR, the terminal-use map region R2 of the terminal-use map M2 to be displayed on the mobile communication terminal 3 is changed along the route GR. As a result, the user can easily see the route or can search for or see facilities around the route.

### 5. Fifth Embodiment

Next, a fifth embodiment is explained. A configuration and processes of a communication system 10 in the fifth embodiment are almost the same as the configuration and the processes of the communication system 10 in the first embodiment. Therefore, a difference from the first embodiment is mainly hereinafter explained.

The communication system 10 in the fifth embodiment includes a holding function that suspends a process to be performed based on a motion of a mobile communication terminal 3 during a predetermined operation that is performed with the mobile communication terminal 3.

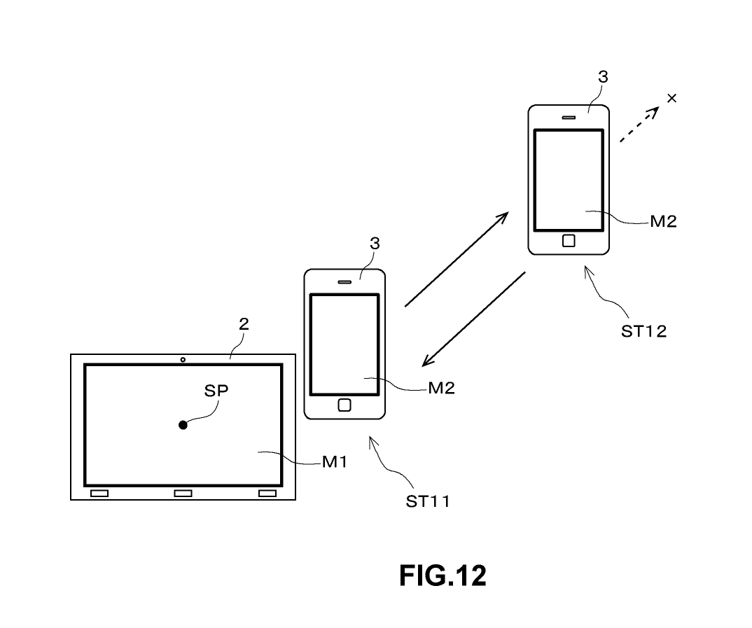

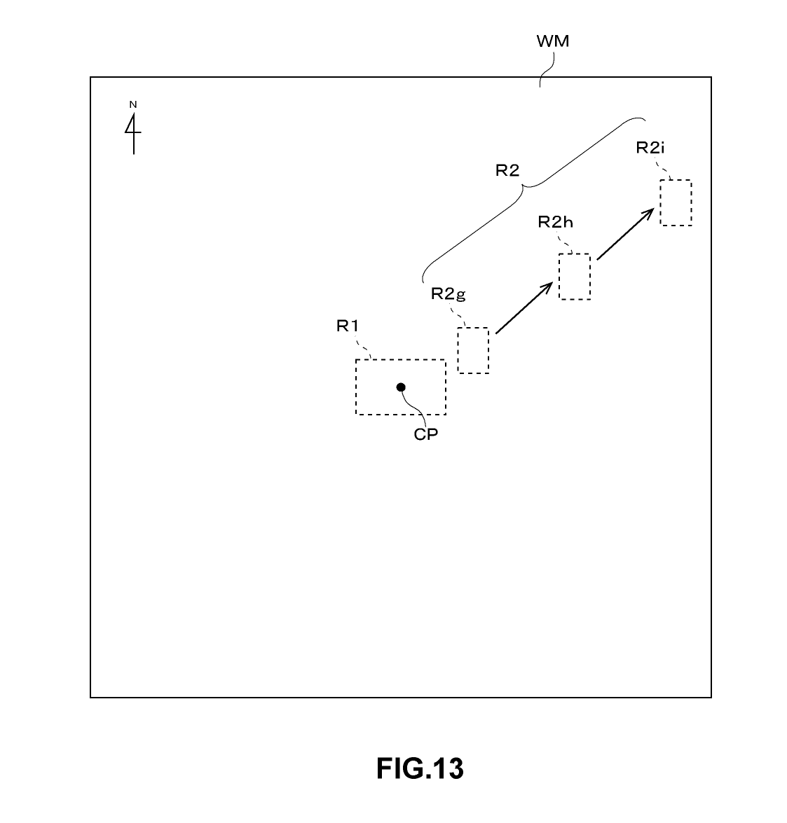

FIG. 12 illustrates a positional relationship between a vehicle-mounted apparatus 2 and the mobile communication terminal 3 in a linked display process (the step S3 in FIG. 6) in the fifth embodiment. Moreover, FIG. 13 illustrates an example of a wide-area map WM used in the linked display process. Also in this embodiment, a vehicle-use map M1 is generated by clipping a region R1 from the wide-area map WM such that a map center CP is in a center of the wide-area map WM. A terminal-use map M2 is generated by clipping a terminal-use map region R2 corresponding to a relative position of the mobile communication terminal 3 to a reference position SP. The reference position SP is set to a center position of a screen of a display 22 of the vehicle-mounted apparatus 2.

In a case where the mobile communication terminal 3 is moved close to the vehicle-mounted apparatus 2 as shown in a state ST11 in FIG. 12, a region R2g relatively close to the map center CP shown in FIG. 13 is clipped as the terminal-use map region R2 to be displayed as the terminal-use map M2. Then, in a case where the user moves the mobile communication terminal 3 away from the vehicle-mounted apparatus 2 as shown in a state ST12 in FIG. 12, a region R2h relatively away from the map center CP shown in FIG. 13 is clipped as the terminal-use map region R2 to be displayed as the terminal-use map M2.

There is a case where the user desires to see a region R2i further away from the map center CP shown in FIG. 13. However, there is a case where it may be physically difficult to move the mobile communication terminal 3 further away from the vehicle-mounted apparatus 2, from the state ST12 shown in FIG. 12.

In such a case, the user moves the mobile communication terminal 3 while performing the predetermined operation with the mobile communication terminal 3. The user can perform the holding operation, for example, by touching a predetermined command button displayed on a display 32 functioning as a touch panel. During the holding operation, the terminal-use map region R2 is not changed corresponding to the motion of the mobile communication terminal 3. In other words, while the display 32 functioning as the tough panel is receiving the holding operation, the region displayed as the terminal-use map M2 is not changed on the mobile communication terminal 3.

Therefore, in a case where the user moves the mobile communication terminal 3 to a position of the state ST11 while performing the holding operation with the mobile communication terminal 3, the region R2h, instead of the region R2g, is kept displayed as the terminal-use map region R2 displayed as the terminal-use map M2. After that, in a case where the user cancels the holding operation and then moves the mobile communication terminal 3 to the position of the state ST12, the region R2i further away from the map center CP shown in FIG. 13 is clipped as the terminal-use map region R2 to be displayed as the terminal-use map M2.

As described above, in this embodiment, the user can perform, with the mobile communication terminal 3, the holding operation that suspends the process corresponding to the motion of the mobile communication terminal 3. Therefore, even in a case where it is difficult to move the mobile communication terminal 3 to a position relatively away from the reference position SP, the user can see the terminal-use map M2 showing a region relatively away from the map center CP of the wide-area map WM, on the display 32 of the mobile communication terminal 3. Moreover, the terminal-use map region R2 displayed as the terminal-use map M2 on the mobile communication terminal 3 is not changed by the holding operation. Therefore, even in a case where the user moves the mobile communication terminal 3 to show a different user the terminal-use map M2 displayed on the mobile communication terminal 3, the user can show the different user the terminal-use map M2 showing the unchanged terminal-use map region R2.

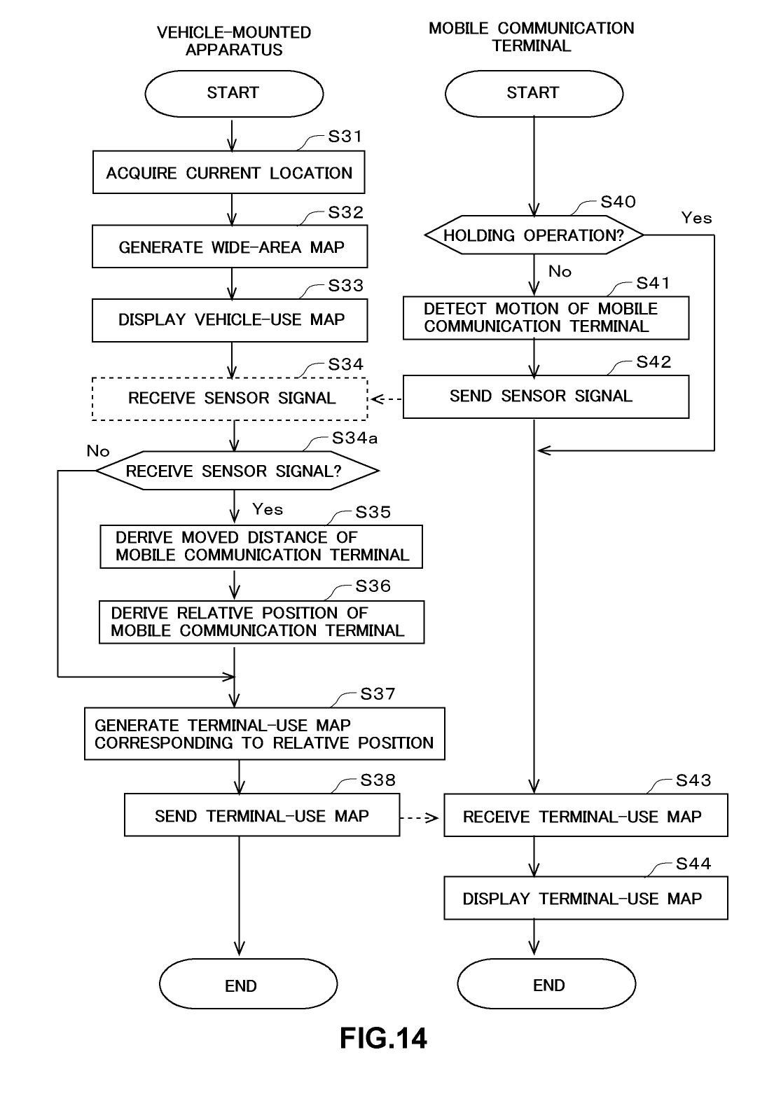

FIG. 14 illustrates a flow of the linked display process (the step S3 in FIG. 6) performed in the fifth embodiment.

The linked display process shown in FIG. 14 is similar to the linked display process shown in FIG. 8 in the first embodiment but a step S40 and a step S34a are added to the linked display process in FIG. 8.

First, the vehicle-mounted apparatus 2 acquires a current location (a step S31) and generates the wide-area map WM such that the current location is in the map center CP of the wide-area map WM. (a step S32). Then, the vehicle-mounted apparatus 2 generates the vehicle-use map M1 and causes the vehicle-use map M1 to be displayed on the display 22 (a step S33).

On the other hand, a controller 20 of the mobile communication terminal 3 determines, based on a signal sent from the display 32, whether or not the display 32 is receiving the holding operation (a step S40). In a case where the display 32 is not receiving the holding operation (No in the step S40), the process same as the process in the first embodiment is performed after the step S40.

In other words, the mobile communication terminal 3 detects the motion of the mobile communication terminal 3 (a step S41) and sends a sensor signal representing the motion to the vehicle-mounted apparatus 2 (a step S42). Once receiving the sensor signal, the vehicle-mounted apparatus 2 derives a moved distance of the mobile communication terminal 3 based on the sensor signal (a step S35) and then further derives the relative position of the mobile communication terminal 3 to the reference position SP (a step S36).

Then, the vehicle-mounted apparatus 2 generates the terminal-use map M2 corresponding to the relative position of the mobile communication terminal 3 and sends the generated terminal-use map M2 to the mobile communication terminal 3 (a step S38). The mobile communication terminal 3 receives the terminal-use map M2 (a step S43) and causes the received terminal-use map M2 to be displayed on the display 32. Thus, the region of the terminal-use map M2 to be displayed on the mobile communication terminal 3 is changed corresponding to the motion of the mobile communication terminal 3.

On the other hand, in a case where the display 32 is receiving the holding operation (Yes in the step S40), the mobile communication terminal 3 does not perform the steps S41 and S42. Therefore, in this case, the mobile communication terminal 3 does not send the sensor signal representing the motion of the mobile communication terminal 3 to the vehicle-mounted apparatus 2 so that the vehicle-mounted apparatus 2 does not receive the sensor signal.

In the case where the vehicle-mounted apparatus 2 does not receive the sensor signal (No in the step S34a), the vehicle-mounted apparatus 2 does not perform the steps S35 and S36. Therefore, in this case, the vehicle-mounted apparatus 2 does not derive the relative position of the mobile communication terminal 3 based on the motion of the mobile communication terminal 3 but continues the linked display process corresponding to the same relative position of the mobile communication terminal 3 detected last time.

Then, the vehicle-mounted apparatus 2 generates the terminal-use map M2 corresponding to the same relative position of the mobile communication terminal 3 detected last time and sends the generated terminal-use map M2 to the mobile communication terminal 3 (a step S38). The mobile communication terminal 3 receives the terminal-use map M2 (a step S43) and causes the received terminal-use map M2 to be displayed on the display 32 (a step S44). Thus, regardless of the motion of the mobile communication terminal 3, the region of the terminal-use map M2 displayed on the mobile communication terminal 3 is not changed.

As described above, in the fifth embodiment, while the display 32 of the mobile communication terminal 3 is receiving the holding operation, the vehicle-mounted apparatus 2 does not perform the process corresponding to the motion of the mobile communication terminal 3. Thus, the user can suspend the process corresponding to the motion of the mobile communication terminal 3 by performing the holding operation.

The flow of the linked display process shown in FIG. 14 is only an example. As long as the process corresponding to the motion of the mobile communication terminal 3 is not performed while the display 32 of the mobile communication terminal 3 is receiving the holding operation, a different flow may be used. For example, while the mobile communication terminal 3 is receiving the holding operation, the mobile communication terminal 3 may not perform any one of the steps S41 and S42, instead of both of the steps. Moreover, the mobile communication terminal 3 may be configured to send to the vehicle-mounted apparatus 2 a predetermined holding signal in addition to the sensor signal while receiving the holding operation, and the vehicle-mounted apparatus 2 may be configured not to perform the steps S35 and S36 while receiving the hold signal.

### 6. Sixth Embodiment

Next, a sixth embodiment is explained. A communication system 10 in the sixth embodiment also includes a vehicle-mounted apparatus 2 and a mobile communication terminal 3 that can be linked to each other to work. Therefore, a difference from the first embodiment is mainly hereinafter explained.

The vehicle-mounted apparatus 2 includes the navigation function in the first embodiment. On the other hand, in the sixth embodiment, the mobile communication terminal 3 includes a navigation function, and the vehicle-mounted apparatus 2 does not include a navigation function and only includes basic functions such as a display function. The mobile communication terminal 3 sends to the vehicle-mounted apparatus 2 an image, such as a map, to be supplied to a user (mainly a driver). The vehicle-mounted apparatus 2 receives the image from the mobile communication terminal 3 and causes the image to be displayed on the display 22. Thus, the vehicle-mounted apparatus 2 provides to the user (mainly the driver) various images to be supplied to the user.

### 6-1. Configuration of System

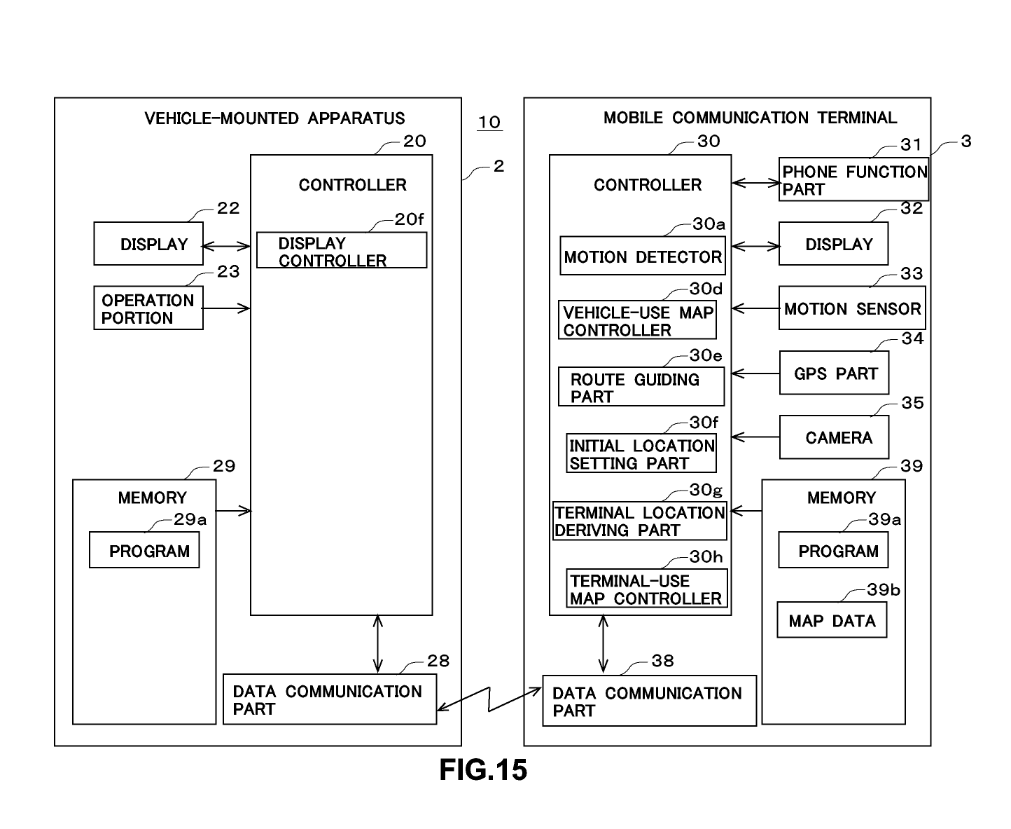

FIG. 15 illustrates a configuration of the communication system 10 in the sixth embodiment. A left portion of FIG. 15 illustrates a configuration of the vehicle-mounted apparatus 2 and a right portion of FIG. 15 illustrates a configuration of the mobile communication terminal 3.

The vehicle-mounted apparatus 2 of the sixth embodiment does not include the GPS part 24 and the camera 25 of the vehicle-mounted apparatus 2 shown in FIG. 2 in the first embodiment. Moreover, a memory 29 stores a program 29a but does not store a map data 29b.

Moreover, the vehicle-mounted apparatus 2 includes a display controller 20f as a processing part implemented by software by execution of the program 29a by a controller 20, instead of the processing parts 20a to 20e shown in FIG. 2 in the first embodiment. The display controller 20f controls a display 22 to display an image that a data communication part 28 receives from the mobile communication terminal 3.

On the other hand, the mobile communication terminal 3 further includes a GPS part 34 and a camera 35 in addition to the configuration shown in FIG. 2 in the first embodiment.

The GPS part 34 acquires a location where the mobile communication terminal 3 is currently located (absolute position on the earth) by receiving signals from plural GPS satellites. The mobile communication terminal 3 is used in the vehicle 9. Therefore, practically, the GPS part 34 acquires a location where the vehicle 9 is currently located. In the sixth embodiment, the location, acquired by the GPS part 34, where the vehicle 9 is currently located is hereinafter referred to as “current location.” The current location acquired by the GPS part 34 is presented, for example, by latitude and longitude and is used as information for defining a position on a map.

The camera 35 includes a lens and an image sensor. The camera 35 captures an image of an object and electronically acquires the captured image. The camera 35 is provided on a main surface on a back side of a side on which a display 32 is provided. Therefore, the camera 35 captures the image of the object existing behind the display 32 that the user sees.

Moreover, a memory 39 stores a map data 39b used for the navigation function in addition to a program 39a.

Further, the mobile communication terminal 3 further includes a vehicle-use map controller 30d, a route guiding part 30e, an initial position setting part 30f, a terminal position deriving part 30g and a terminal-use map controller 30h, as processing parts that are implemented by software by a controller 30 executing the program 39a, in addition to a motion detector 30a that is included in the first embodiment, too.

The vehicle-use map controller 30d, the route guiding part 30e, the initial position setting part 30f, the terminal position deriving part 30g and the terminal-use map controller 30h are processing parts that implement the almost same functions as the vehicle-use map controller 20a, the route guiding part 20b, the initial position setting part 20c, the terminal position deriving part 20d and the terminal-use map controller 20e do, respectively, included in the vehicle-mounted apparatus 2 in the first embodiment. Therefore, the mobile communication terminal 3 in the sixth embodiment performs almost same steps performed by the vehicle-mounted apparatus 2 in the first embodiment. Those steps are hereinafter described.

### 6-2. Initial Position Setting Process

First explained is a flow of an initial position setting process (the step S2 in FIG. 6) that sets an initial position of the mobile communication terminal 3.

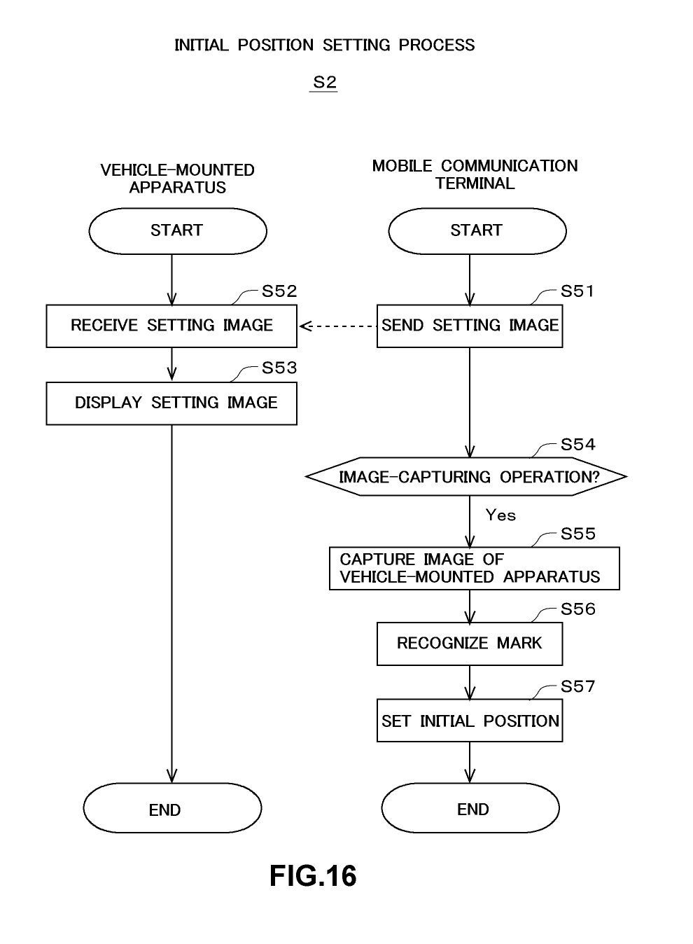

FIG. 16 illustrates the flow of the initial position setting process performed in the sixth embodiment. A flow on a left side in FIG. 16 is performed by vehicle-mounted apparatus 2 and a flow on a right side in FIG. 16 is performed by the mobile communication terminal 3.

First, the initial position setting part 30f of the mobile communication terminal 3 controls the data communicating part 38 to send to the vehicle-mounted apparatus 2 a setting image that is used for setting the initial position of the mobile communication terminal 3 (a step S51). Such a setting image is stored in the memory 39 and the like beforehand.

The data communication part 28 of the vehicle-mounted apparatus 2 receives the setting image sent from the mobile communication terminal 3 (a step S52). Once receiving the setting image, the display controller 20f of the vehicle-mounted apparatus 2 controls the display 22 to display the setting image received from the mobile communication terminal 3 on the display 22 (a step S53).

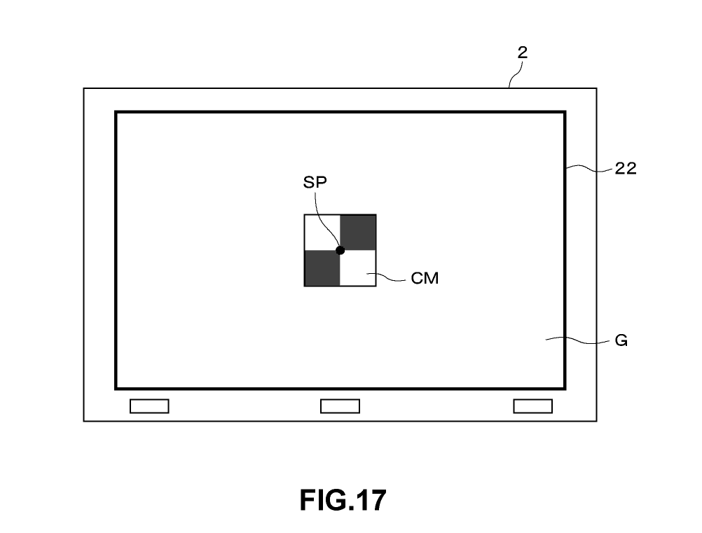

Thus, as shown in FIG. 17, a setting image G is displayed on the display 22 of the vehicle-mounted apparatus 2. A setting mark CM in a predetermined pattern is provided in a center position of the setting image G. Therefore, a center of the setting mark CM is in a center position of a screen of the display 22 displaying the setting image G. The pattern of the setting mark CM is, for example, a checked design in which two colored squares are alternately disposed. In the sixth embodiment, too, the center position of the screen of the display 22 is defined as a reference position SP. Therefore, the reference position SP is matched with the center position of the setting mark CM.

As described above, while the setting mark CM is displayed on the vehicle-mounted apparatus 2, the initial position setting part 30f of the mobile communication terminal 3 controls the camera 35 to be ready to capture an image. In other words, the image captured by the camera 35 is displayed on the display 32 on live, i.e., the captured image is displayed in real time.

In a state where the mobile communication terminal 3 is ready to capture an image, the initial position setting part 30f determines whether or not the user has performed an image-capturing operation that commands the camera 35 to capture an image (a step S54). The image-capturing operation is substantially equivalent to the initial setting operation in the foregoing embodiment.

The user performs the image-capturing operation by touching a command button displayed on the display 32 functioning as the touch panel. The user moves the mobile communication terminal 3 to near a front of the screen of the display 22 of the vehicle-mounted apparatus 2 to capture the image of the setting mark CM on the screen of the display 22.

In a case where the image-capturing operation is performed (Yes in the step S54), the initial position setting part 30f controls the camera 35 to capture the image of the screen of the display 22 of the vehicle-mounted apparatus 2 (a step S55). Thus, the initial position setting part 30f acquires the captured image including the image of the setting mark CM.

Next, the initial position setting part 30f recognizes the image of the setting mark CM in the acquired captured image (a step S56). The initial position setting part 30f recognizes the image of the setting mark CM in the captured image by using a well-known technology, such as Harris operator.

Next, the initial position setting part 30f sets the initial position of the mobile communication terminal 3 based on a position of the image of the setting mark CM in the captured image (a step S57). The initial position setting part 30f derives a direction and a degree of a difference of an actual position of the mobile communication terminal 3 from the reference position (the center position of the screen of the display 22) SP based on a difference of the position of the image of the setting mark CM from a center in the captured image. Thus, the initial position setting part 30f sets the initial position of the mobile communication terminal 3 based on the reference position SP.

### 6-3. Linked Display Process

Next explained is a flow of the linked display process (the step S3 in FIG. 6) that causes the map to be displayed by a linked operation between the vehicle-mounted apparatus 2 and the mobile communication terminal 3.

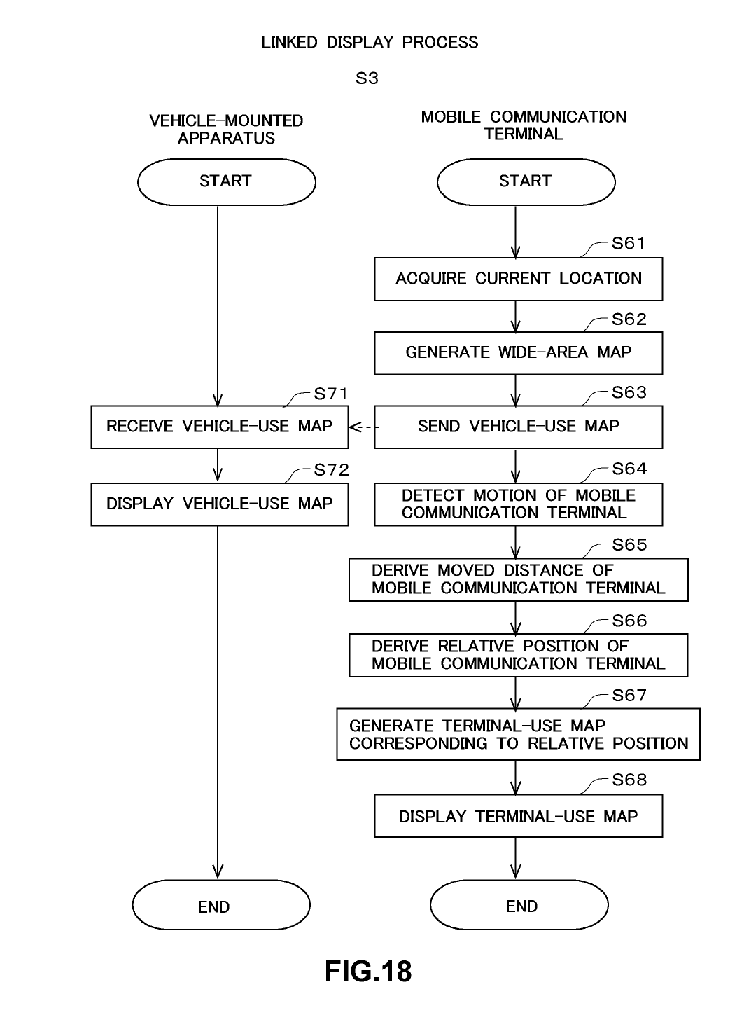

FIG. 18 illustrates the flow of the linked display process performed in the sixth embodiment. A flow on a left side in FIG. 18 is performed by vehicle-mounted apparatus 2 and a flow on a right side in FIG. 18 is performed by the mobile communication terminal 3. The processes shown in FIG. 18 are performed repeatedly at a predetermined cycle (e.g. 1/30 second-cycle).

First, the vehicle-use map controller 30d of the mobile communication terminal 3 controls the GPS part 34 to acquire the current location where the vehicle 9 is located on the map (a step S61).

Next, the vehicle-use map controller 30d generates a wide-area map WM wider than a vehicle-use map M1 (a step S62). The vehicle-use map controller 30d generates the wide-area map WM, as shown in FIG. 5, using the map data 39b stored in the memory 39, such that the current location is in the map center CP of the wide-area map WM.

Next, the vehicle-use map controller 30d generates the vehicle-use map M1 and sends the generated vehicle-use map M1 to the vehicle-mounted apparatus 2 (a step S63). The vehicle-use map controller 30d generates the vehicle-use map M1 by clipping a region R1 from the wide-area map WM, such that the current location on the wide-area map WM is in a center of the region R1. The vehicle-use map controller 30d controls the data communicating part 38 to send the generated vehicle-use map M1 to the display 22 (the step S63). Thus, the vehicle-use map controller 30d causes the vehicle-use map M1 to be displayed on the vehicle-mounted apparatus 2.

The data communication part 28 of the vehicle-mounted apparatus 2 receives the vehicle-use map M1 sent from the mobile communication terminal 3 (a step S71). Once the vehicle-use map M1 is received, the display controller 20f of the vehicle-mounted apparatus 2 controls the display 22 to display the vehicle-use map M1 received from the mobile communication terminal 3 on the display 22 (a step S72).

Thus, the vehicle-use map M1 having the current location in the center is displayed on the vehicle-mounted apparatus 2. In a case where the destination is set, the route guiding part 30e superimposes a route leading to the destination on the vehicle-use map M1 before the vehicle-use map M1 is sent to the vehicle-mounted apparatus 2. As a result, the user (mainly the driver) can see a region around the current location and the route leading to the destination by seeing the vehicle-use map M1 displayed on the vehicle-mounted apparatus 2.

While the vehicle-use map M1 is displayed on the vehicle-mounted apparatus 2 as described above, the motion sensor 33 of the mobile communication terminal 3 detects a motion of the mobile communication terminal 3 (a step S64). The motion detector 30a controls the motion sensor 33 to acquire from the motion sensor 33 a sensor signal representing the motion of the mobile communication terminal 3. The sensor signal represents accelerations and angular speeds along/around three axes.

Next, the terminal position deriving part 30g of the mobile communication terminal 3 derives a moved distance of the mobile communication terminal 3 along each of three axes from a location derived in a previous linked display process (a series of process in FIG. 18), based on accelerations along the three axes represented by the sensor signal (a step S65).

Moreover, the terminal position deriving part 30g derives the moved distance of the mobile communication terminal 3 from the initial position along the three axes by accumulating the moved distances of the mobile communication terminal 3 derived in the linked display process repeated before. As described above, the initial position is set based on the reference position SP in the initial position setting process. Therefore, the terminal position deriving part 30g derives the relative position of the mobile communication terminal 3 to the reference position SP, based on the initial position set based on the reference position SP and on the moved distance of the mobile communication terminal 3 from the initial position (a step S66).

Next, the terminal-use map controller 30h generates the terminal-use map M2 corresponding to the relative position of the mobile communication terminal 3 to the reference position SP (a step S67). The terminal-use map controller 30h sets the terminal-use map region R2 on the wide-area map WM such that the relative position of the terminal-use map region R2 to the map center CP is matched with an actual relative position of the mobile communication terminal 3 to the reference position SP. Then, the terminal-use map controller 30h generates the terminal-use map M2 by clipping the set terminal-use map region R2 from the wide-area map WM.

Next, the terminal-use map controller 30h controls the display 32 to display the generated terminal-use map M2 on the display 32 (a step S68). Thus, the mobile communication terminal 3 displays the terminal-use map M2 showing the region corresponding to the relative position to the reference position SP.

As described above, in the communication system 10 in the sixth embodiment, the mobile communication terminal 3 mainly performs the process required for the linked display process. The mobile communication terminal 3 generates the vehicle-use map M1 by clipping the region R1 to be displayed from the wide-area map WM. The mobile communication terminal 3 sends the vehicle-use map M1 to the vehicle-mounted apparatus 2 that is the separate apparatus from the mobile communication terminal 3, and causes the vehicle-use map M1 to be displayed on the vehicle-mounted apparatus 2. Moreover, the mobile communication terminal 3 detects the motion of the mobile communication terminal 3 and derives the relative position of the mobile communication terminal 3 to the reference position SP, based on the motion. Then, the mobile communication terminal 3 generates the terminal-use map M2 by clipping from the wide-area map WM the terminal-use map region R2 corresponding to the relative position of the mobile communication terminal 3 on the wide-area map WM, and causes the generated terminal-use map M2 to be displayed.

As described above, even in a case where the mobile communication terminal 3 mainly performs the process, a different region of the wide-area map WM can be displayed, like in the first embodiment, by the vehicle-mounted apparatus 2 and the mobile communication terminal 3. The user can see a desired region of the wide-area map WM, as the terminal-use map M2, displayed on the display 32 of the mobile communication terminal 3 by moving the mobile communication terminal 3. Moreover, displaying of the terminal-use map M2 on the mobile communication terminal 3 has no influence on the vehicle-use map M1 on the vehicle-mounted apparatus 2.

In the embodiment described above, the setting image G including the setting mark CM is used in the initial position setting process. However, a different image, such as a general map, may be used as the setting image. In a case where a general map is used as the setting image, a name of place or the like located in a center of the map, instead of the setting mark CM, may be recognized by using a well-known letter recognition method.

Further, in the embodiment described above, the reference position is set to the center of the screen of the display 22 of the vehicle-mounted apparatus 2. However, like in the third embodiment, the reference position may be set to an arbitrary position of a user who operates the mobile communication terminal 3. In this case, the initial position setting part 30f may set, as the reference position, an initial position that is the position of the mobile communication terminal 3 at a time when the user performs an initial setting operation.

### 7. Seventh Embodiment

Next, a seventh embodiment is explained. A communication system 10 in the seventh embodiment also includes a vehicle-mounted apparatus 2 and a mobile communication terminal 3 that can be linked to each other to work. Therefore, a difference from the first embodiment is mainly hereinafter explained.

In the first embodiment, the user can change the region of the terminal-use map M2 to be displayed on the display 32 of the mobile communication terminal 3 by moving the mobile communication terminal 3. In the seventh embodiment, a user can perform an operation for input into the vehicle-mounted apparatus 2 by moving the mobile communication terminal 3. In the seventh embodiment, too, the vehicle-mounted apparatus 2 is a navigation apparatus including a navigation function.

### 7-1. Configuration of System

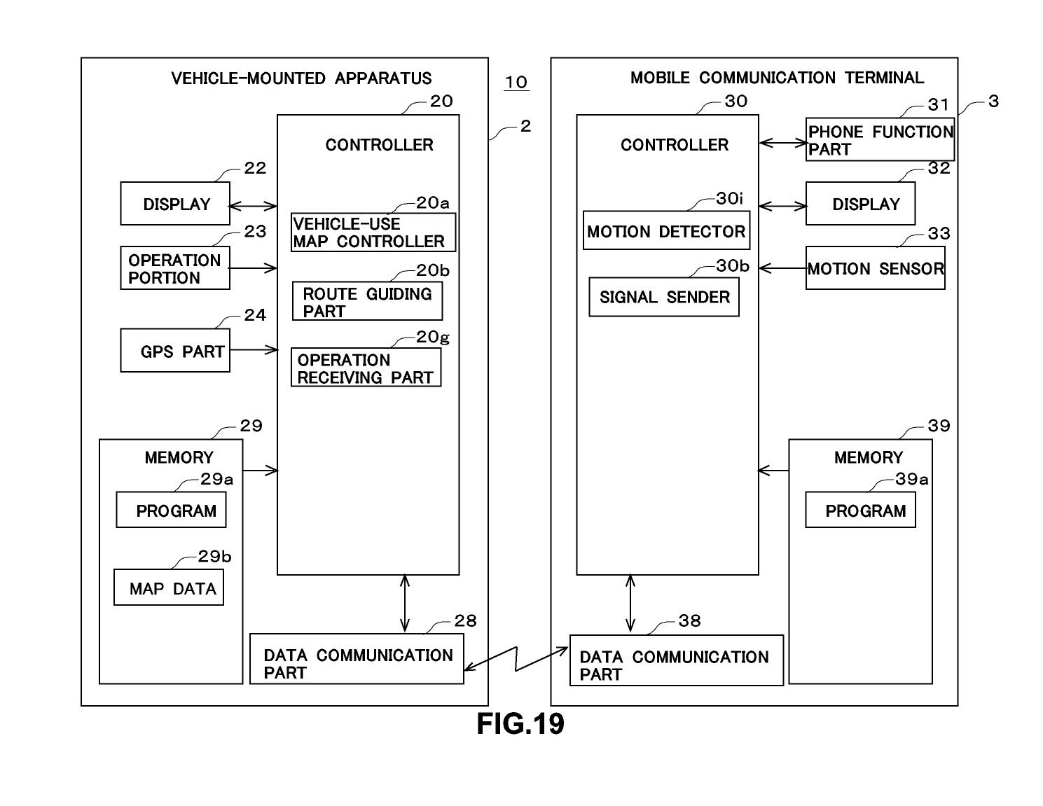

FIG. 19 illustrates a configuration of the communication system 10 in the seventh embodiment. A left side and a right side in FIG. 19 illustrate the configurations of the vehicle-mounted apparatus 2 and the mobile communication terminal 3, respectively

The vehicle-mounted apparatus 2 in the seventh embodiment does not include the camera 25 of the first embodiment shown in FIG. 2. The vehicle-mounted apparatus 2 includes a vehicle-use map controller 20a, a route guiding part 20b and an operation receiving part 20g, as processing parts implemented by software by controller 20 executing a program 29a.

The vehicle-use map controller 20a generates a vehicle-use map to be displayed on a display 22 of the vehicle-mounted apparatus 2 and causes the vehicle-use map to be displayed on the display 22. However, the vehicle-use map controller 20a in this embodiment does not generate a wide-area map WM. Moreover, the route guiding part 20b derives a route leading to a destination and superimposes the derived route on the vehicle-use map. In a case where a data communication part 28 receives from the mobile communication terminal 3 an operation signal corresponding to a motion of the mobile communication terminal 3, the operation receiving part 20g accepts the operation signal and performs a predetermined process corresponding to the operation signal.

The configuration of the mobile communication terminal 3 is substantially the same as the configuration of the first embodiment shown in FIG. 2. However, the mobile communication terminal 3 in the seventh embodiment includes a motion detector 30i and a signal sender 30b as processing parts implemented by software by a controller 30 executing a program 39a.

The motion detector 30a in the first embodiment acquires from the motion sensor 33 the sensor signal representing the motion of the mobile communication terminal 3. On the other hand, the motion detector 30i in the seventh embodiment acquires from a motion sensor 33 a sensor signal representing a motion of the mobile communication terminal 3. Then, the motion detector 30i recognizes user operations, such as a direction changing operation, a determination operation and a cancel operation, based on the sensor signal, and generates the operation signal representing the user operation. The signal sender 30b controls a data communicating part 38 to send to the vehicle-mounted apparatus 2 the operation signal generated by the motion detector 30i as a terminal signal.

### 7-2. Outline of Linked Operation

Next explained is an outline of a linked operation between the vehicle-mounted apparatus 2 and the mobile communication terminal 3 of the communication system 10 in the seventh embodiment.

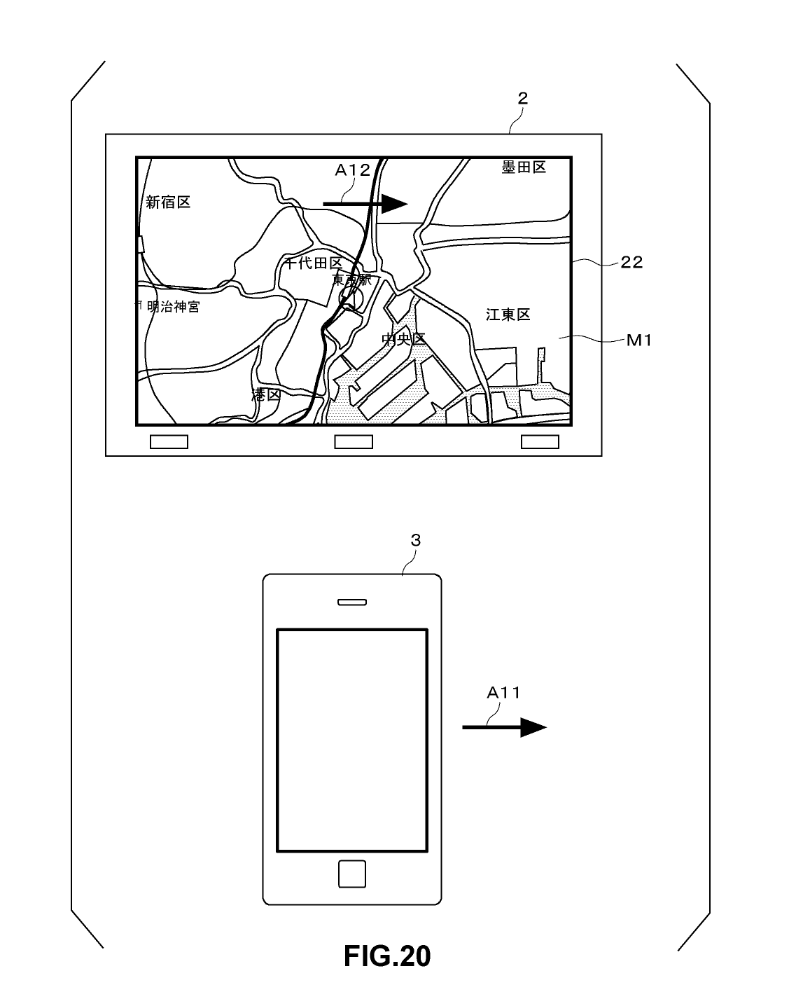

FIG. 20 illustrates an example of the linked operation between the vehicle-mounted apparatus 2 and the mobile communication terminal 3. In FIG. 20, a vehicle-use map M1 is displayed on the display 22 of the vehicle-mounted apparatus 2.

In a state where the vehicle-use map M1 is displayed on the vehicle-mounted apparatus 2, the user can scroll the vehicle-use map M1 displayed on the vehicle-mounted apparatus 2 by moving the mobile communication terminal 3 substantially in parallel to a screen of the display 22 of the vehicle-mounted apparatus 2.

For example, in a case where the user moves the mobile communication terminal 3 rightward, as shown by an arrow A11, the motion of the mobile communication terminal 3 is recognized as the direction changing operation. Therefore, in this case, the vehicle-mounted apparatus 2 scrolls the vehicle-use map M1 rightward as shown by an arrow A12 and displays the scrolled vehicle-use map M1. Similarly, in a case where the user moves the mobile communication terminal 3 leftward, upward, or downward, the vehicle-mounted apparatus 2 scrolls the vehicle-use map M1 leftward, upward, or downward, respectively, and displays the scrolled vehicle-use map M1.

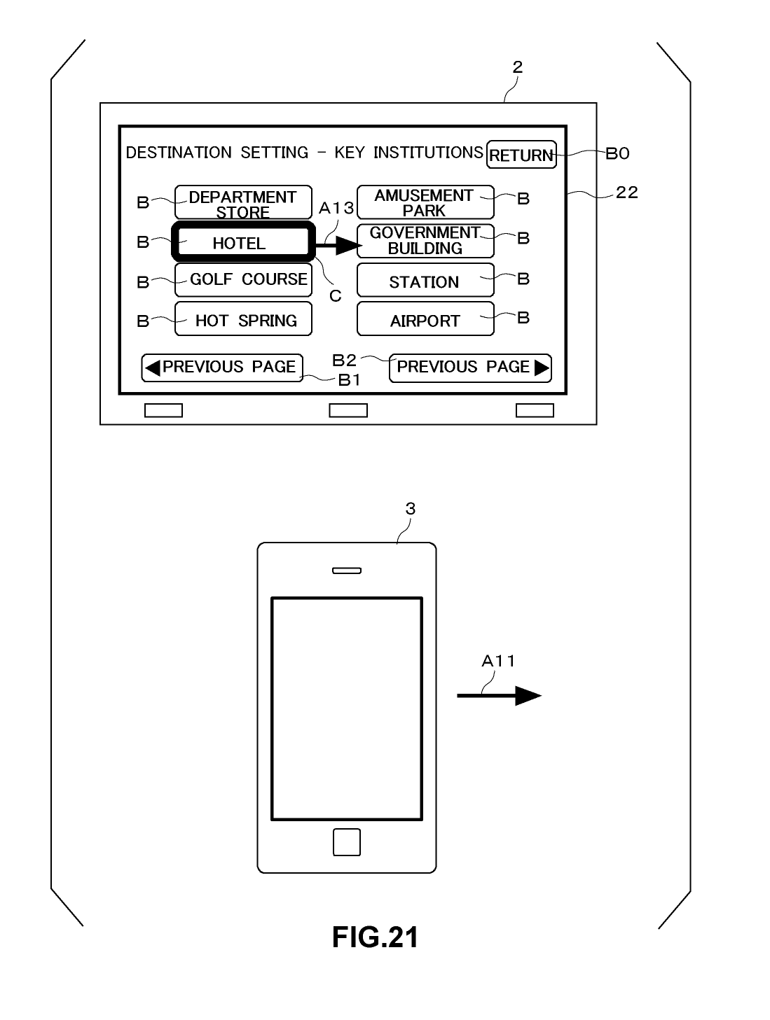

FIG. 21 illustrates an example of the linked operation between the vehicle-mounted apparatus 2 and the mobile communication terminal 3. FIG. 21 illustrates a setting screen including a plurality of command buttons on the display 22 of the vehicle-mounted apparatus 2. The setting screen shown in FIG. 21 is a destination setting screen for setting a destination.

The destination setting screen shown in FIG. 21 includes a plurality of institution buttons B that serve as a list of candidate institution types to narrow down a destination, a return button B0 that is used to return to a previous setting screen and page changing buttons B1 and B2 that are used to move up or down a page to show other candidates in the list. Generally, these command buttons B, B0, B1 and B2 are operated by a direct touch of the user to the buttons.

In a state where the setting screen including the command buttons is displayed on the vehicle-mounted apparatus 2, the user can cause the vehicle-mounted apparatus 2 to perform operations relating to the command buttons by moving the mobile communication terminal 3.

For example, as shown by the arrow A11, in a case where the user moves the mobile communication terminal 3 rightward, the motion of the mobile communication terminal 3 is recognized as the direction changing operation for moving rightward. Therefore, in this case, in response to the motion, the vehicle-mounted apparatus 2 moves a cursor C rightward as shown by an arrow A13 to activate one of the command buttons B. Similarly, in a case where the user moves the mobile communication terminal 3 leftward, upward or downward, the vehicle-mounted apparatus 2 moves the cursor C leftward, upward or downward, respectively.

Moreover, for example, in a case where the user moves the mobile communication terminal 3 toward the screen of the display 22 (a direction orthogonal to a main surface of the mobile communication terminal 3), the motion of the mobile communication terminal 3 is recognized as the determination operation. Therefore, in this case, the vehicle-mounted apparatus 2 selects the command button B activated by the cursor C. Moreover, in a case where the user jiggles the mobile communication terminal 3 from side to side, the motion is recognized as the cancel operation and causes the vehicle-mounted apparatus 2 to perform a same process as a process performed when the return button B0 is selected.

Further, in a case where the user moves the mobile communication terminal 3 leftward or rightward and then turns the mobile communication terminal 3 along a vertical axis of the main surface of the mobile communication terminal 3, the motion of the mobile communication terminal 3 is recognized as a flick operation. A leftward flick operation causes the vehicle-mounted apparatus 2 to perform a same process as a process performed when the page changing button B1 is selected. A rightward flick operation causes the vehicle-mounted apparatus 2 to perform a same process as a process performed when the page changing button B2 is selected.

### 7-3. Flow of Linked Operation

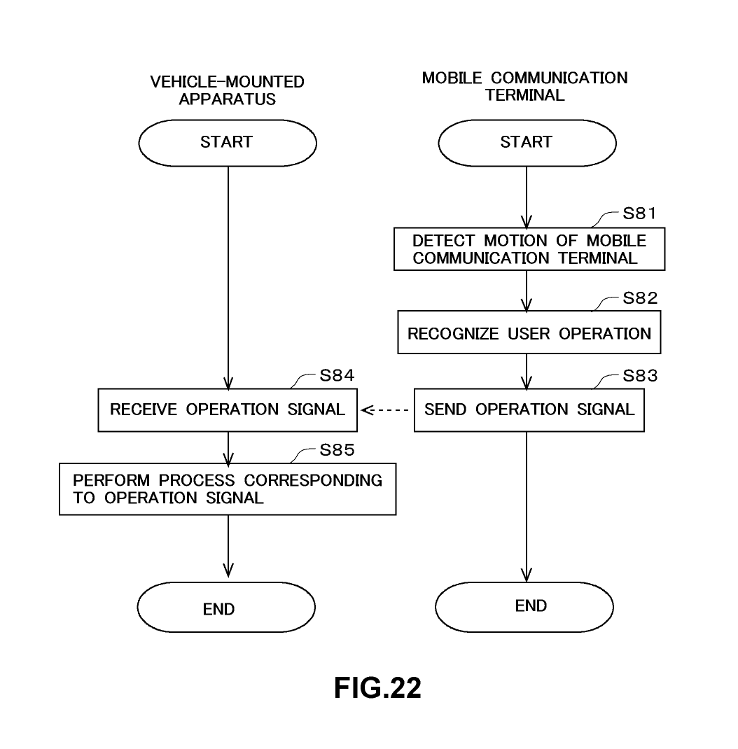

Next explained is a flow of the linked operation that is performed by the communication system 10 in the seventh embodiment. FIG. 22 illustrates the flow of a process of the linked operation performed in the seventh embodiment. At a start of the linked operation, a predetermined application has already been executed in the mobile communication terminal 3 to link the mobile communication terminal 3 to the vehicle-mounted apparatus 2. Thus, the motion detector 30i and the signal sender 30b of the mobile communication terminal 3 are activated. Moreover, the vehicle-mounted apparatus 2 and the mobile communication terminal 3 are ready to communicate to each other.

A flow on a left side in FIG. 22 is performed by vehicle-mounted apparatus 2 and a flow on a right side in FIG. 22 is performed by the mobile communication terminal 3. The processes shown in FIG. 22 are performed repeatedly at a predetermined cycle (e.g. 1/30 second-cycle).

First, the motion sensor 33 of the mobile communication terminal 3 detects the motion of the mobile communication terminal 3 (a step S81). The motion detector 30i controls the motion sensor 33 to acquire the sensor signal representing the motion of the mobile communication terminal 3 from the motion sensor 33. The sensor signal represents accelerations and angular speeds along/around three axes.

The motion detector 30i recognizes, based on the sensor signal, a type of a user operation, such as the direction changing operation, the determination operation, the cancel operation and the flick operation, represented by the detected motion of the mobile communication terminal 3 (a step S82). Then the motion detector 30i generates an operation signal representing the recognized user operation.

Next, the signal sender 30b of the mobile communication terminal 3 controls the data communicating part 38 to send to the vehicle-mounted apparatus 2 the operation signal as the terminal signal corresponding to the motion of the mobile communication terminal 3 (a step S83).

The data communication part 28 of the vehicle-mounted apparatus 2 receives the operation signal sent from the mobile communication terminal 3 (a step S84). The operation receiving part 20g of the vehicle-mounted apparatus 2 performs the process corresponding to the user operation represented by the operation signal (a step S85). In other words, the operation receiving part 20g controls the display 22, etc. to perform a process such as scrolling of the vehicle-use map M1 and moving of the cursor C.

As described above, in the seventh embodiment, since the vehicle-mounted apparatus 2 performs the process corresponding to the motion of the mobile communication terminal 3, even a user (located away from the vehicle-mounted apparatus 2) other than the main user (the driver) of the vehicle-mounted apparatus 2 can perform various operations for input into the vehicle-mounted apparatus 2 by moving the mobile communication terminal 3.

Moreover, since a general mobile communication terminal that the user uses daily can be used as the mobile communication terminal 3 of the communication system 10, the foregoing function can be implemented at a relative low cost.

There is a possibility that after the user moves the mobile communication terminal 3 as the user operation from an original position to another position, a motion caused by moving the mobile communication terminal 3 back to the original position is recognized as a different user operation. Therefore, the motion detector 30i may be configured not to detect a next user operation for a predetermined time period (e.g. 0.5 sec) after the motion detector 30i recognizes one user operation.

Moreover, the motion detector 30i may be configured to recognize that motions of the mobile communication terminal 3 moved in a portrait position and motions of the mobile communication terminal 3 moved in a landscape position are different user operations. For example, in the case shown in FIG. 20, when the mobile communication terminal 3 is moved in the portrait position, the vehicle-mounted apparatus 2 scrolls the vehicle-use map M1, and when the mobile communication terminal 3 is moved in the landscape position, the vehicle-mounted apparatus 2 changes a scale of the vehicle-use map M1.

Further, in the embodiment described above, the mobile communication terminal 3 recognizes the user operation based on the sensor signal. However, the vehicle-mounted apparatus 2 may recognize the user operation based on the sensor signal sent from the mobile communication terminal 3 to the vehicle-mounted apparatus 2.

### 8. Eighth Embodiment

Next, an eighth embodiment is explained. A communication system 10 in the eighth embodiment also includes a vehicle-mounted apparatus 2 and a mobile communication terminal 3 that can be linked to each other to work. Therefore, a difference from the seventh embodiment is mainly hereinafter explained.

In the seventh embodiment, the user can perform the operation for input into the vehicle-mounted apparatus 2 by moving the mobile communication terminal 3 in hand. On the other hand, in the eighth embodiment, a user can perform an operation for input into the vehicle-mounted apparatus 2 by moving, for example, a hand of the user in an image-capturing range of a camera included in the mobile communication terminal 3.

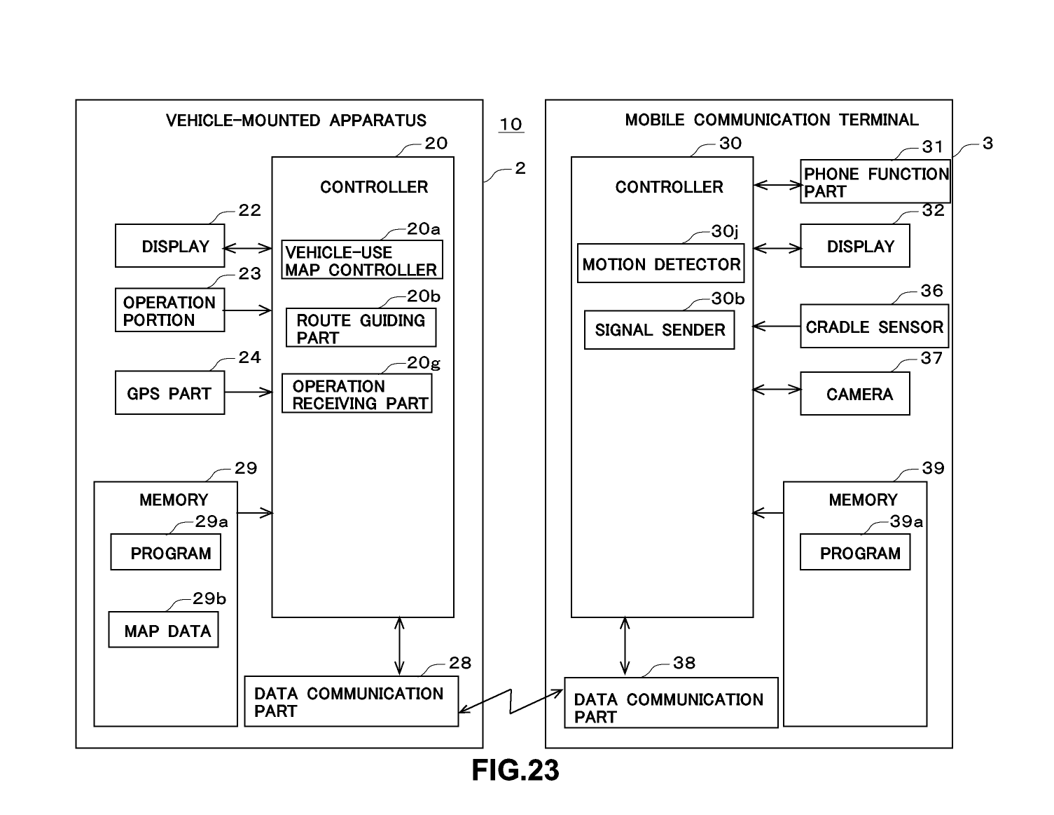

FIG. 23 illustrates a configuration of the communication system 10 in the eighth embodiment. A left portion of FIG. 23 illustrates a configuration of the vehicle-mounted apparatus 2 and a right portion of FIG. 23 illustrates a configuration of the mobile communication terminal 3. The configuration of the vehicle-mounted apparatus 2 is the same as the configuration of the vehicle-mounted apparatus 2 of the seventh embodiment shown in FIG. 19.

On the other hand, the configuration of the mobile communication terminal 3 in the eighth embodiment does not include the motion sensor 33 from the configuration of the seventh embodiment shown in FIG. 19 and includes a cradle sensor 36 and a camera 37.

The cradle sensor 36 detects whether or not the mobile communication terminal 3 is placed in a cradle that is a holding member disposed to a predetermined location of a vehicle 9. For example, in a case where the cradle includes a charging function, the cradle sensor 36 detects based on voltage of a charging terminal whether or not the mobile communication terminal 3 is placed in the cradle. The cradle is placed to the location, for example, near a passenger's seat or a back seat where the user who mainly operates the mobile communication terminal 3.

The camera 37 includes a lens and an image sensor. The camera 37 captures an image of an object and electronically acquires the captured image. The camera 37 is provided on a main surface on a side on which a display 32 is provided. Therefore, the camera 37 captures the image of an object existing on a side of the user who sees the display 32.

The mobile communication terminal 3 includes a motion detector 30j and a signal sender 30b as part of the processing parts implemented by software by the controller 20 executing a program 29a.

The motion detector 30i in the seventh embodiment acquires the operation signal based on the signal from the motion sensor 33. On the other hand, the motion detector 30j in the eighth embodiment detects a motion of a hand of the user based on images continuously captured by the camera 37. Then, the motion detector 30j recognizes a user operation, such as a direction changing operation, a determination operation and a cancel operation, based on the motion of the hand, and generates an operation signal representing the user operation. The signal sender 30b controls a data communicating part 38 to send to the vehicle-mounted apparatus 2 the operation signal generated by the motion detector 30j as a terminal signal.

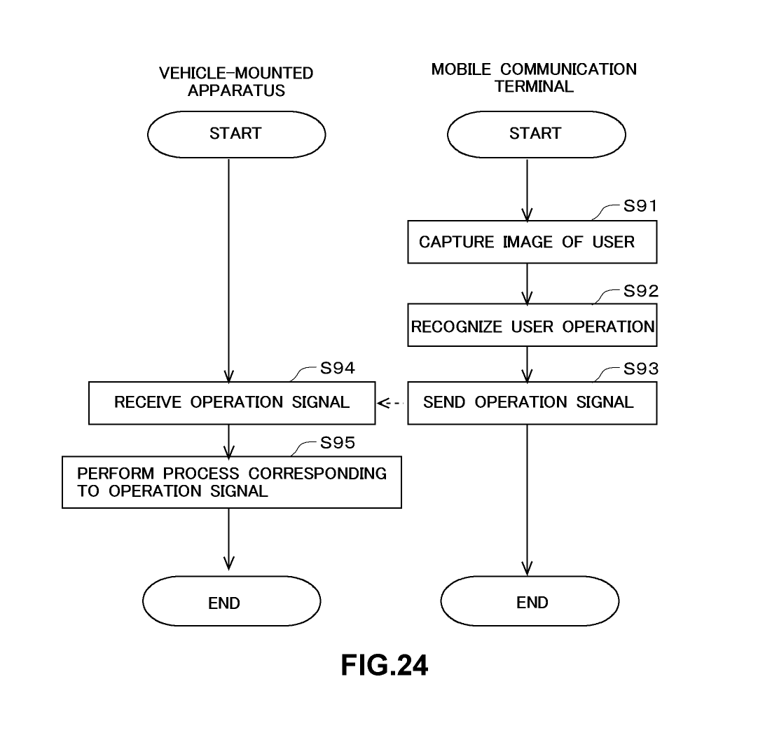

FIG. 24 illustrates a flow of the process of a linked operation in the eighth embodiment. At a start point of the operation, a predetermined application has already been executed in the mobile communication terminal 3 to link the mobile communication terminal 3 to the vehicle-mounted apparatus 2. Thus, the motion detector 30j and the signal sender 30b of the mobile communication terminal 3 are activated. Moreover, the vehicle-mounted apparatus 2 and the mobile communication terminal 3 are ready to communicate to each other.

A left portion of FIG. 24 illustrates a configuration of the vehicle-mounted apparatus 2 and a right portion of FIG. 24 illustrates a configuration of the mobile communication terminal 3. The processes shown in FIG. 24 are performed repeatedly at a predetermined cycle (e.g. 1/30 second-cycle). The processes shown in FIG. 24 are performed after the mobile communication terminal 3 in the cradle is confirmed by the cradle sensor 36 and after a predetermined start command of the processes is given by the user. Such a command may be given by, for example, utterance of a predetermined keyword by the user in use of a voice recognition technology.

First, the camera 37 of the mobile communication terminal 3 captures an image of the hand of the user (a step S91). The motion detector 30i controls the camera 37 to continuously acquire captured images including the image of the hand of the user.

The motion detector 30j recognizes the image of the hand of the user included in each of the plural continuously-captured images, based on a color and a shape of the images of the hand, and detects the motion of the hand from motion of the images. Then, the motion detector 30j recognizes, based on a sensor signal, a type of the user operation, such as the direction changing operation, the determination operation, the cancel operation and the flick operation, represented by the detected motion of the user (a step S92). Then the motion detector 30i generates the operation signal representing the recognized user operation.

Next, the signal sender 30b of the mobile communication terminal 3 controls the data communicating part 38 to send to the vehicle-mounted apparatus 2 the operation signal as the terminal signal corresponding to the motion of the hand of the user (a step S93).

The data communication part 28 of the vehicle-mounted apparatus 2 receives the operation signal sent from the mobile communication terminal 3 (a step S94). An operation receiving part 20g of the vehicle-mounted apparatus 2 performs a process corresponding to the user operation represented by the operation signal (a step S95).

As described above, by using the communication system 10 of the eighth embodiment, the user can causes the vehicle-mounted apparatus 2 to perform a desired process by moving the hand of the user in the image-capturing range of the camera 37 included in the mobile communication terminal 3. Since the cradle in which the mobile communication terminal 3 is placed can be disposed to a desired position in the vehicle 9, even a user (located away from the vehicle-mounted apparatus 2) other than the main user (the driver) of the vehicle-mounted apparatus 2 can perform various operations for input into the vehicle-mounted apparatus 2 by moving, for example, the hand of the user.

### 9. Modifications of First to Eighth Embodiments

The first to the eighth embodiments are described above. However, various modifications of the first to the eighth embodiments are possible. Such modifications are hereinafter described. Any of all forms of the first to the eighth embodiments described above and the modifications described below can be arbitrarily combined with another.

In the foregoing first to eighth embodiments, the vehicle-mounted apparatus 2 that is an electronic apparatus is linked to the mobile communication terminal 3 to work. However, the mobile communication terminal 3 may be linked to a different electronic apparatus, such as a household television.

Moreover, in the foregoing first to eighth embodiments, the motion sensor 33 of the mobile communication terminal 3 detects the motion of the mobile communication terminal 3. However, the motion of the mobile communication terminal 3 may be detected by using a different method, such as an optical flow method. For example, in a case of the optical flow method, by extracting characteristic points from each of plural captured images (frames) captured by a camera included in the mobile communication terminal 3, the motion of the mobile communication terminal 3 can be detected based on a direction of an optical flow representing movement of the characteristic points in the plural captured images.

Further, in the foregoing first to sixth embodiments, the map center CP on the map displayed in the center position of the screen of the display 22 of the vehicle-mounted apparatus 2 is defined as the current location where the vehicle 9 is currently located. On the other hand, the map center CP may be changed from the current position to a different position by a user operation with the vehicle-mounted apparatus 2. In a case, like this, where the map center CP is changed to a different position from the current location, the changed map center CP may be used as the reference position for setting the terminal-use map region R2 to be displayed as the terminal-use map M2, instead of the current location. In addition, the user may choose either of the map center CP and the current position as a reference position for setting the terminal-use map region R2.

Further, in the foregoing first to sixth embodiments, the content to be displayed is a map. However, the displayed content may be any content, such as an image, a web page and an electronic program guide (EPG), as long as a region of the content is displayed on the screen and the other region of the content is displayed by scrolling the content. For example, in a case where an EPG is the content to be displayed, generally, a region including programs broadcasted in a time period including a current time (region including currently broadcasted programs) is mainly displayed on the screen from the EPG and the remaining region of the EPG for the other time period are scrolled to be displayed. Therefore, in this case, while the region of the EPG showing the programs broadcasted in the time period including the current time is displayed on the vehicle-mounted apparatus 2, the user can cause a region of the EPG showing a desired different time period to be displayed on the screen of the mobile communication terminal 3.

Further, the communication system in the foregoing first to sixth embodiments may receive a user operation with the mobile communication terminal 3 as an operation relating to a content displayed on the mobile communication terminal 3. Thus, operability by the user operation can be improved. For example, in the communication system including a navigation function, in a case where a user operation to specify a location is performed while the terminal-use map M2 is being displayed on the mobile communication terminal 3, the communication system may register a point (institution) on the terminal-use map M2 specified by the user as a registered point (registered institution). Moreover, for example, in a communication system including a digital TV reception function, in a case where a user operation to select a program is performed while an electronic program guide is being displayed on the mobile communication terminal 3, the communication system may cause the program selected by the user to be displayed or reserved (receiving reservation or recording reservation). In such a case, the communication system may identify the point or the program selected by the user based on a region of the content displayed on the mobile communication terminal 3 and on a position of the user operation performed with a touch panel.

Further, in the foregoing first to sixth embodiments, a position of the mobile communication terminal 3, i.e., in a portrait position or a landscape position, is not considered. However, the terminal-use map region R2 displayed as the terminal-use map M2 may be set in consideration of the position.

Further, in the foregoing first to sixth embodiments, the scale of the terminal-use map M2 displayed on the mobile communication terminal 3 is the same as the scale of the vehicle-use map M1 displayed on the vehicle-mounted apparatus 2. However, the scale of the terminal-use map M2 may be changed by the user to be a different scale from the scale of the vehicle-use map M1.

In the foregoing embodiments, the various functions are implemented by software using the CPU executing the arithmetic processing in accordance with the program. However, a part of the functions may be implemented by an electrical hardware circuit.

### 10-1. Ninth Embodiment

Next, a ninth embodiment is explained. In the ninth embodiment, a function of improving operability of the communication system in the foregoing embodiments is explained.

For easy understanding of the explanation, a case of displaying a map is taken as an example to explain functions below. Moreover, the functions below are explained, taking, as an example, a case where an image to be displayed on a mobile communication terminal 3 is generated by the mobile communication terminal. However, the image to be displayed on the mobile communication terminal 3 may be generated by a vehicle-mounted apparatus 2. Further, the image to be displayed on the mobile communication terminal 3 may be generated in an information center linked to the mobile communication terminal 3 or the vehicle-mounted apparatus 2. In these cases, necessary data is communicated among the apparatus, the terminal and the center.

### 10-1. Function of Displaying Position of Mobile Communication Terminal

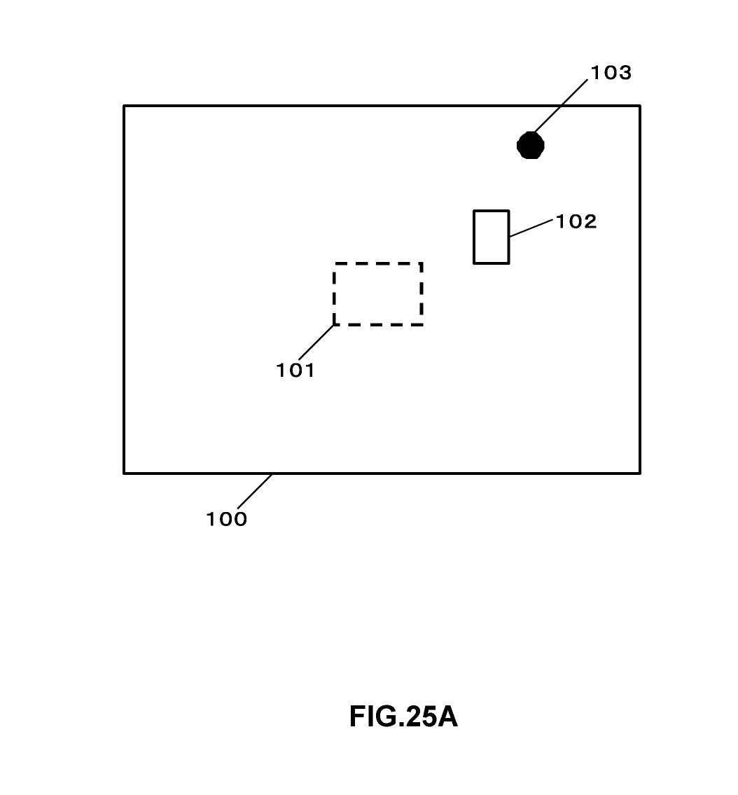

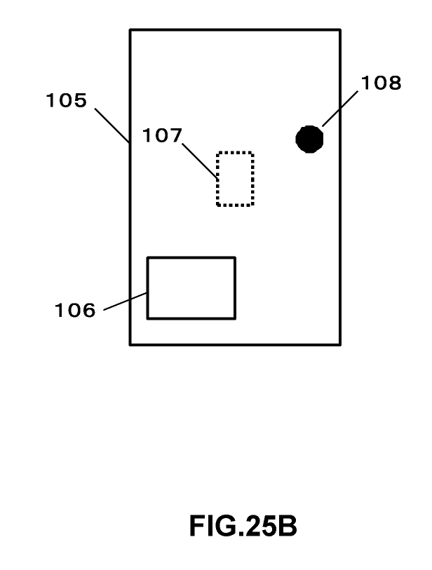

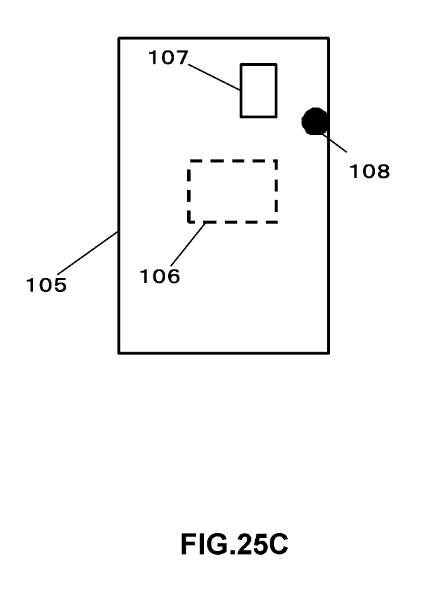

Each of FIG. 25A, FIG. 25B and FIG. 25C illustrates an outline of a function of displaying a position of the mobile communication terminal.

A map is displayed on a screen 100 of the vehicle-mounted apparatus 2. Moreover, a screen 105 of the mobile communication terminal 3 displays a map showing a region corresponding to a position of the mobile communication terminal 3 on a wide-area map that is a virtual map wider than the map displayed on the screen 100 of the vehicle-mounted apparatus 2. A vehicle-mounted apparatus mark 101 representing a position of the vehicle-mounted apparatus 2, a mobile communication terminal mark 102 representing a position of the mobile communication terminal 3 and a destination mark 103 representing a position of a destination are displayed on the screen 100 of the vehicle-mounted apparatus 2, as shown in FIG. 25A. Positions of the vehicle-mounted apparatus mark 101, the mobile communication terminal mark 102 and the destination mark 103 on the screen 100 is similar to the positions of the vehicle-mounted apparatus 2 (the screen 100), the mobile communication terminal 3 (the screen 105) and the destination on the wide-area map. Further, a size (shape) of the vehicle-mounted apparatus mark 101 displayed on the screen is similar to an actual size (shape) of the screen 100 of the actual vehicle-mounted apparatus 2. A size of the mobile communication terminal mark 102 is similar to an actual size of the screen 105 of the mobile communication terminal 3. Therefore, a user can easily understands a positional relationship, distances, etc. among the vehicle-mounted apparatus 2, the mobile communication terminal 3 and the destination.

Distances between the vehicle-mounted apparatus mark 101, the mobile communication terminal mark 102 and the destination mark 103 and the sizes of those marks are adjusted to be displayable on the screen 100 of the vehicle-mounted apparatus 2. In a case where the vehicle-mounted apparatus mark 101 representing the position of the vehicle-mounted apparatus 2 is displayed in a predetermined position (recommended to be placed in a center of the screen 100) on the screen 100 of the vehicle-mounted apparatus 2, the user can easily understand the positional relationship and the distances among/between the vehicle-mounted apparatus 2, the mobile communication terminal 3 and the destination even without displaying the vehicle-mounted apparatus mark 101.

A vehicle-mounted apparatus mark 106 representing the position of the vehicle-mounted apparatus 2, a mobile communication terminal mark 107 representing the position of the mobile communication terminal 3 and a destination mark 108 representing the destination are displayed on the screen 105 of the mobile communication terminal 3, as shown in FIG. 25B and FIG. 25C.

Positions of the vehicle-mounted apparatus mark 106, the mobile communication terminal mark 107 and the destination mark 108 on the screen 105 are similar to the positions of the vehicle-mounted apparatus 2 (the screen 100), the mobile communication terminal 3 (the screen 105) and the destination 103 on the wide-area map. Further, a size of the vehicle-mounted apparatus mark 106 on the screen 105 is similar to the size of the screen 100 of the actual vehicle-mounted apparatus 2. A size of the mobile communication terminal mark 107 is similar to the size of the screen 105 of the mobile communication terminal 3. Therefore, the user can easily understands the positional relationship, distances, etc. among the vehicle-mounted apparatus 2, the mobile communication terminal 3 and the destination.

Distances among the vehicle-mounted apparatus mark 106, the mobile communication terminal mark 107 and the destination mark 108 and the sizes of those marks are adjusted to be displayable on the screen 105 of the mobile communication terminal 3.

FIG. 25B illustrates an example of displaying the mobile communication terminal mark 107 in a center of the screen 105 of the mobile communication terminal 3. FIG. 25C illustrates an example of displaying the vehicle-mounted apparatus mark 106 in the center of the screen 105 of the mobile communication terminal 3. A method of displaying the marks may be arbitrarily selected, depending on an intended use and/or on a preference of the user. It is recommended that the method of displaying the marks should be changed, depending on an operation selected by the user and/or on the intended use.

In a case where the mobile communication terminal mark 107 representing the position of the mobile communication terminal 3 is positioned in the predetermined position (recommended to be positioned in the center position) on the screen 100 of the vehicle-mounted apparatus 2 (FIG. 25B), the user can easily understand the positional relationship and the distances even without displaying the mobile communication terminal mark 107 or the vehicle-mounted apparatus mark 106.

In a case where the vehicle-mounted apparatus mark 106 representing the position of the vehicle-mounted apparatus 2 is positioned in a predetermined position (recommended to be positioned in the center position) on the screen 105 of the mobile communication terminal 3 (FIG. 25C), the user can easily understand the positional relationship and the distances even without displaying the mobile communication terminal mark 107 or the vehicle-mounted apparatus mark 106.

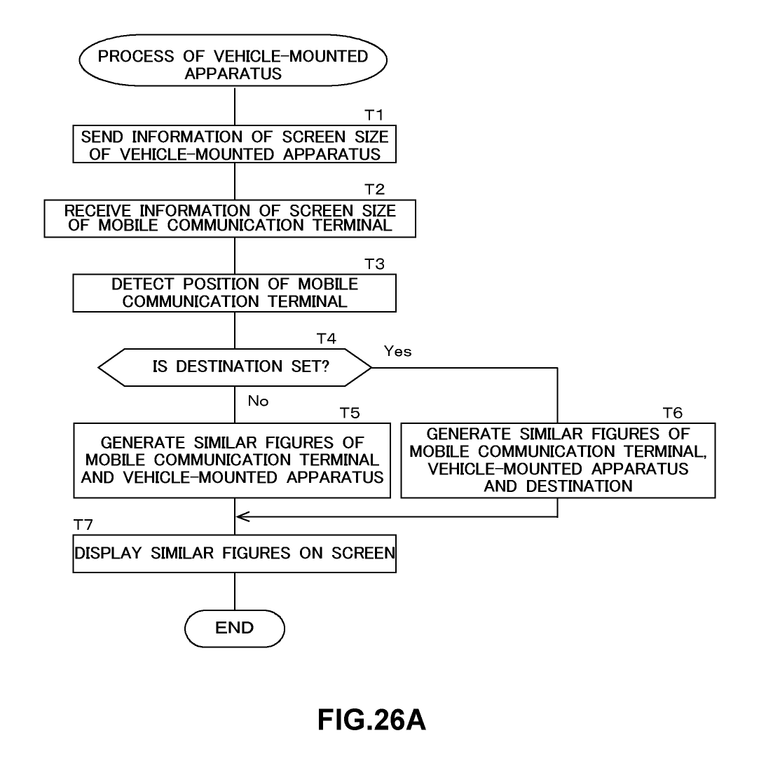

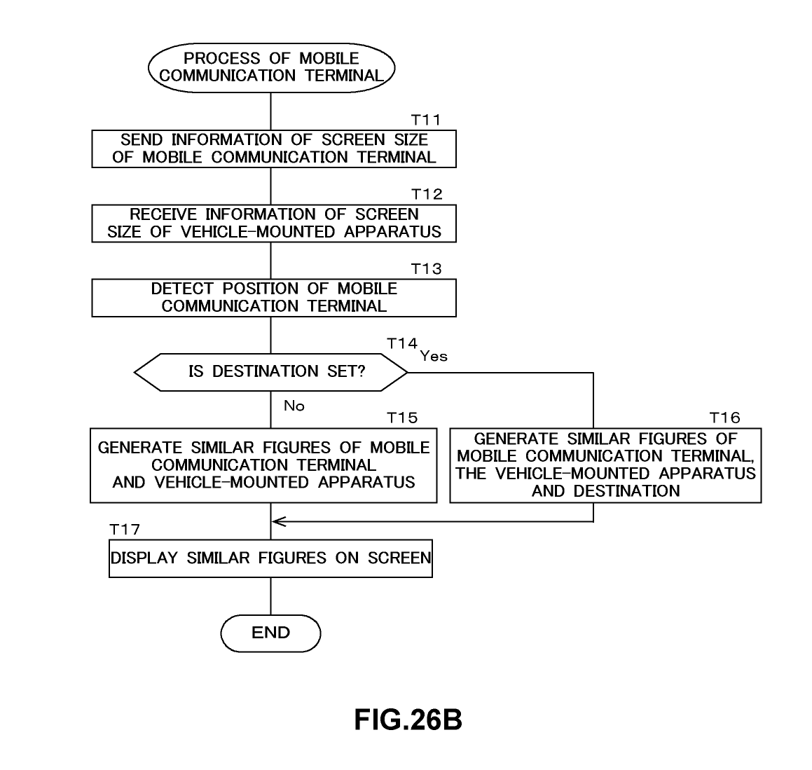

Next explained is a process that is performed by each of microcomputers of the vehicle-mounted apparatus 2 and the mobile communication terminal 3 to display the position of the mobile communication terminal 3. FIG. 26A illustrates a flow of the process that is performed by the vehicle-mounted apparatus 2. The process is performed repeatedly during a linked operation between the vehicle-mounted apparatus 2 and the mobile communication terminal 3.

The microcomputer of the vehicle-mounted apparatus 2 (hereinafter referred to as “vehicle-mounted microcomputer”) sends information relating to the size of the screen 100 of the vehicle-mounted apparatus 2 to the mobile communication terminal 3 in a step T1 and moves to a step T2. In the step T2, the vehicle-mounted microcomputer receives information relating to the size of the screen 105 of the mobile communication terminal 3 sent from the mobile communication terminal 3 and moves to a step T3. In the step T3, the vehicle-mounted microcomputer detects the position of the mobile communication terminal 3 and moves to a step T4. In the step T4, the vehicle-mounted microcomputer determines whether or not the destination is set in a navigation function. In the step T4, in a case where the vehicle-mounted microcomputer determines that the destination is set in the navigation function, the vehicle-mounted microcomputer moves to a step T6. In the step T4, in a case where the vehicle-mounted microcomputer determines that the destination is not set in the navigation function, the vehicle-mounted microcomputer moves to a step T5.

In the step T5, the vehicle-mounted microcomputer generates an image to be displayed (hereinafter referred to as “displayed image”) such that displayed positions of the vehicle-mounted apparatus mark 101, the mobile communication terminal mark 102 and the destination mark 103 are similar to the positions of the vehicle-mounted apparatus 2 (the screen 100) and the mobile communication terminal 3 (the screen 105) and the destination 103 on the map to be displayed (hereinafter referred to as “displayed map”), respectively. In addition, in the step T5, the vehicle-mounted microcomputer generates the displayed image such that the sizes of the vehicle-mounted apparatus mark 101 and the mobile communication terminal mark 102 are similar to the screen 100 of the vehicle-mounted apparatus 2 and the screen 105 of the mobile communication terminal 3, respectively. Further, in the step T5, the vehicle-mounted microcomputer generates displayed images of the vehicle-mounted apparatus mark 101 and the mobile communication terminal mark 102 such that the vehicle-mounted apparatus mark 101 and the mobile communication terminal mark 102 are displayable on the screen 100 of the vehicle-mounted apparatus 2 and moves to a step T7.

In the step T6, the vehicle-mounted microcomputer generates a displayed image such that the displayed positions of the vehicle-mounted apparatus mark 101, the mobile communication terminal mark 102 and the destination mark 103 are similar to the positions of the vehicle-mounted apparatus 2 (the screen 100), the mobile communication terminal 3 (the screen 105) and the destination on the displayed map, respectively. In addition, in the step T6, the vehicle-mounted microcomputer generates the displayed image such that the sizes of the vehicle-mounted apparatus mark 101 and the mobile communication terminal mark 102 are similar to the sizes of the screen 100 of the vehicle-mounted apparatus 2 and the screen 105 of the mobile communication terminal 3, respectively. Further, in the step T6, the vehicle-mounted microcomputer generates the displayed images of the vehicle-mounted apparatus mark 101, the mobile communication terminal mark 102 and the destination mark 103 such that the vehicle-mounted apparatus mark 101, the mobile communication terminal mark 102 and the destination mark 103 are displayable on the screen 100 of the vehicle-mounted apparatus 2, and moves to the step T7.

In the step T7, the vehicle-mounted microcomputer superimposes the displayed images generated in the step T5 or in the step T6 on the displayed map and then causes the superimposed displayed map to be displayed. Once the map is displayed, the vehicle-mounted microcomputer ends the process.

FIG. 26B illustrates a flow of the process that is performed by the mobile communication terminal 3. The process is performed repeatedly during the linked operation between the vehicle-mounted apparatus 2 and the mobile communication terminal 3.

The microcomputer of the mobile communication terminal 3 (hereinafter referred to as “mobile communication microcomputer”) sends the information relating to the size of the screen 105 of the mobile communication terminal 3 to the vehicle-mounted apparatus 2 in a step T11 and move to a step T12. In the step T12, the mobile communication microcomputer receives the information relating to the size of the screen 100 of the vehicle-mounted apparatus 2 sent from the vehicle-mounted apparatus 2 and moves to a step T13. In the step T13, the mobile communication microcomputer detects the position of the mobile communication terminal 3 and moves to a step T14. In the step T14, the mobile communication microcomputer determines whether or not the destination is set in the navigation function. In the step T14, in a case where the mobile communication microcomputer determines that the destination is set in the navigation function, the mobile communication microcomputer moves to a step T16. In the step T14, in a case where the mobile communication microcomputer determines that the destination is not set in the navigation function, the mobile communication microcomputer moves to a step T15.

In the step T15, the mobile communication microcomputer generates a displayed image such that displayed positions of the vehicle-mounted apparatus mark 106 and the mobile communication terminal mark 107 are similar to the positions of the vehicle-mounted apparatus 2 (the screen 100) and the mobile communication terminal 3 (the screen 105) on a displayed map, respectively. In addition, in the step T15, the mobile communication microcomputer generates the displayed image such that the sizes of the vehicle-mounted apparatus mark 106 and the mobile communication terminal mark 107 are similar to the screen 100 of the vehicle-mounted apparatus 2 and the screen 105 of the mobile communication terminal 3, respectively. Further, in the step T15, the mobile communication microcomputer generates displayed images of the vehicle-mounted apparatus mark 106 and the mobile communication terminal mark 107 such that the vehicle-mounted apparatus mark 106 and the mobile communication terminal mark 107 are displayable on the screen 100 of the vehicle-mounted apparatus 2 and moves to a step T17

In the step T16, the mobile communication microcomputer generates a displayed image such that the displayed positions of the vehicle-mounted apparatus mark 106, the mobile communication terminal mark 107 and the destination mark 108 are similar to the positions of the vehicle-mounted apparatus 2 (the screen 100), the mobile communication terminal 3 (the screen 105) and the destination on the displayed map, respectively. In addition, in the step T16, the mobile communication microcomputer generates displayed images such that the sizes of the vehicle-mounted apparatus mark 106 and the mobile communication terminal mark 107 are similar to the sizes of the screen 100 of the vehicle-mounted apparatus 2 and the screen 105 of the mobile communication terminal 3, respectively. Further, in the step T16, the vehicle-mounted microcomputer generates the displayed images of the vehicle-mounted apparatus mark 106, the mobile communication terminal mark 107 and the destination mark 108 such that the vehicle-mounted apparatus mark 106, the mobile communication terminal mark 107 and the destination mark 108 are displayable on the screen 100 of the vehicle-mounted apparatus 2, and moves to the step T17. In the step T17, the mobile communication microcomputer superimposes the displayed images generated in the step T15 or in the step T16 on the displayed map and then causes the superimposed displayed map to be displayed. Once the map is displayed, the mobile communication microcomputer ends the process.

<Adjusting Function of Move of Mobile Communication Terminal/Map>

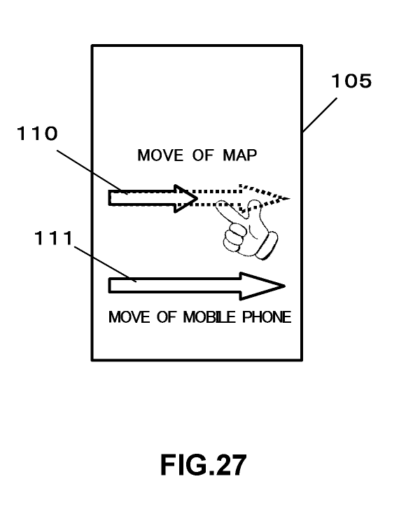

FIG. 27 illustrates an outline of a function of adjusting a speed of moving a map.

A reference distance bar and a move distance bar 111 are displayed on the screen 105 of the mobile communication terminal 3. The reference distance bar indicates a reference distance by which the mobile communication terminal 3 is moved (hereinafter referred to as “reference moved distance”). The move distance bar 111 indicates a distance by which the displayed map is moved (scrolled) (hereinafter referred to as “moved distance of the displayed map”) in a case where the mobile communication terminal 3 is moved by the reference moved distance (hereinafter referred to as “moved distance of the mobile communication terminal”). In a case where the move distance bar 111 is lengthened or shortened by an operation (e.g. pinch-in or pinch-out operation) performed with the screen 105 functioning as the touch panel of the mobile communication terminal 3, a relations between the moved distance of the mobile communication terminal 3 and the moved distance of the displayed map is defined by a lengthened amount or a shorten amount of the move distance bar 111. Data relating to the adjusted relationship between the moved distance of the mobile communication terminal 3 and the moved distance of the displayed map is stored in a memory. Moreover, the data is used to a deriving process for a region that is clipped as the displayed map.

In this embodiment, the moved distance of the mobile communication terminal 3 is fixed and the moved distance of the displayed map is adjusted. However, the moved distance of the displayed map may be fixed and the moved distance of the mobile communication terminal 3 may be adjusted.

As for this function, the user can select whether or not to change the moved distance of the displayed map to the moved distance of the mobile communication terminal 3 based on an enlarged or reduced scale. For example, the map is set to be moved by 1 cm on the map, equivalent to 1 km, to a 1 cm moved distance of the mobile communication terminal 3. In a case where a scale of the map is doubled (close-up map), the user can select one of a 2 cm moved distance, equivalent to 1 km, and a 1 cm moved distance, equivalent to 0.5 km, of the displayed map to a 1 cm moved distance of the mobile communication terminal 3.

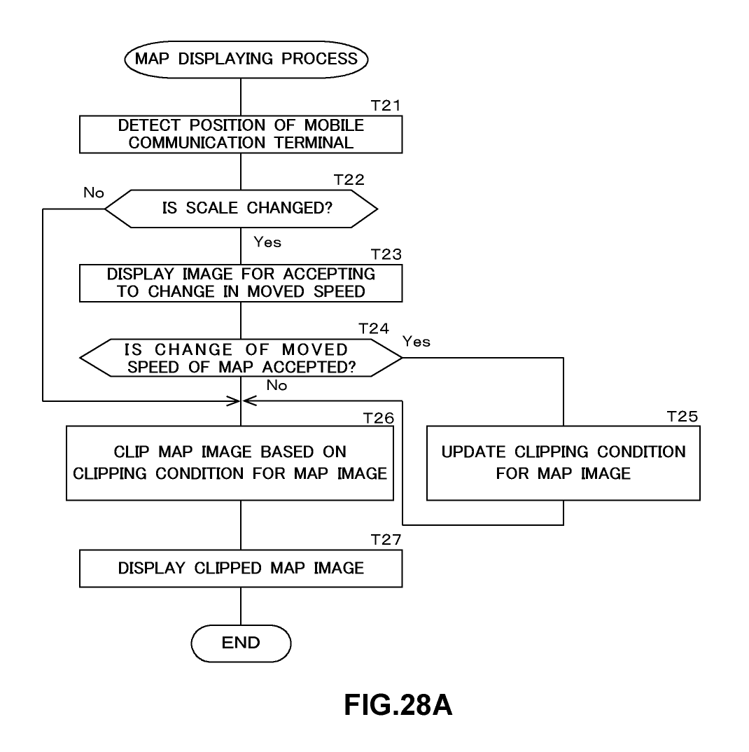

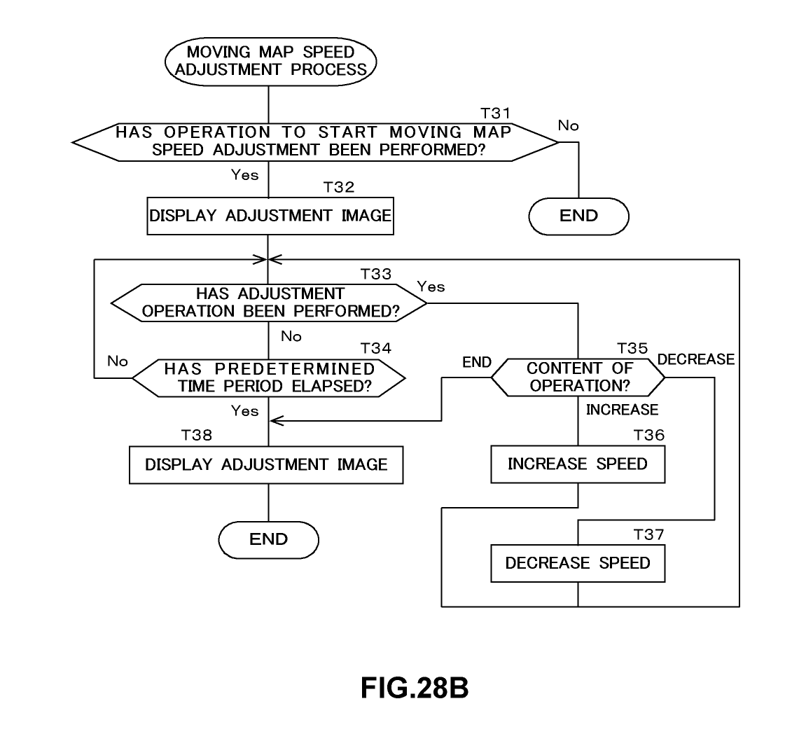

FIG. 28A illustrates a flow of a map displaying process that is performed by the mobile communication terminal 3. The process is performed repeatedly during the linked operation between the vehicle-mounted apparatus 2 and the mobile communication terminal 3.

The mobile communication microcomputer detects the position of the mobile communication terminal 3 in a step T21 and moves to a step T22. In the step T22, the mobile communication microcomputer determines whether or not the scale of the displayed map displayed on the mobile communication terminal 3 is changed. In a case where the scale is changed, the mobile communication microcomputer moves to a step T23. In a case where the scale is not changed, the mobile communication microcomputer moves to a step T26. In the step T23, the mobile communication microcomputer causes an image to be displayed for the user to select whether or not to accept that a moved speed of the displayed map to a move of the mobile communication terminal 3 is changed based on the scale, and moves to a step T24. In the step T24, the mobile communication microcomputer determines whether or not the change of the moved speed of the displayed map to the move of the mobile communication terminal 3 based on the scale is accepted by the user. In a case where the mobile communication microcomputer determines that the change is accepted, the mobile communication microcomputer moves to a step T25. In a case where the mobile communication microcomputer determines that the change is not accepted, the mobile communication microcomputer moves to the step T26.

In the step T25, the mobile communication microcomputer updates a control value stored in the memory for determining a region to be clipped, such that a clipping condition (region determining condition) for the map image is changed based on the changed scale, and moves to the step T26. In the step T26, the mobile communication microcomputer clips the map image based on the clipping condition including the control value stored in the memory for determining a region to be clipped, and moves to a step T27. In the step T27, the mobile communication microcomputer causes the clipped map image clipped in the step T27 to be displayed on the mobile communication terminal 3 and ends the process.

FIG. 28B illustrates a flow of a moving map speed adjustment process that is performed by the mobile communication terminal 3. The process is performed repeatedly during the linked operation between the vehicle-mounted apparatus 2 and the mobile communication terminal 3.

In a step T31, the mobile communication microcomputer determines whether or not an operation to start an adjustment of the speed of moving the displayed map (operation with a switch for a start of the adjustment of the speed of moving the displayed map) (hereinafter referred to as “moving map speed adjustment”) has been performed. In a case where the mobile communication microcomputer determines that the operation has been performed, the mobile communication microcomputer moves to a step T32. In a case where the mobile communication microcomputer determines that the operation has not been performed, the mobile communication microcomputer ends the process. In the step T32, the mobile communication microcomputer causes an image for the moving map speed adjustment to be displayed, and moves to a step T33. In the step T33, the mobile communication microcomputer determines whether or not an operation for the moving map speed adjustment has been performed. In a case where the mobile communication microcomputer determines that the operation has been performed, the mobile communication microcomputer moves to a step T35. In a case where the mobile communication microcomputer determines that the operation has not been performed, the mobile communication microcomputer moves to a step T34. In the step T34, the mobile communication microcomputer determines whether or not a predetermined time period has elapsed since the operation has not been performed last. In a case where the mobile communication microcomputer determines that the predetermined time period has elapsed, the mobile communication microcomputer moves to a step T38. In a case where the mobile communication microcomputer determines that the predetermined time period has not past, the mobile communication microcomputer moves back to the step T33.

In the step T35, the mobile communication microcomputer checks a content of the operation. In a case where the checked content represents an operation to end the adjustment (e.g. operation with an end switch or with a switch for a different function), the mobile communication microcomputer moves to the step T38. In a case where the checked content represents an operation to increase a speed of moving the displayed map, the mobile communication microcomputer moves to a step T36. In a case where the checked content represents an operation to decrease the peed of moving the displayed map, the mobile communication microcomputer moves to a step T37. In the step T36, the mobile communication microcomputer increases a speed coefficient for moving the displayed map that is used for a map clipping process (clipped region determination process) and moves back to the step T32. In the step T37, the mobile communication microcomputer decreases the speed coefficient for moving the displayed map that is used for the map clipping process (the clipped region determination process) and moves back to the step T32. The move distance bar 111 on the image for the moving map speed adjustment is changed based on the increase or the decrease in the speed coefficient for moving the displayed map (the step T32). In the step T38, the mobile communication microcomputer causes the image for the moving map speed adjustment to be displayed and ends the process.

<Function of Fixing Screen of Mobile Communication Terminal>

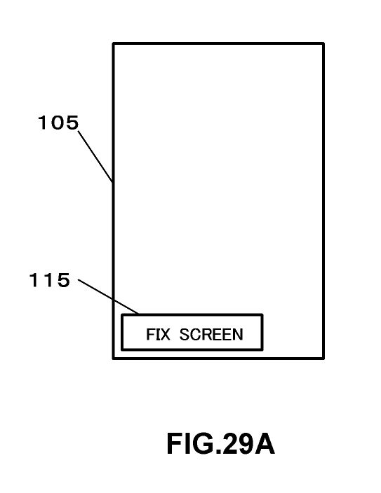

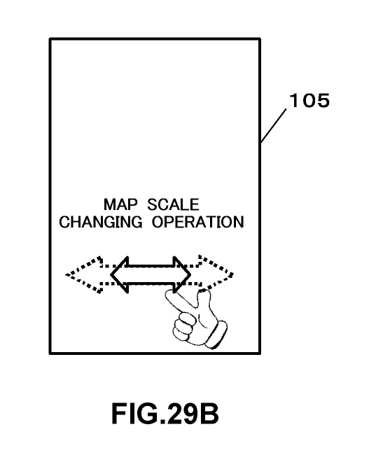

Each of FIG. 29A and FIG. 29B illustrates an outline of a function of fixing the screen of the mobile communication terminal 3.

When the displayed map is displayed on the screen 105 of the mobile communication terminal 3 based on the position of the mobile communication terminal 3 on the wide-area map, a screen fixing switch 115 for fixing the screen 105 is displayed, as shown in FIG. 29A. While the user is operating the screen fixing switch 115, even if the mobile communication terminal 3 is moved, the displayed map displayed on the mobile communication terminal 3 is fixed and is not changed. Once the operation with the screen fixing switch 115 is cancelled, the displayed map is moved based on the move of the mobile communication terminal 3 after the operation.

Once the operation with the screen fixing switch 115 is cancelled, the displayed map may be moved from the displayed map moved corresponding to the move of the mobile communication terminal 3 moved during the operation with the screen fixing switch 115. In this case, the move of the displayed map after the cancel of the operation with the screen fixing switch 115 may be determined based on a mode set by the user beforehand. Moreover, the displayed map may be switched between move and suspension of move for each operation with the screen fixing switch 115.

In addition to the operation with the screen fixing switch 115, as shown in FIG. 29B, a method of suspending the move of the displayed map during an operation of changing the scale of the displayed map on the mobile communication terminal 3 (prevention of lower visibility of the displayed map due to the move of the displayed map during the operation of changing the scale of the map) is also effective. A method of suspending the move of the displayed map in a case where the displayed screen 105 of the mobile communication terminal 3 is in a horizontal state (prevention of lower visibility of the displayed map when a different user checks a content of the displayed map or the like) is also effective. In a case where the suspension of the move of the displayed map is cancelled when the mobile communication terminal 3 moves more than a predetermined distance, having the screen 105 thereof in the horizontal state, it is convenient for the different user to see a wide-area map.

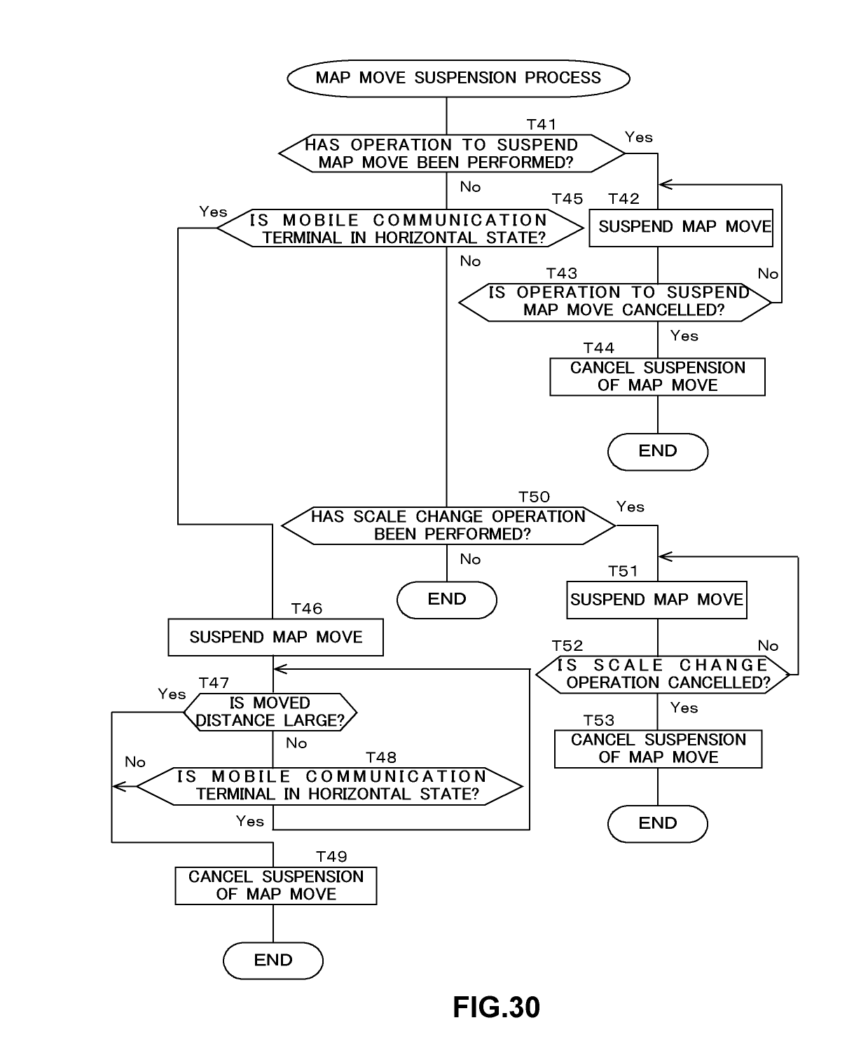

FIG. 30 illustrates a flow of a map move suspension process that is performed by the mobile communication terminal 3. The process is performed repeatedly during the linked operation between the vehicle-mounted apparatus 2 and the mobile communication terminal 3.

In a step T41, the mobile communication microcomputer determines whether or not an operation to suspend the move of the displayed map (operation with a switch for suspension of the move of the displayed map) has been performed. In a case where the mobile communication microcomputer determines that the operation to suspend the move of the displayed map has been performed, the mobile communication microcomputer moves to a step T42. In a case where the mobile communication microcomputer determines that the operation to suspend the move of the displayed map has not been performed, the mobile communication microcomputer moves to a step T44. In the step T42, the mobile communication microcomputer performs the operation to suspend the move of the displayed map that is caused by the move of the mobile communication terminal 3, and then moves to a step T43. In the step T43, the mobile communication microcomputer determines whether or not the operation to suspend the move of the displayed map is cancelled. In a case where the mobile communication microcomputer determines that the operation to suspend the move of the displayed map is cancelled, the mobile communication microcomputer moves to the step T44. In a case where the mobile communication microcomputer determines that the operation to suspend the move of the displayed map is not cancelled, the mobile communication microcomputer repeats the step T43. In the step T44, the mobile communication microcomputer cancels the operation to suspend the move of the displayed map that is caused by the move of the mobile communication terminal 3, and ends the process.

In a step T45, the mobile communication microcomputer determines whether or not the screen 105 of the mobile communication terminal 3 is in the horizontal state. In a case where the mobile communication microcomputer determines that the screen 105 of the mobile communication terminal 3 is in the horizontal state, the mobile communication microcomputer moves to a step T46. In a case where the mobile communication microcomputer determines that the screen 105 of the mobile communication terminal 3 is not in the horizontal state, the mobile communication microcomputer moves to a step T50. The mobile communication microcomputer determines whether or not the mobile communication terminal 3 is in the horizontal state, based on an output representing a direction of gravity acceleration detected by an acceleration sensor provided to the mobile communication terminal 3. In the step T46, the mobile communication microcomputer performs the operation to suspend the move of the displayed map that is caused by the move of the mobile communication terminal 3 and moves to a step T47. In the step T47, the mobile communication microcomputer determines whether or not the moved distance of the mobile communication terminal 3 is equal to a predetermined distance or more (in the horizontal state). In a case where the mobile communication microcomputer determines that the moved distance of the mobile communication terminal 3 is equal to the predetermined distance or more, the mobile communication microcomputer moves to a step T49. In a case where the mobile communication microcomputer determines that the moved distance of the mobile communication terminal 3 is less than the predetermined distance, the mobile communication microcomputer moves to a step T48. In the step T48, the mobile communication microcomputer determines whether or not the screen 105 of the mobile communication terminal 3 is in the horizontal state. In a case where the mobile communication microcomputer determines that the screen 105 is in the horizontal state, the mobile communication microcomputer moves to the step T47. In a case where the mobile communication microcomputer determines that the screen 105 is not in the horizontal state, the mobile communication microcomputer moves to the step T49. In the step T49, the mobile communication microcomputer cancels the operation to suspend the move of the displayed map that is caused by the move of the mobile communication terminal 3, and ends the process.

In the step T50, the mobile communication microcomputer determines whether or not a scale change operation for the displayed map on the mobile communication terminal 3 (operation with a switch to change the scale) has been performed. In a case where the mobile communication microcomputer determines that the scale change operation has been performed, the mobile communication microcomputer moves to a step T51. In a case where the mobile communication microcomputer determines that the scale change operation has not been performed, the mobile communication microcomputer ends the process. In the step T51, the mobile communication microcomputer performs the operation to suspend the move of the displayed map that is caused by the move of the mobile communication terminal 3 and moves to a step T52. In the step T52, the mobile communication microcomputer determines whether or not the scale change operation is cancelled. In a case where the mobile communication microcomputer determines that the scale change operation is cancelled, the mobile communication microcomputer moves to a step T53. In a case where the mobile communication microcomputer determines that the scale change operation is not cancelled, the mobile communication microcomputer repeats the step T52. In the step T53, the mobile communication microcomputer cancels the operation to suspend the move of the displayed map that is caused by the move of the mobile communication terminal 3 and ends the process.

<Function of Linking Scales Used by Vehicle-Mounted Apparatus and by Mobile Communication Terminal>

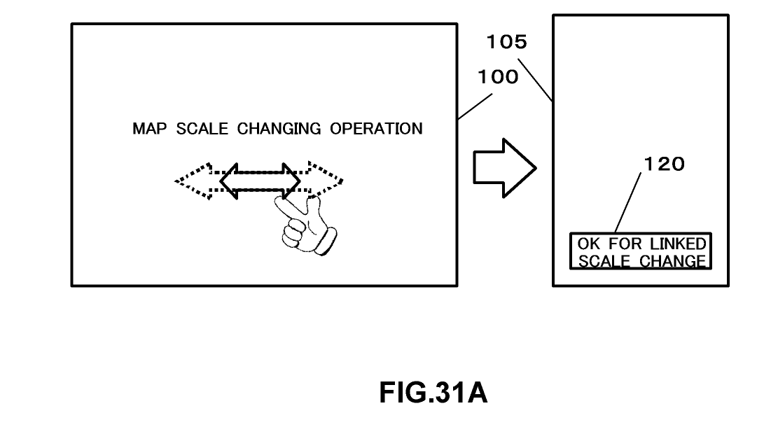

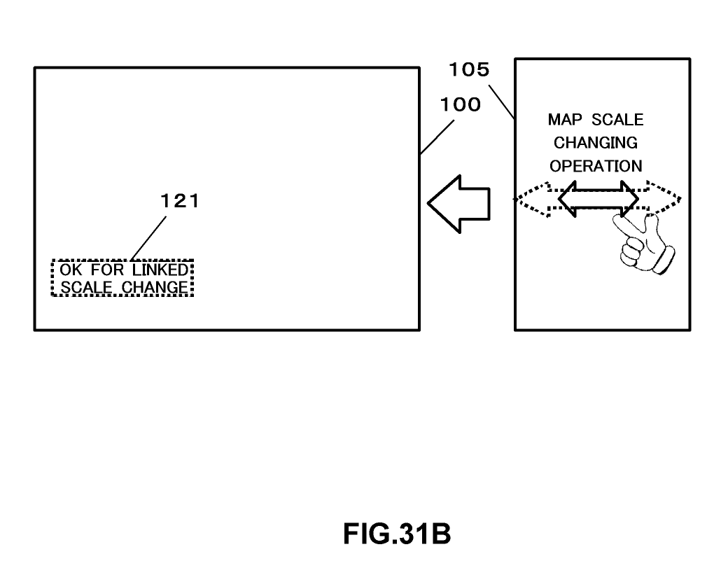

Each of FIG. 31A and FIG. 31B illustrates an outline of a function of linking the scales used by the vehicle-mounted apparatus 2 and by the mobile communication terminal 3.

In a case where the user performs a scale change operation for the displayed map with the vehicle-mounted apparatus 2, as shown in FIG. 31A, in a state where the map is displayed on the screen 105 of the mobile communication terminal 3 based on the position of the mobile communication terminal 3 on the wide-area map, a linked scale change selection switch 120 is displayed on the screen 105 of the mobile communication terminal 3 for the user to determine whether or not to link the scale of the displayed map on the mobile communication terminal 3 to the scale of the displayed map on the vehicle-mounted apparatus 2 (to use a same scale for those displayed maps). In a case where the user performs an operation to accept the change to link the scales, the scale of the displayed map on the mobile communication terminal 3 is changed to use the same scale used for the displayed map on the vehicle-mounted apparatus 2.

In a case where the user performs the scale change operation for the displayed map with the mobile communication terminal 3, as shown in FIG. 31B, in a state where the map is displayed on the screen 105 of the mobile communication terminal 3 based on the position of the mobile communication terminal 3 on the wide-area map, a linked scale change selection switch 121 is displayed on the screen 100 of the vehicle-mounted apparatus 2 for the user to determine whether or not to link the scale of the displayed map on the vehicle-mounted apparatus 2 to the scale of the displayed map on the mobile communication terminal 3 (to use a same scale for those displayed maps). In a case where the user performs an operation to accept the change to link the scales, the scale of the displayed map on the vehicle-mounted apparatus 2 is changed to use the same scale used for the displayed map on the mobile communication terminal 3.

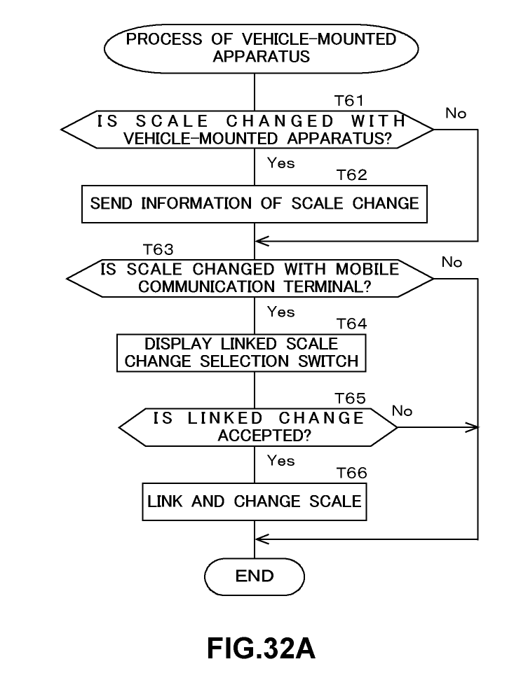

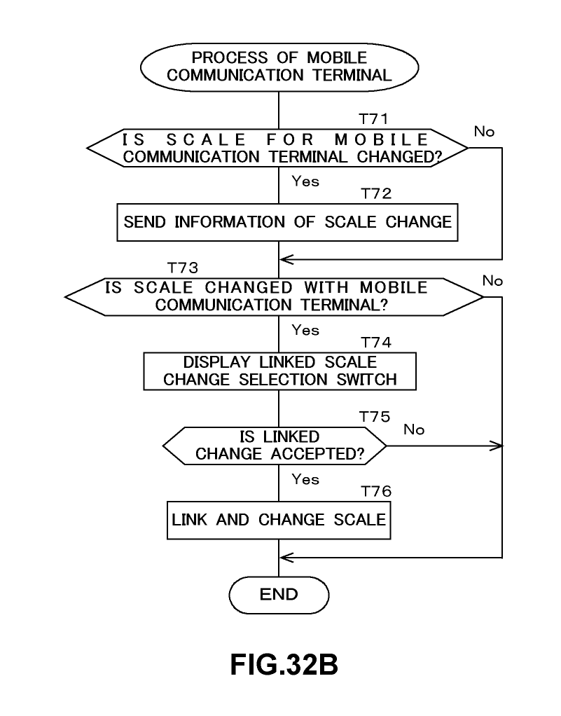

FIG. 32A illustrates a flow of a process that is performed by the vehicle-mounted apparatus 2. The process is performed repeatedly during the linked operation between the vehicle-mounted apparatus 2 and the mobile communication terminal 3.

In a step T61, the vehicle-mounted microcomputer determines whether or not the scale change operation (operation with a switch to change the scale) has been performed with the vehicle-mounted apparatus 2 for the displayed map on the vehicle-mounted apparatus 2. In a case where the vehicle-mounted microcomputer determines that the scale change operation has been performed, the vehicle-mounted microcomputer moves to a step T63. In a case where the vehicle-mounted microcomputer determines that the scale change operation has not been performed, the vehicle-mounted microcomputer moves to a step T62. In the step T62, the vehicle-mounted microcomputer sends, to the mobile communication terminal 3, data representing a content of the scale changed on the vehicle-mounted apparatus 2, and then moves to the step T63.

In the step T63, the vehicle-mounted microcomputer determines, based on the data representing the content of the changed scale sent from the mobile communication terminal 3, whether or not the scale change operation has been performed with the mobile communication terminal 3. In a case where the vehicle-mounted microcomputer determines that the scale change operation has been performed, the vehicle-mounted microcomputer moves to a step T64. In a case where the vehicle-mounted microcomputer determines that the scale change operation has not been performed, the vehicle-mounted microcomputer ends the process. In the step T64, the vehicle-mounted microcomputer causes the screen 100 of the vehicle-mounted apparatus 2 to display the linked scale change selection switch 121 for determination of whether or not to accept a linked change of the scale, and moves to the step T65. In the step T65, the vehicle-mounted microcomputer determines, based on an operation with the linked scale change selection 121, whether or not the linked change of the scale is accepted by the user. In a case where the vehicle-mounted microcomputer determines that the linked change of the scale is accepted, the vehicle-mounted microcomputer moves to a step T66. In a case where the vehicle-mounted microcomputer determines that the linked change of the scale is not accepted, the vehicle-mounted microcomputer ends the process. In the step T66, the vehicle-mounted microcomputer changes the scale of the displayed map on the vehicle-mounted apparatus 2 based on the scale of the displayed map on the mobile communication terminal 3, and ends the process.

FIG. 32B illustrates a flow of a process that is performed by the mobile communication terminal 3. The process is performed repeatedly during the linked operation between the vehicle-mounted apparatus 2 and the mobile communication terminal 3.

In a step T71, the mobile communication microcomputer determines whether or not the scale change operation (operation with a switch to change the scale) has been performed with the mobile communication terminal 3 for the displayed map on the mobile communication terminal 3. In a case where the mobile communication microcomputer determines that the scale change operation has been performed, the mobile communication microcomputer moves to a step T73. In a case where the mobile communication microcomputer determines that the scale change operation has not been performed, the mobile communication microcomputer moves to a step T72. In the step T72, the mobile communication microcomputer sends, to the vehicle-mounted apparatus 2, data representing a content of the scale changed on the mobile communication terminal 3, and then moves to the step T73.

In the step T73, the mobile communication microcomputer determines, based on the data representing the content of the changed scale sent from the vehicle-mounted apparatus 2, whether or not the scale change operation has been performed with the vehicle-mounted apparatus 2. In a case where the mobile communication microcomputer determines that the scale change operation has been performed, the mobile communication microcomputer moves to a step T74. In a case where the mobile communication microcomputer determines that the scale change operation has not been performed, the mobile communication microcomputer ends the process. In the step T74, the mobile communication microcomputer causes the screen 105 of the mobile communication terminal 3 to display the linked scale change selection switch 120 for determination of whether or not to accept a linked change of the scale, and moves to the step T75. In the step T75, the mobile communication microcomputer determines, based on an operation with the linked scale change selection switch 120, whether or not the linked change of the scale is accepted by the user. In a case where the mobile communication microcomputer determines that the linked change of the scale is accepted, the mobile communication microcomputer moves to a step T76. In a case where the mobile communication microcomputer determines that the linked change of the scale is not accepted, the mobile communication microcomputer ends the process. In the step T76, the mobile communication microcomputer changes the scale of the displayed map on the mobile communication terminal 3 based on the scale of the displayed map on the vehicle-mounted apparatus 2, and ends the process.

<Function of Displaying Screen According to Inclination of Mobile Communication Terminal>

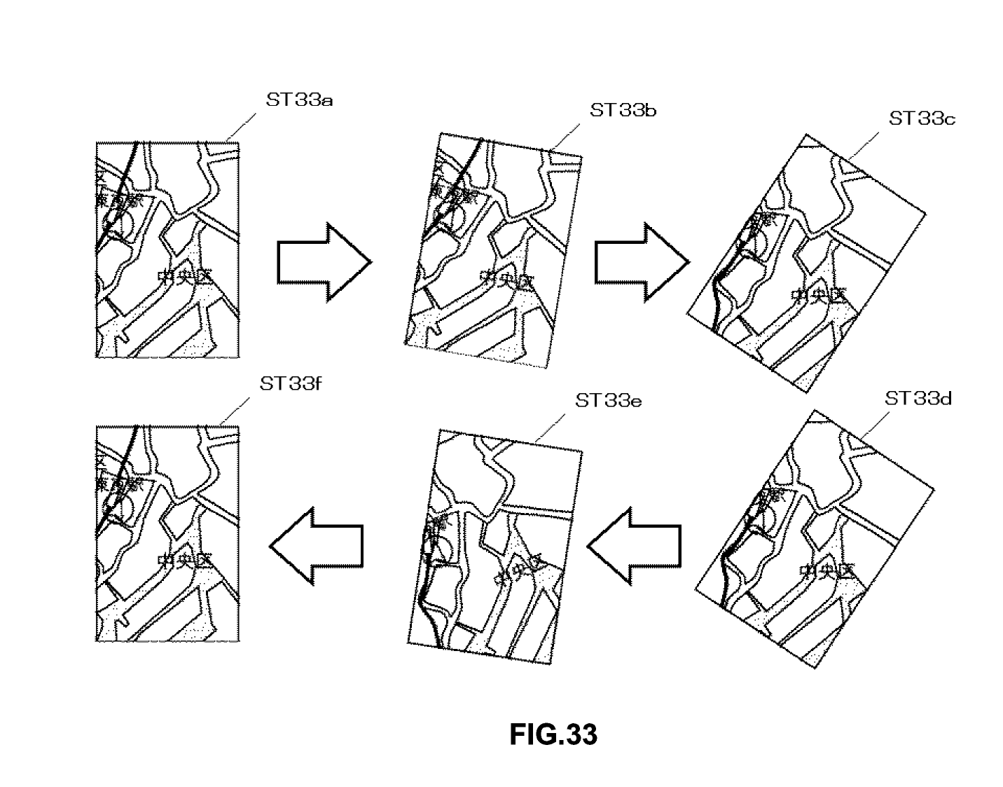

FIG. 33 illustrates an outline of a function of displaying a screen according to an inclination of the mobile communication terminal.

In a case where the mobile communication terminal 3 is inclined in a state where a map corresponding to the position of the mobile communication terminal 3 on the wide-area map is displayed on the screen 105 of the mobile communication terminal 3, the displayed map is rotated according to an inclined angle of a surface of the screen 105 and then the displayed map is displayed in a same direction in which a displayed map is displayed on the vehicle-mounted apparatus 2. FIG. 33 illustrates an example of a series of shifts in the displayed map on the screen 105 of the mobile communication terminal 3 in a case where an inclined angle of the screen 105 is continuously changed. A state ST33a shows the displayed map displayed when the inclined angle of the screen 105 is 0 degree. A state ST33b shows the displayed map displayed when the inclined angle of the screen 105 is 5 degrees. A state ST33c shows the displayed map displayed when the inclined angle of the screen 105 is 10 degrees. A state ST33d shows the displayed map displayed when the inclined angle of the screen 105 is 10 degrees. A state ST33e shows the displayed map displayed when the inclined angle of the screen 105 is 5 degrees. A state ST33f shows the displayed map displayed when the inclined angle of the screen 105 is 0 degree. The mobile communication terminal 3 in the state ST33d is inclined in a reversed direction as compared to the mobile communication terminal 3 in the state ST33c. The illustrated inclined angles are emphasized as compared to actual angles for convenience of explanation.

In a case where the mobile communication terminal 3 is rotated (inclined) alone the surface of the screen 105, the displayed map is rotated along with the rotation of the mobile communication terminal 3. When the inclined angle of the screen 105 is 5 degrees, the displayed map is similarly rotated along with the rotation of the mobile communication terminal 3 (FIG. 33 (the state ST33b)). When the mobile communication terminal 3 is continuously rotated and reaches 10 degrees, the displayed map is rotated in an opposite direction by a rotated angle (10 degrees) of the mobile communication terminal 3 to be displayed in a same direction (FIG. 33 (the state ST33c)) in which the displayed map on the vehicle-mounted apparatus 2 is displayed. In other words, by setting a play of a 10-degree inclined angle, the displayed map is prevented from being rotated by small changes of the inclined angle of the mobile communication terminal 3 so that the displayed map can be seen comfortably.

In a case where the mobile communication terminal 3 is rotated (inclined) in an original direction alone the surface of the screen 105, the displayed map rotates along with the rotation of the mobile communication terminal 3. When the inclined angle of the screen 105 is 5 degrees, the displayed map is similarly rotated along with the rotation of the mobile communication terminal 3 (FIG. 33 (the state ST33e)). When the mobile communication terminal 3 is continuously rotated and reaches 0 degree, the displayed map is rotated in an opposite direction by a rotated angle (−10 degrees) of the mobile communication terminal 3 to be displayed in a same direction (FIG. 33 (the state ST33f)) in which the displayed map on the vehicle-mounted apparatus 2 is displayed. In other words, by setting a play of a 10-degree inclined angle, the displayed map is prevented from being rotated by small changes of the inclined angle of the mobile communication terminal 3 so that the displayed map can be seen comfortably. By setting hysteresis to a timing of changing the angle of the displayed map in a clockwise direction and in a counterclockwise direction, sways caused around a timing of changing an angle (inclined angle) of the displayed map (frequent changes of the inclined angle of the displayed map based on frequent changes of the inclined angle of the mobile communication terminal 3 near a boundary angle) can be prevented so that the displayed map can be seen comfortably.

In this embodiment, only in a case where a mode that accepts the change of the angle of the displayed map according to the angle of the mobile communication terminal 3 is selected by the user, the angle of the displayed map is changed according to the angle of the mobile communication terminal 3. While the mobile communication terminal 3 is being moved, the change of the angle of the displayed map according to the angle of the mobile communication terminal 3 is suspended. After a predetermined time period from the move of the mobile communication terminal 3, the displayed map is rotated according to a sum of changed angle of the mobile communication terminal 3 caused during the move, for easy to see the displayed map moved by the move of the mobile communication terminal 3.

In a case of a front-up display mode (display mode where a traveling direction of a vehicle is positioned on a top of the map), a displayed direction of the displayed map on the vehicle-mounted apparatus 2 is changed along with travel of the vehicle. The displayed map on the mobile communication terminal 3 is rotated to match the displayed map on the vehicle-mounted apparatus 2. In this embodiment, like the case where the inclined angle of the mobile communication terminal 3 is changed, a 10-degree play is set to the inclined (rotated) angle of the displayed map, and hysteresis is given to the inclined angle each in the clockwise direction and the counterclockwise direction.

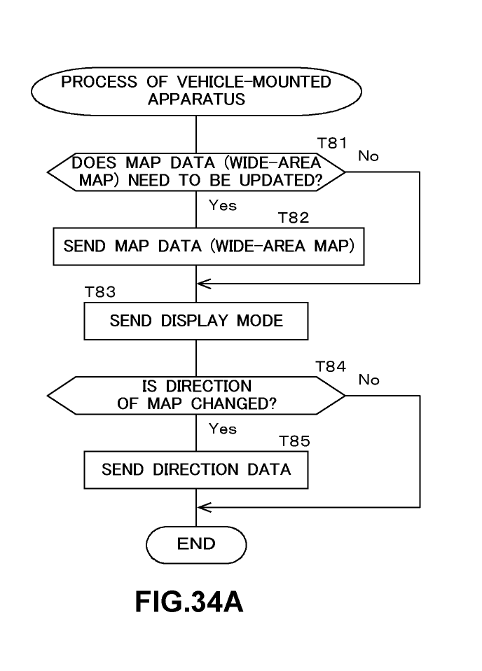

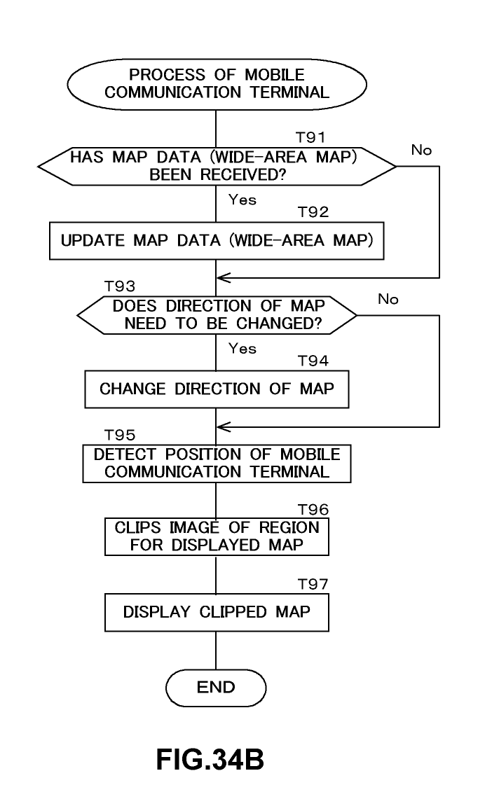

FIG. 34A illustrates a flow of a process of a function of displaying the displayed map on the vehicle-mounted apparatus 2 according to the inclined angle of the mobile communication terminal 3. The process is performed repeatedly during the linked operation between the vehicle-mounted apparatus 2 and the mobile communication terminal 3.

In a step T81, the vehicle-mounted microcomputer determines, based on the travel of the vehicle and other situations, whether or not the map data (the wide-area map) needs to be updated (in a case of increase in necessity to update the map data showing a vicinity of the vehicle due to a large distance of travel of the vehicle from a last update of the map data). In a case where the vehicle-mounted microcomputer determines that the update is necessary, the vehicle-mounted microcomputer moves to a step T82. In a case where the vehicle-mounted microcomputer determines that the update is not necessary, the vehicle-mounted microcomputer moves to a step T83. In the step T83, the vehicle-mounted microcomputer sends data of an appropriate range of the wide-area map to the mobile communication terminal 3 and ends the process. In the step T83, the vehicle-mounted microcomputer also updates data of the wide-area map (store the data stored in a magnetic recording medium, etc. into a buffer memory, etc. for high-speed processing) that is used for the map displaying process by the vehicle-mounted apparatus 2.

In the step T83, the vehicle-mounted microcomputer sends the display (direction) mode of the displayed map (front-up mode, north-up mode (in which north is positioned on the top of the map)) to the mobile communication terminal 3 and moves to a step T84. In the step T84, the vehicle-mounted microcomputer determines whether or not the angle of the displayed map is changed by a predetermined angle (10 degrees) or more from a reference value (from direction data of the displayed map sent last (in a step T85)). In a case where the vehicle-mounted microcomputer determines that the angle of the displayed map is changed by the predetermined angle or more, the vehicle-mounted microcomputer moves to the step T85. In a case where the vehicle-mounted microcomputer determines that the angle of the displayed map is not changed by the predetermined angle or more, the vehicle-mounted microcomputer ends the process. In the step T85, the vehicle-mounted microcomputer sends the direction data of the displayed map to the mobile communication terminal 3 and ends the process.

FIG. 34B illustrates a flow of a process of a function of displaying the displayed map on the mobile communication terminal 3 according to the inclined angle of the mobile communication terminal 3. The process is performed repeatedly during the linked operation between the vehicle-mounted apparatus 2 and the mobile communication terminal 3.

In a step T91, the mobile communication microcomputer determines whether or not the mobile communication terminal 3 has received freshly updated data of the wide-area map sent from the vehicle-mounted apparatus 2. In a case where the mobile communication microcomputer determines that the mobile communication terminal 3 has received the data, the mobile communication microcomputer moves to a step T92. In a case where the mobile communication microcomputer determines that the mobile communication terminal 3 has not received the data, the mobile communication microcomputer moves to a step T93. In the step T92, the mobile communication microcomputer updates data of the displayed map based on the received updated data of the wide-area map (store the data in a memory for map processing) and causes the displayed map based on the updated data to be displayed and moves to the step T93.

In the step T93, the mobile communication microcomputer determines whether or not the direction of the displayed map on the mobile communication terminal 3 needs to be changed. In a case where the mobile communication microcomputer determines that the direction needs to be changed, the mobile communication microcomputer moves to a step T94. In case where the mobile communication microcomputer determines that the direction does not need to be changed, the mobile communication microcomputer moves to a step T95. If one of conditions below is satisfied, the mobile communication microcomputer determines that the direction needs to be changed.

Condition 1: The user has set the mobile communication terminal 3 such that in a case where the inclined angle of the mobile communication terminal 3 is changed, changing the direction of the displayed map on the mobile communication terminal 3 is accepted. In addition, the displayed map on the mobile communication terminal 3 needs to be rotated by the predetermine angle or more from the direction of the displayed map on the mobile communication terminal 3 changed last, and in a case where the direction of the displayed map on the mobile communication terminal 3 has been rotated both in the clockwise direction and in the counterclockwise direction, a hysteresis condition also needs to be satisfied. In addition, satisfaction of any condition of changing the direction of the displayed map is deemed ineffective (the mobile communication microcomputer deems that the displayed map does not need to be rotated) during move of the mobile communication terminal 3 or before the predetermined time period elapses after stop of the move of the mobile communication terminal 3.

Condition 2: The user has set the mobile communication terminal 3 such that in a case where the direction of the displayed map on the vehicle-mounted apparatus 2 (north-up mode for the vehicle-mounted apparatus 2) is changed, changing the direction of the displayed map on the mobile communication terminal 3 is accepted. In addition, the displayed map on the mobile communication terminal 3 needs to be rotated by the predetermine angle or more from the direction of the displayed map on the mobile communication terminal 3 changed last (the displayed map on the vehicle-mounted apparatus 2 is rotated by the predetermine angle or more from the direction of the displayed map on the mobile communication terminal 3 changed last), and in a case where the direction of the displayed map on the vehicle-mounted apparatus 2 has rotated both in the clockwise direction and in the counterclockwise direction, a hysteresis condition also needs to be satisfied. In addition, satisfaction of any condition of changing the direction of the displayed map is deemed ineffective (the mobile communication microcomputer deems that the displayed map does not need to be rotated) during move of the mobile communication terminal 3 or before the predetermined time period elapses after stop of the move of the mobile communication terminal 3.

In the step T94, the mobile communication microcomputer rotates the displayed map by an angle according to the conditions (rotates the wide-area map stored in the memory for the map processing) and moves to the step T95. In the step T95, the mobile communication microcomputer detects the position of the mobile communication terminal 3 and moves to a step T96. In the step T96, the mobile communication microcomputer clips a region corresponding to the position of the mobile communication terminal 3 from the wide-area map stored in the memory for the map processing, and moves to a step T97. In the step T97, the mobile communication microcomputer causes the clipped map as the displayed map to be displayed on the screen 105 of the mobile communication terminal 3 and ends the process.

[Function of Adjusting Size of Image on the Mobile Communication Terminal]

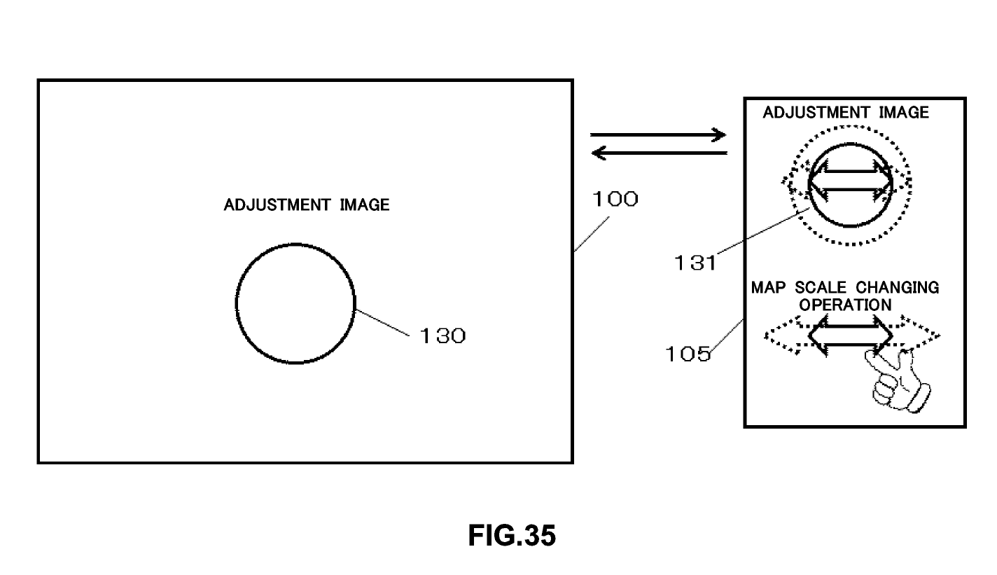

FIG. 35 illustrates an outline of a function of adjusting a size of an image on the mobile communication terminal 3.

Screen sizes of the vehicle-mounted apparatus 2 and the mobile communication terminal 3 vary depending on models thereof. Therefore, there is a need to adjust a size of the displayed map. As shown in FIG. 35, for adjustment of the size of the image on the mobile communication terminal 3, the function of adjusting the size of the image on the mobile communication terminal 3 (hereinafter referred to as “mobile communication terminal image size adjustment function) causes an adjustment image 130 and an adjustment image 131 to be displayed on the screen 100 of the vehicle-mounted apparatus 2 and on the screen 105 of the mobile communication terminal 3, respectively. Each of the adjustment image 130 and the adjustment image 131 is displayed on a scale and in a shape (circle in this example) used for the displayed map displayed on each of the screen 100 of the vehicle-mounted apparatus 2 and on the screen 105 of the mobile communication terminal 3. For example, if the displayed maps on the screen 100 of the vehicle-mounted apparatus 2 and on the screen 105 of the mobile communication terminal 3 are displayed on a same scale and in a same display size, the adjustment images 130 and 131 are an identical figure (circle) in shape and size.

Once the user performs a size adjustment operation with the screen 105 functioning as the touch panel, of the mobile communication terminal 3, the size of the adjustment image 131 displayed on the screen 105 of the mobile communication terminal 3 is reduced or increased along with the displayed map, and the size of the displayed map is adjusted. In a case where the scales used for the displayed maps on the vehicle-mounted apparatus 2 and the mobile communication terminal 3 are the same and where the size of the adjustment image 131 displayed on the screen 105 of the mobile communication terminal 3 is the same as the size of the adjustment image 130 displayed on the screen 100 of the vehicle-mounted apparatus 2, the displayed maps on the screen 105 of the mobile communication terminal 3 and on the screen 100 of the vehicle-mounted apparatus 2 are displayed on the same scale and in the same size. In this case, there is high continuity between the displayed maps.

In a case where the vehicle-mounted apparatus 2 and the mobile communication terminal 3 are freshly linked, if the vehicle-mounted apparatus 2 and the mobile communication terminal 3 have been linked before, an adjustment value used before is set as an initial setting value for a display size. If the vehicle-mounted apparatus 2 and the mobile communication terminal 3 have not been linked before, an adjustment value is set as the initial setting value for the display size, depending on a model. The adjustment value depending on the model is stored in a memory and the like of the vehicle-mounted apparatus 2 or the mobile communication terminal 3 for use, or data stored in a center or the like is used.

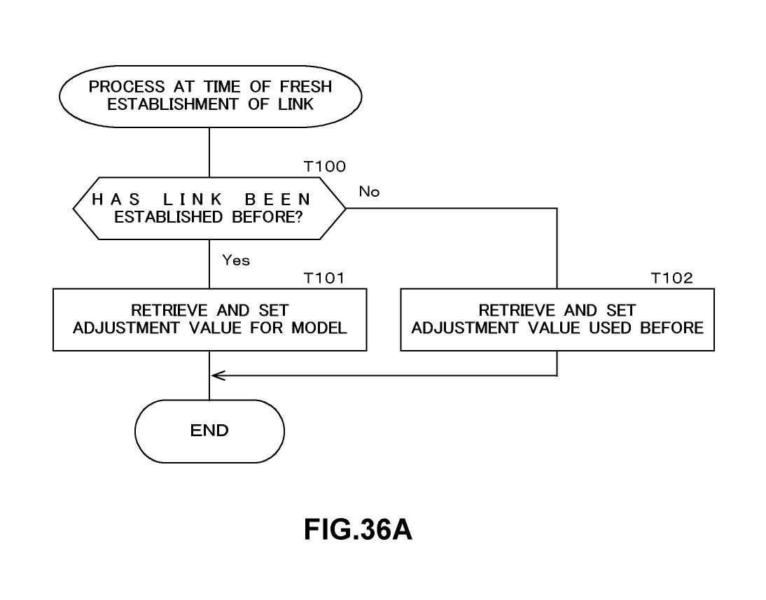

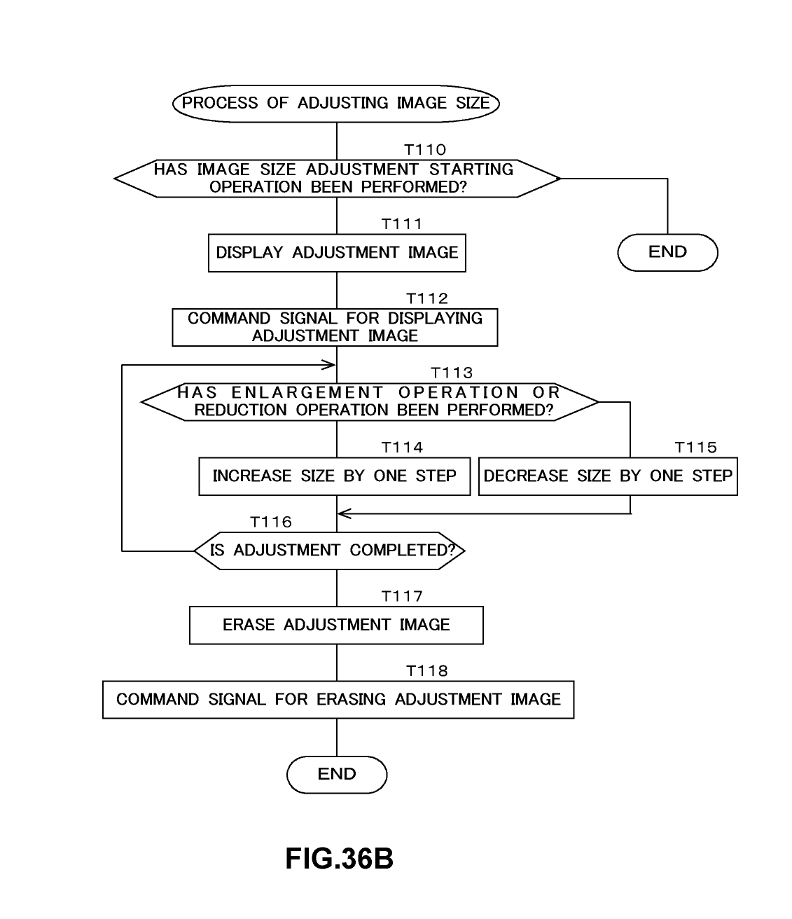

FIG. 36A illustrates a flow of a process of setting the initial value of the display size performed in the mobile communication terminal image size adjustment function at a time of fresh link. The process is performed whenever the mobile communication terminal 3 is freshly linked to the vehicle-mounted apparatus 2.

In a step T100, the mobile communication microcomputer determines whether or not the mobile communication terminal 3 and the vehicle-mounted apparatus 2 have been linked to each other before (link of this pair between the vehicle-mounted apparatus 2 and the mobile communication terminal 3). In a case where the mobile communication microcomputer determines that the mobile communication terminal 3 and the vehicle-mounted apparatus 2 have been linked before, the mobile communication microcomputer moves to a step T102. In a case where the mobile communication microcomputer determines that the mobile communication terminal 3 and the vehicle-mounted apparatus 2 have not been linked before, the mobile communication microcomputer moves to a step T101. In the step T101, the mobile communication microcomputer searches database based on the models of the vehicle-mounted apparatus 2 and the mobile communication terminal 3. Moreover, the mobile communication microcomputer searches the database for an appropriate adjustment value for linking the models. Moreover, the mobile communication microcomputer sets the appropriate adjustment value as the initial value of the display size for the mobile communication terminal 3 and ends the process. In the step T102, the mobile communication microcomputer retrieves from the memory the adjustment value used for linking the mobile communication terminal 3 and the vehicle-mounted apparatus 2 before, and sets the adjustment value as the initial value of the display size and then ends the process. The adjustment value for linking the mobile communication terminal 3 and vehicle-mounted apparatus 2 before is stored in association with identification information of the mobile communication terminal 3 and the vehicle-mounted apparatus 2.

FIG. 36B illustrates a flow of a process of adjusting an image size in the mobile communication terminal image size adjustment function. The process is performed repeatedly during the linked operation of the vehicle-mounted apparatus 2 and the mobile communication terminal 3.

In a step T110, the mobile communication microcomputer determines whether or not an adjustment starting operation of the image size has been performed. In a case where the mobile communication microcomputer determines that the adjustment starting operation has been performed, the mobile communication microcomputer moves to a step T111. In a case where the mobile communication microcomputer determines that the adjustment starting operation has not been performed, the mobile communication microcomputer ends the process. In the step T111, the mobile communication microcomputer causes the adjustment image (e.g. circle) to be displayed on the screen 105 of the mobile communication terminal 3, and moves to a step T112.

In the step T112, the mobile communication microcomputer sends to the vehicle-mounted apparatus 2 a command signal for displaying the adjustment image (in a same shape as the adjustment image on the mobile communication terminal 3) to be displayed on the vehicle-mounted apparatus 2 and moves to a step T113.

Thus, the adjustment image is displayed on the screen 100 of the vehicle-mounted apparatus 2.

In the step T113, the mobile communication microcomputer determines whether or not an enlargement operation or a reduction operation has been performed. In a case where the mobile communication microcomputer determines that the enlargement operation has been performed, the mobile communication microcomputer moves to a step T114. In a case where the mobile communication microcomputer determines that the reduction operation has been performed, the mobile communication microcomputer moves to a step T115. In the step T114, the mobile communication microcomputer increases the adjustment value of the display size by one step, and moves to a step T116. In the step T115, the mobile communication microcomputer decreases the adjustment value of the display size by one step, and moves to the step T116. In the step T116, the mobile communication microcomputer determines whether or not the adjustment is completed. In a case where the mobile communication microcomputer determines that the adjustment is completed, the mobile communication microcomputer moves to a step T117. In a case where the mobile communication microcomputer determines that the adjustment is not completed, the mobile communication microcomputer moves back to the step T113. The mobile communication terminal 3 determines whether or not the adjustment is completed, based on detection of an operation with an adjustment complete switch or the like. However, by using a timeout process, if neither the enlargement operation nor the reduction operation is performed for a predetermined time period or more, the mobile communication microcomputer may determine that the adjustment is completed.

In the step T117, the mobile communication microcomputer erases the adjustment image from the screen 105 of the mobile communication terminal 3 and moves to a step T118. In the step T118, the mobile communication microcomputer sends to the vehicle-mounted apparatus 2 a command signal for erasing the adjustment image, and ends the process. Accordingly, the adjustment image is erased from the screen 100 of the vehicle-mounted apparatus 2.

[Function of Return Operation]

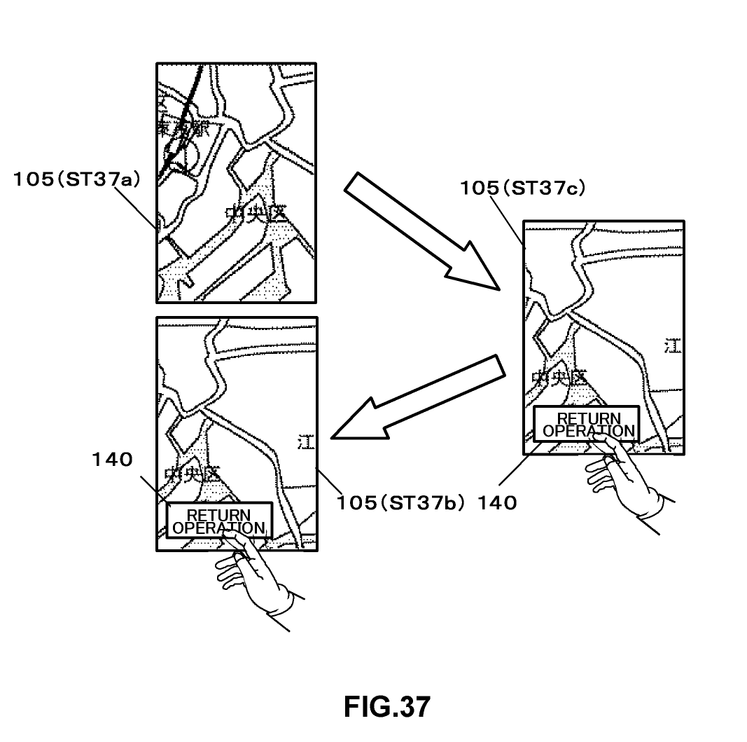

FIG. 37 illustrates an outline of a function of a return operation. In a case of the wide-area map is very wide, even if the mobile communication terminal 3 is moved as far as the user can reach, there is a case where an end portion of the wide-area map is not displayed. In that case, the user needs to move back the mobile communication terminal 3 and to move the mobile communication terminal 3 again from a reached point as a reference. The return operation shown in FIG. 37 solves the problem. When the mobile communication terminal 3 is moved from a position ST37a to a position ST37b, the displayed map on the mobile communication terminal 3 is moved along with the move of the mobile communication terminal 3. During the move (until a predetermined time period elapses after an end of the move), a return operation switch 140 is displayed on the screen 105 of the mobile communication terminal 3. While the return operation switch 140 is being operated, the displayed map is not moved (the position data of the mobile communication terminal 3 is fixed) and even if the mobile communication terminal 3 is moved to a position ST37c, the displayed map is not moved. Then, once the operation with the return operation switch 140 is cancelled, the displayed map is ready to move again (the position data of the mobile communication terminal 3 changes based on the move of the mobile communication terminal 3).

In addition to the return operation switch 140, the return operation may be started by moving the screen 105 of the mobile communication terminal 3 vertically forward and the return operation may be cancelled by moving the screen 105 of the mobile communication terminal 3 vertically backwards. This operation method is similar to a mouse operation at a time of using a personal computer. Therefore, the user can instinctively accept (easily understand) the operation.

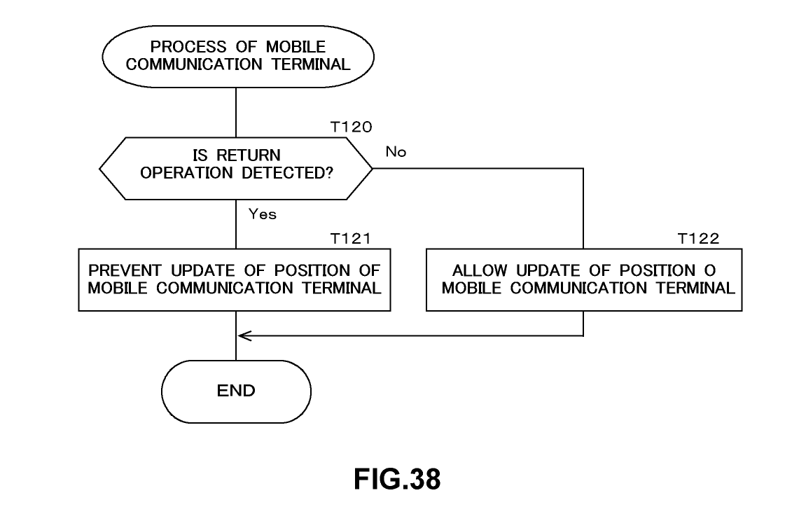

FIG. 38 illustrates a flow of a process that implements the function of the return operation. The process is performed repeatedly during the linked operation between the vehicle-mounted apparatus 2 and the mobile communication terminal 3.

In a step T120, the mobile communication microcomputer determines whether or not the return operation is being performed. In a case where the mobile communication microcomputer determines that the return operation is being performed, the mobile communication microcomputer moves to a step T121. In a case where the mobile communication microcomputer determines that the return operation is not being performed, the mobile communication microcomputer moves to a step T122. In the step T121, the mobile communication microcomputer prevents update of the position data of the mobile communication terminal 3 (control data for the display image) that is caused by the move of the mobile communication terminal 3, and ends the process. Accordingly, even if the mobile communication terminal 3 is moved, the position data of the mobile communication terminal 3 is not updated after the step T121. Therefore, even if the mobile communication terminal 3 is moved, the displayed map displayed on the screen 105 of the mobile communication terminal 3 is not changed. In the step T122, the mobile communication microcomputer allows update of the position data (control data for display image) of the mobile communication terminal 3 that is caused by the move of the mobile communication terminal 3, and ends the process. Accordingly, the position data of the mobile communication terminal 3 is updated after this step, based on the move of the mobile communication terminal 3. Therefore, the displayed map to be displayed on the screen 105 of the mobile communication terminal 3 is moved based on the move of the mobile communication terminal 3.

[Function Performed when Mobile Communication Terminal and Vehicle-Mounted Apparatus Come into Contact]

There is a case where the mobile communication terminal 3 and the vehicle-mounted apparatus 2 come into contact with each other although the case is a rare situation. In this case, the displayed map on the mobile communication terminal 3 is a map showing a neighboring region that continues from the displayed map on the vehicle-mounted apparatus 2 (end portions of the displayed maps on both of the vehicle-mounted apparatus 2 and the mobile communication terminal 3 show a same region of the wide-area map (the region of the displayed maps may be slightly overlapped with each other)) on a same scale and in a same size (size adjusted by the mobile communication terminal image size adjustment function described above). In other words, when the mobile communication terminal 3 and the vehicle-mounted apparatus 2 are in contact with each other, the displayed images on the screen 100 and the screen 105 are displayed as one continuing image.

A touch sensor is provided to each of a surface of the vehicle-mounted apparatus 2 and the mobile communication terminal 3. One example of methods of detecting a contact of the vehicle-mounted apparatus 2 and the mobile communication terminal 3 is a method of confirming a contact simultaneously detected by the contact sensors via communications between the vehicle-mounted apparatus 2 and the mobile communication terminal 3. Another example is a method of detecting a contact between the vehicle-mounted apparatus 2 and the mobile communication terminal 3 by analyzing an image captured by a camera provided near the vehicle-mounted apparatus 2.

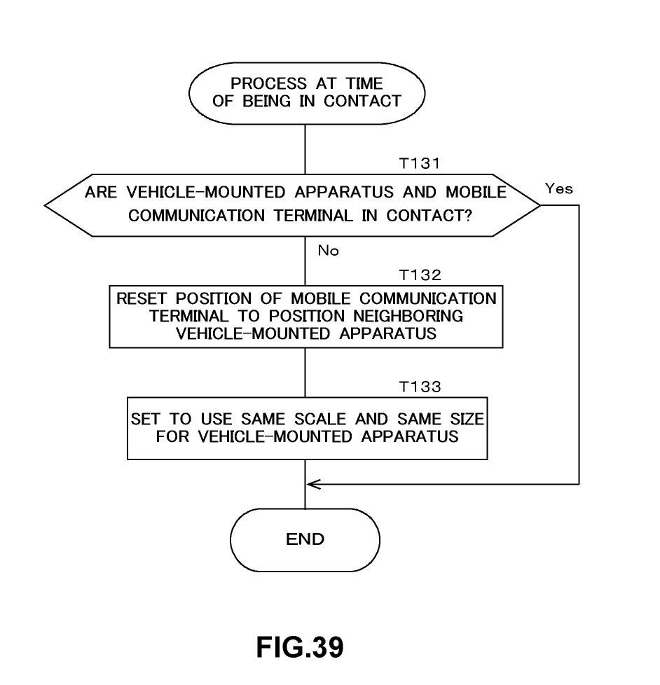

FIG. 39 illustrates a flow of a process that implements the function performed when mobile communication terminal and vehicle-mounted apparatus come into contact with each other. The process is performed repeatedly during the linked operation between the vehicle-mounted apparatus 2 and the mobile communication terminal 3.

In a step T131, the mobile communication microcomputer determines whether or not the vehicle-mounted apparatus 2 and the mobile communication terminal 3 are in a contact state. In a case where the mobile communication microcomputer determines that the vehicle-mounted apparatus 2 and the mobile communication terminal 3 are in the contact state, the mobile communication microcomputer moves to a step T132. In a case where the mobile communication microcomputer determines that the vehicle-mounted apparatus 2 and the mobile communication terminal 3 are not in the contact state, the mobile communication microcomputer ends the process. In the step T132, the mobile communication microcomputer resets the position data of the mobile communication terminal 3 to a position neighboring the vehicle-mounted apparatus 2, and moves to a step T133. The position data is changed to a reset value that is adjusted based on a contact position between the vehicle-mounted apparatus 2 and the mobile communication terminal 3. In other words, the reset value corresponding to the contact position is stored in a memory and is retrieved. In the step T133, the mobile communication microcomputer sets the scale and the size of the displayed map on the mobile communication terminal 3 such that the scale and the size are the same as a scale and a size of the displayed map on the vehicle-mounted apparatus 2, and ends the process.

Accordingly, when the vehicle-mounted apparatus 2 is in contact with the mobile communication terminal 3, the screen 105 of the mobile communication terminal 3 displays the displayed map showing the region neighboring the displayed map displayed on the screen 100 of the vehicle-mounted apparatus 2, on the same scale and in the same size.

### 10-2. Modifications of Ninth Embodiment

Next, modifications of the ninth embodiment are described. The vehicle-mounted apparatus 2 is an electronic apparatus. The wide-area map that is a virtual map wider than the displayed map on the screen 100 of the vehicle-mounted apparatus 2 and that is a to-be-displayed image larger than a size displayable on a screen of the electronic apparatus. The wide-area map is a position indicating map.

An electronic system includes a mobile communication terminal 3 and an electronic apparatus that is configured to communicate with the mobile communication terminal 3. The electronic apparatus includes an apparatus display that displays a first region that is a part of a to-be-displayed image larger than a displayable size. The mobile communication terminal 3 includes a terminal display that displays a second region that is a part of the to-be-displayed image corresponding to a relative position of the mobile communication terminal 3 to the electronic apparatus. The electronic system includes a position displaying part that displays a position indicating image that shows a positional relationship between the first region and the second region on the to-be-displayed image. The user who uses the electronic system can understand the positional relationship between the first region and the second region on the to-be-displayed image.

The mobile communication terminal 3 includes the terminal display that displays the second region that is a part of the to-be-displayed image, corresponding to the relative position of the mobile communication terminal 3 to the position of the electronic apparatus. Moreover, the mobile communication terminal 3 includes a position displaying part that displays the position indicating image that shows the positional relationship between the first region and the second region on the to-be-displayed image. The user who uses the mobile communication terminal 3 can understand the positional relationship between the first region and the second region on the to-be-displayed image at hand.

Further, in the mobile communication terminal 3, the position indicating image shows the positional relationship between the first region and the second region on the to-be displayed image, by using a mark similar to a screen of the apparatus display and a mark similar to a screen of the terminal display. The user can understand the first region and the second region on the to-be-displayed image by an appropriate positional relationship.

The electronic apparatus includes a terminal displaying part that causes the mobile communication terminal 3 to display the second region that is a part of the to-be-displayed image, corresponding to the relative position of the mobile communication terminal 3 to the electronic apparatus. Moreover, the electronic apparatus includes a position displaying part that causes the mobile communication terminal 3 to display the position indicating image that shows the positional relationship between the first region and the second region on the to-be-displayed image. The user who uses the electronic apparatus and the mobile communication terminal 3 can understand the positional relationship between the first region and the second region on the to-be-displayed image.

The to-be-displayed image on the electronic apparatus is a map image including a route guidance leading to a destination. The position indicating image shows a relational relationship among the first region, the second region and the destination. The user who uses the electronic apparatus and the mobile communication terminal 3 can understand the positional relationship among the first region, the second region and the destination.

Moreover, a figure formed by connecting the positions of the first region, the second region and the destination on the to-be-displayed image is similar to a figure formed by connecting the marks of the first region, the second region and the destination on the position indicating image. The user who uses the electronic apparatus and the mobile communication terminal 3 can see the marks representing the first region, the second region and the destination in an appropriate size.

### 11. 10th Embodiment

### 11-1. Outline

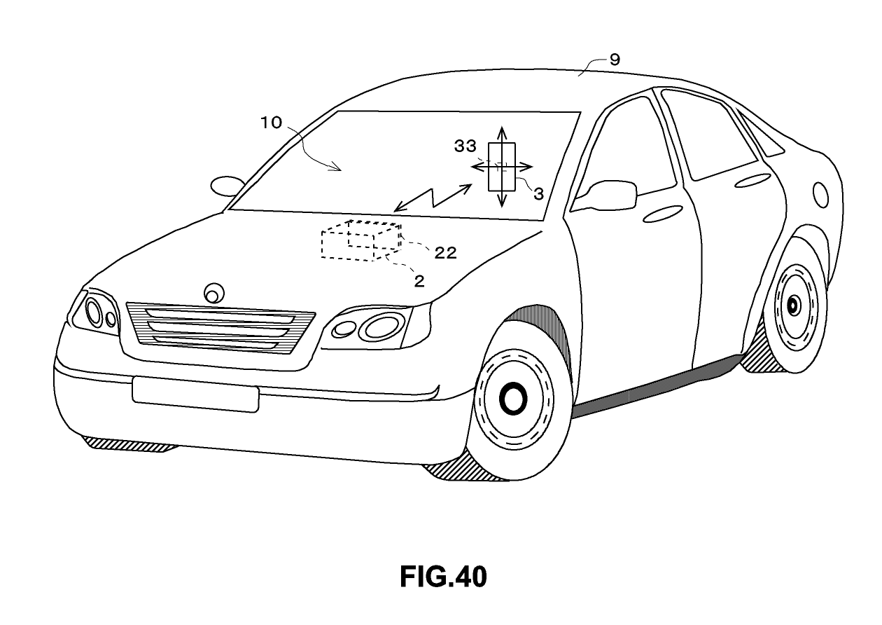

Next, a tenth embodiment is explained. FIG. 40 illustrates an outline of a communication system 10 in this embodiment. The communication system 10 includes a vehicle-mounted apparatus 2 that is mounted on a vehicle 9, such as a car, and a mobile communication terminal 3 that is configured separately from the vehicle-mounted apparatus 2. The vehicle-mounted apparatus 2 and the mobile communication terminal 3 are linked to each other to work.

Each of the vehicle-mounted apparatus 2 and the mobile communication terminal 3 includes a wireless communication function that uses a predetermined communication method, such as Bluetooth (registered trademark). Thus, the vehicle-mounted apparatus 2 and the mobile communication terminal 3 are configured to send and receive signals to/from each other via the wire communication. Moreover, the vehicle-mounted apparatus 2 and the mobile communication terminal 3 may be physically connected by a cable and may send and receive signals to/from each other via cable communication.

The vehicle-mounted apparatus 2 is an electronic apparatus that is fixed in a cabin of the vehicle 9 and includes a display 22 that displays various images. The vehicle-mounted apparatus 2 is, for example, a navigation apparatus that includes a navigation function of providing a route leading to a destination set by a user. An intended main user of the vehicle-mounted apparatus 2 is a driver in a driver's seat of the vehicle 9. Therefore, the vehicle-mounted apparatus 2 is disposed in a dashboard located in a front side of the cabin of the vehicle 9 such that mainly the driver can see a screen of the display 22.

The mobile communication terminal 3 is a portable communication terminal that can be held and used by the user and includes a phone function. For example, the mobile communication terminal 3 is a smartphone or a mobile phone that is used daily by the user. The mobile communication terminal 3 is mainly used by a user, other than the driver, in a passenger's seat or a backseat of the vehicle 9.

The mobile communication terminal 3 includes a motion sensor 33 and is configured to detect a motion, such as a move or a rotation, of the mobile communication terminal 3. In a case where the vehicle-mounted apparatus 2 and the mobile communication terminal 3 are linked to each other to work, the motion sensor 33 of the mobile communication terminal 3 detects the motion of the mobile communication terminal 3 held and moved (hereinafter referred to as “move(d) in hand) by the user. Then, the mobile communication terminal 3 sends to the vehicle-mounted apparatus 2 a terminal signal representing the detected motion of the mobile communication terminal 3. Once receiving the terminal signal, the vehicle-mounted apparatus 2 performs a process corresponding to the motion of the mobile communication terminal 3 based on the received terminal signal. Therefore, the user can cause the vehicle-mounted apparatus 2 to perform a predetermined process by moving the mobile communication terminal 3.

For example, in a case where the mobile communication terminal 3 is positioned next to the vehicle-mounted apparatus 2 displaying a map, a region of the map that is not displayed on the vehicle-mounted apparatus 2 and that continues from the map displayed on the vehicle-mounted apparatus 2 is displayed on the mobile communication terminal 3. Thus, while the map showing a region near the vehicle 9 is being displayed on the vehicle-mounted apparatus 2, it is possible to see, on the mobile communication terminal 3, a map showing a region near the destination that is not included in the map on the vehicle-mounted apparatus 2.

In this case, the user can smoothly see the map from the displayed region to the destination by matching a scrolled distance of the map displayed on the mobile communication terminal 3 to a distance by which the mobile communication terminal 3 is moved (hereinafter referred to as “moved distance”). Matching of the moved distance of the mobile communication terminal 3 to the scrolled distance of the map displayed on the mobile communication terminal 3 means that a ratio of the scrolled distance of the map displayed on the mobile communication terminal 3 to the moved distance of the mobile communication terminal 3 is set to 1:1, i.e., equal.

Moreover, in a case where the ratio of the scrolled distance of the map displayed on the mobile communication terminal 3 to the moved distance of the mobile communication terminal 3 is set to a ratio greater than equal, the map displayed on the mobile communication terminal 3 is scrolled greater than the moved distance of the mobile communication terminal 3 as compared to the equal ratio. In this case, even if the destination is located a long distance away from a region near the vehicle 9, the user can see the destination easily by moving the mobile communication terminal 3 by a small distance.

In a case where the ratio of the scrolled distance of the map displayed on the mobile communication terminal 3 to the moved distance of the mobile communication terminal 3 is set to a ratio smaller than equal (and greater than 0), the map displayed on the mobile communication terminal 3 is scrolled less than the moved distance of the mobile communication terminal 3 as compared to the equal ratio. In this case, the user can see a region near the destination more in detail.

A configuration and a process of the communication system 10 mentioned above are explained in detail below.

### 11-2. Configuration

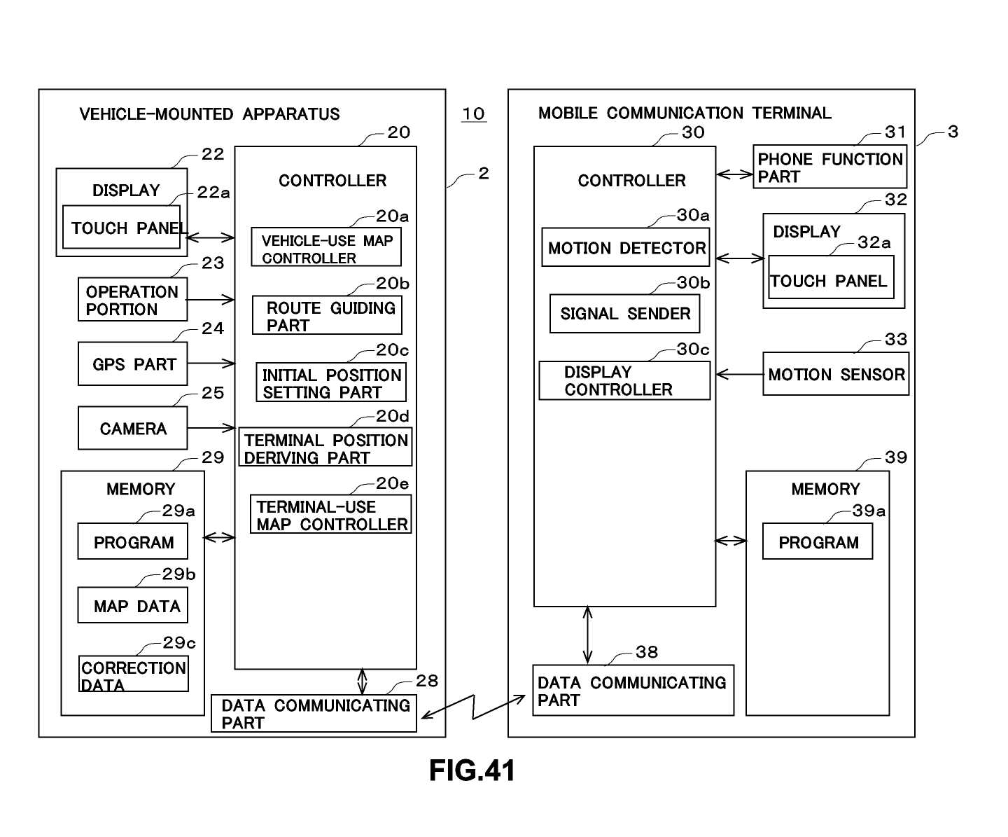

FIG. 41 illustrates the configuration of the communication system 10. A left portion of FIG. 41 illustrates a configuration of the vehicle-mounted apparatus 2 and a right portion of FIG. 2 illustrates a configuration of the mobile communication terminal 3.

The vehicle-mounted apparatus 2 includes a controller 20, the display 22, an operation portion 23, a GPS part 24, a camera 25, a data communication part 28 and a memory 29. The controller 20 is a microcomputer that includes a CPU, a RAM, a ROM and/or the like and controls the entire vehicle-mounted apparatus 2.

The display 22 includes, for example, a liquid crystal panel and displays the various images. Moreover, the display 22 includes a touch panel 22a and functions as an operation receiving portion that receives a user operation. In a case where a user operates the display 22 functioning as the touch panel, a signal representing a content of the user operation is input to the controller 20.

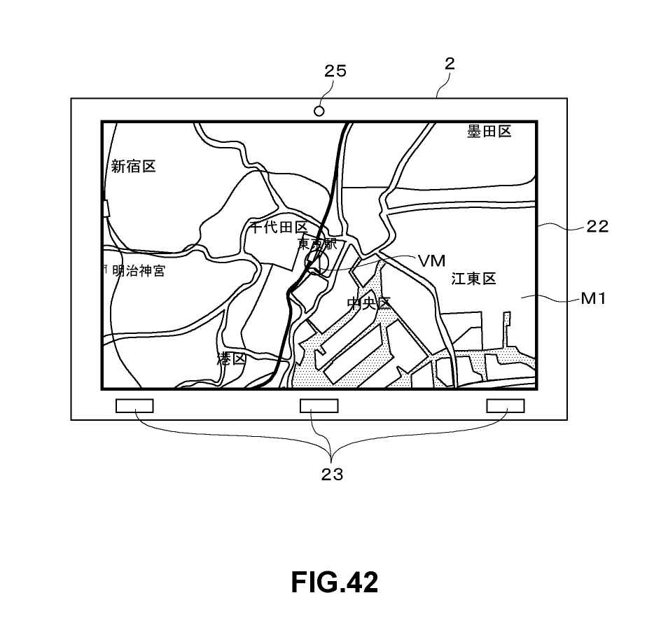

The operation portion 23 is an operation receiving portion that receives a user operation directly. The operation portion 23 includes, for example, plural operation buttons disposed below the screen of the display 22 (refer to FIG. 42). In a case where the user operates the operation portion 23, a signal representing a content of the user operation is input to the controller 20.

The GPS part 24 acquires a location where the vehicle-mounted apparatus 2 is currently located (absolute position on the earth) by receiving signals from plural GPS satellites. The vehicle-mounted apparatus 2 is mounted on the vehicle 9. Therefore, practically, the GPS part 24 acquires a location where the vehicle 9 is currently located. The location, acquired by the GPS part 24, where the vehicle 9 is currently located is hereinafter referred to as “current location.” The current location acquired by the GPS part 24 is represented, for example, by latitude and longitude and can be used as information for defining a position on a map.

The camera 25 includes a lens and an image sensor. The camera 25 captures an image of an object and electronically acquires the captured image. The camera 25 is provided, for example, above the screen of the display 22 (refer to FIG. 42). Therefore, the camera 25 captures an image of an object existing in front of the screen of the display 22 and acquires the captured image including an image of the object.

The data communication part 28 sends and receives signals to/from the mobile communication terminal 3 via the wireless communication based on the predetermined communication method. The data communication part 28 receives from the mobile communication terminal 3 the terminal signal representing the motion of the mobile communication terminal 3. Moreover, the data communication part 28 sends to the mobile communication terminal 3 an image to be displayed on the mobile communication terminal 3.

The memory 29 is, for example, a non-volatile memory, such as a flash memory, and stores various information. The memory 29 stores, for example, a program 29a that is executable by the controller 20, map data 29b that is used for the navigation function and correction data 29c. Processing parts including various functions, such as the navigation function, are implemented in the controller 20 by software by the CPU of the controller 20 performing arithmetic processing based on the program 29a.

The correction data 29c is numeric data that is used for setting the ratio between the scrolled distance of the map displayed on the mobile communication terminal 3 and the moved distance of the mobile communication terminal 3. The correction data 29c is a real number that is greater than 0. The correction data 29c is stored in the memory 29 beforehand. Moreover, the correction data 29c may be input into the memory 29 and may be updated by the user.

In a case where the correction data 29c is “1,” the ratio of the scrolled distance of the map displayed on the mobile communication terminal 3 to the moved distance of the mobile communication terminal 3 is 1:1 (equal). For example, in a case where the moved distance of the mobile communication terminal 3 is 10 cm, the map displayed on the mobile communication terminal 3 is scrolled by 10 cm.

In a case where the correction data 29c is “2,” the ratio of the scrolled distance of the map displayed on the mobile communication terminal 3 to the moved distance of the mobile communication terminal 3 is 2:1 (double). For example, in a case where the moved distance of the mobile communication terminal 3 is 10 cm, the map displayed on the mobile communication terminal 3 is scrolled by 20 cm.

In a case where the correction data 29c is “0.5,” the ratio of the scrolled distance of the map displayed on the mobile communication terminal 3 to the moved distance of the mobile communication terminal 3 is 1:2 (half). For example, in a case where the moved distance of the mobile communication terminal 3 is 10 cm, the map displayed on the mobile communication terminal 3 is scrolled by 5 cm.

A vehicle-use map controller 20a, a route guiding part 20b, an initial position setting part 20c, a terminal position deriving part 20d and a terminal-use map controller 20e, shown in FIG. 41, are a part of the processing parts that are implemented by software by execution of the program 29a.

The vehicle-use map controller 20a generates a map used in the vehicle 9 (hereinafter referred to as vehicle-use map) that is to be displayed on the display 22 of the vehicle-mounted apparatus 2 and causes the display 22 to display the map. The vehicle-use map controller 20a generates the vehicle-use map including the current location, using the map data 29b stored in the memory 29. The vehicle-use map controller 20a controls the display 22 to display the generated vehicle-use map.

The route guiding part 20b provides the route leading to the destination. The route guiding part 20b derives the route leading to the destination from the current location, using the map data 29b stored in the memory 29 and superimposes the derived route on the vehicle-use map generated by the vehicle-use map controller 20a. Thus, the route leading to the destination is provided to the user.

Each of the initial position setting part 20c, the terminal position deriving part 20d and the terminal-use map controller 20e performs a process relating to an operation performed by linked work between the vehicle-mounted apparatus 2 and the mobile communication terminal 3. The processes that are performed by the initial position setting part 20c, the terminal position deriving part 20d and the terminal-use map controller 20e will be described later in detail.

The mobile communication terminal 3 includes a controller 30, a phone function part 31, a display 32, the motion sensor 33, a data communicating part 38 and a memory 39. The controller 30 is a microcomputer that includes a CPU, a RAM, a ROM and/or the like and controls the entire mobile communication terminal 3.

The phone function part 31 implements the phone function of the mobile communication terminal 3. The phone function part 31 converts voice of the user in conversation into electrical signals and sends the signals to a base station. Moreover, the phone function part 31 receives from the base station audio signals representing audio from a person who has conversation with the user and outputs the sound.

The display 32 includes, for example, a liquid crystal panel and displays various images. Moreover, the display 32 includes a touch panel 32a and also functions as an operation receiving portion that receives a user operation. In a case where the user operates the display 32 functioning as the touch panel, a signal representing a content of the user operation is input to the controller 30.

The motion sensor 33 detects the motion of the mobile communication terminal 3. The motion sensor 33 is, for example, a 6-axis sensor that is configured to detect accelerations in directions of three axes and angular speeds around the three axes. More specifically, in a case of an XYZ Cartesian coordinate system, the motion sensor 33 is configured to detect a move in each direction of an X-axis, a Y-axis and a Z-axis (accelerations along the three axes) and a rotation about each of the X-axis, the Y-axis and the Z-axis (angular speeds around the three axes). In a case where an angular speed acts on an object moving at a speed, a fictitious force (the Coriolis effect) is generated. Moreover, in a case where an acceleration acts on an object, a force is generated (Newton's laws). The motion sensor 33 detects the accelerations and the angular speeds along/around the three axes based on these principles.

The data communicating part 38 sends and receives signals to/from the vehicle-mounted apparatus 2 via the wireless communication based on the predetermined communication method. The data communicating part 38 sends to the vehicle-mounted apparatus 2 the terminal signal representing the motion of the mobile communication terminal 3. Moreover, the data communicating part 38 receives the image to be displayed on the mobile communication terminal 3 from the vehicle-mounted apparatus 2.

The memory 39 is, for example, a non-volatile memory, such as a flash memory, and stores various information. The memory 39 stores, for example, a program 39a of an application that is executable by the controller 30. Processing parts including various functions are implemented in the controller 30 by software by the CPU of the controller 30 performing arithmetic processing based on the program 39a.

A motion detector 30a, a signal sender 30b and a display controller 30c, shown in FIG. 41, are a part of the processing parts that are implemented by software by execution of the program 39a.

The motion detector 30a controls the motion sensor 33 to acquire a sensor signal representing the motion of the mobile communication terminal 3 from the motion sensor 33. The sensor signal represents the accelerations and the angular speeds along/around the three axes. The signal sender 30b controls the data communicating part 38 to send the sensor signal acquired by the motion detector 30a, as the terminal signal, to the vehicle-mounted apparatus 2.

Moreover, the display controller 30c controls the display 32 to display on the display 32 the image that the data communicating part 38 receives from the vehicle-mounted apparatus 2.

The processes that are performed by the motion detector 30a, the signal sender 30b and the display controller 30c will be described later in detail.

### 1-3. Outline of Linked Operation

Next explained is an outline of an operation performed by the linked work of the vehicle-mounted apparatus 2 and the mobile communication terminal 3 (hereinafter referred to as linked operation) in the communication system 10.

FIG. 42 illustrates the vehicle-mounted apparatus 2 working independently without being linked with the mobile communication terminal 3. As shown in FIG. 42, the display 22 of the vehicle-mounted apparatus 2 displays a vehicle-use map M1.

The vehicle-use map M1 is a map showing a region including the current location (the location where the vehicle 9 is currently located). The current location is shown in a center of the vehicle-use map M1 and a host vehicle mark VM representing the current location of the vehicle 9 is positioned in the center. Therefore, the host vehicle mark VM is shown in a center of the screen of the display 22 that displays the vehicle-use map M1.

The user (mainly the driver of the vehicle 9) can see the map showing a region around the current location by seeing the vehicle-use map M1 displayed on the display 22 as described above. In a case of an example shown in FIG. 42, the current location is near “Tokyo Station” and the vehicle-use map M1 having “Tokyo Station” substantially in the center is displayed on the display 22 of the vehicle-mounted apparatus 2.

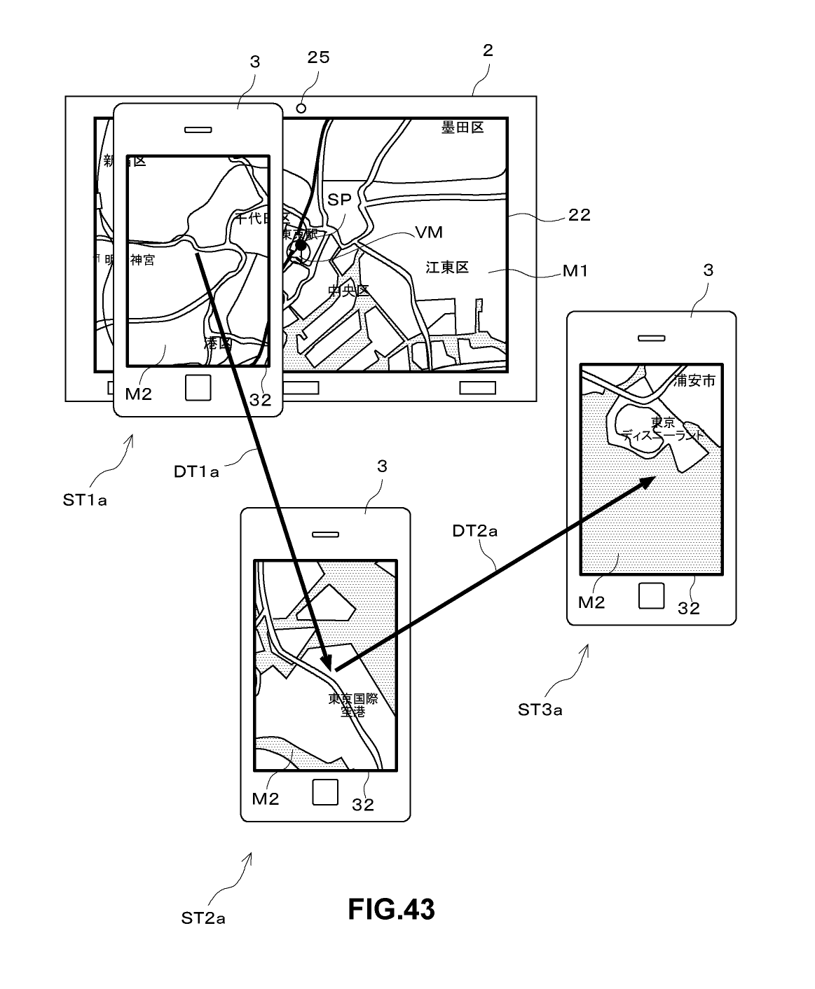

FIG. 43 illustrates the linked operation between the vehicle-mounted apparatus 2 and the mobile communication terminal 3 in a case where the current location is the same as the current location in FIG. 42. In this case, too, the display 22 of the vehicle-mounted apparatus 2 displays the vehicle-use map M1 showing the region including the current location.

On the other hand, the display 32 of the mobile communication terminal 3 displays a map M2 showing a region different from the vehicle-use map M1 (hereinafter referred to as “terminal-use map”) on a same map scale used for the vehicle-use map M1. The terminal-use map M2 is a map showing a region corresponding to a relative position of the mobile communication terminal 3 to a position of the vehicle-mounted apparatus 2. Therefore, in a case where the user moves the mobile communication terminal 3 in hand, the region included in the terminal-use map M2 displayed on the display 32 varies depending on the motion of the mobile communication terminal 3

In a case where the mobile communication terminal 3 is moved substantially parallel to the screen of the display 22 of the vehicle-mounted apparatus 2, the mobile communication terminal 3 scrolls the terminal-use map M2 based on the motion and displays the scrolled terminal-use map M2. A scrolled distance of the terminal-use map M2 is approximately the same as an actually-moved distance of the mobile communication terminal 3. Moreover, a direction in which the terminal-use map M2 is scrolled is approximately the same as a direction in which the mobile communication terminal 3 is moved. As a result, the terminal-use map M2 showing a region corresponding to the position of the moved mobile communication terminal 3 is displayed on the mobile communication terminal 3.

For example, as shown in a state ST1a in FIG. 43, in a case where the mobile communication terminal 3 is overlapped on the screen of the display 22 of the vehicle-mounted apparatus 2, the mobile communication terminal 3 displays the terminal-use map M2 showing a region of the vehicle-use map M1 immediately under the mobile communication terminal 3, i.e., an overlapped portion of the vehicle-use map M1 displayed on the vehicle-mounted apparatus 2.

Moreover, as shown in a state ST2a, in a case where the mobile communication terminal 3 is moved diagonally downward to the right from the state ST1a by a distance DT1a, the mobile communication terminal 3 displays the terminal-use map M2 showing a region located the distance DT1a away to a diagonally lower right side (i.e., more southern) from a position, shown in the state ST1a, on the vehicle-use map M1 displayed on the vehicle-mounted apparatus 2. In a case of an example shown in FIG. 43, the mobile communication terminal 3 displays the terminal-use map M2 showing a region near “airport” located in the south of “Tokyo Station.”

As shown in a state ST3a, in a case where the mobile communication terminal 3 is moved diagonally upward to the right from the state ST2a by a distance DT2a, the mobile communication terminal 3 displays the terminal-use map M2 showing a region located the distance DT2a away to a diagonally upper right side (i.e. more northeast) from a position, shown in the state ST2a, on the terminal-use map M2 shown in the state ST2a. In a case of an example shown in FIG. 43, the mobile communication terminal 3 displays the terminal-use map M2 showing a region near “theme park” located in the southeast of “Tokyo Station.”

As described above, the user can see the map showing a desired region different from the region displayed on the display 22 of the vehicle-mounted apparatus 2, by moving the mobile communication terminal 3 in hand. Even in this case, the vehicle-use map M1 is displayed on the display 22 of the vehicle-mounted apparatus 2 and displaying of the terminal-use map M2 on the mobile communication terminal 3 has no influence on the vehicle-use map M1 on the vehicle-mounted apparatus 2. Therefore, the driver can understand the region near the current location as normal by seeing the vehicle-use map M1 displayed on the vehicle-mounted apparatus 2.

As described above, in a case where the scrolled distance of the terminal-use map M2 is matched to the actual moved distance of the mobile communication terminal 3, a region corresponding to the scrolled terminal-use map M2 is displayed on the mobile communication terminal 3. In other words, the scrolled distance of the terminal-use map M2 to the actual moved distance of the mobile communication terminal 3 is 1:1 (equal).

On the other hand, in a case where the ratio of the scrolled distance of the map displayed on the mobile communication terminal 3 to the moved distance of the mobile communication terminal 3 is set to a ratio greater than equal, the map displayed on the mobile communication terminal 3 is scrolled greater than the moved distance of the mobile communication terminal 3.

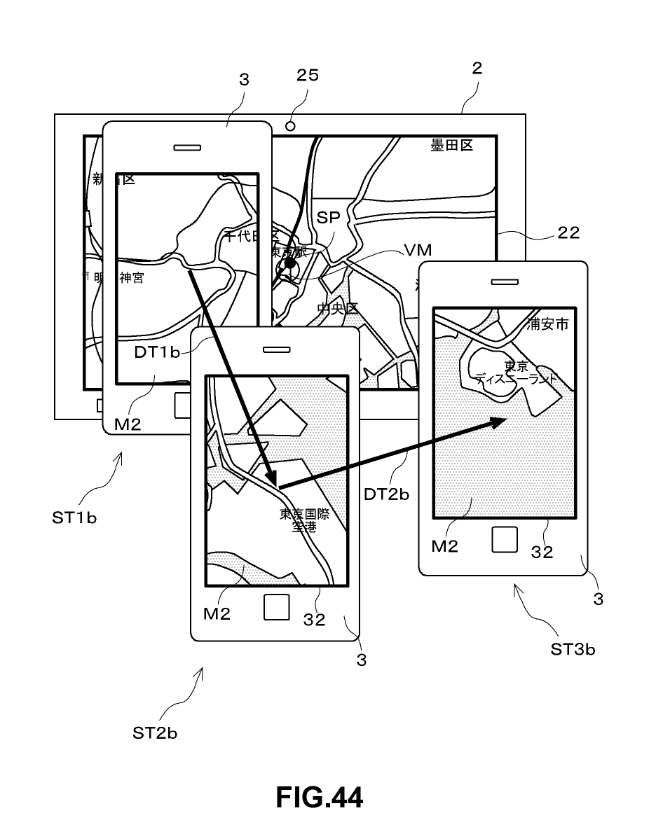

FIG. 44 illustrates a state where the mobile communication terminal 3 is moved from the state where the mobile communication terminal 3 is overlapped on the display 22 of the mobile communication terminal 3, in a 2:1 (double) ratio of the scrolled distance of the map displayed on the mobile communication terminal 3 to the moved distance of the mobile communication terminal 3. The moved distance of the mobile communication terminal 3 is half (the DT1b and the DT2b) as compared to the moved distance (the DT1a and the DT2a) shown in FIG. 44. A direction in which the mobile communication terminal 3 is moved is the same as the direction in the case illustrated in FIG. 43.

As shown in a state ST1b in FIG. 44, in a case where the mobile communication terminal 3 is overlapped on the screen of the display 22 of the vehicle-mounted apparatus 2, the mobile communication terminal 3 displays the terminal-use map M2 showing a region immediately under the mobile communication terminal 3, i.e., an overlapped portion of the vehicle-use map M1 displayed on the vehicle-mounted apparatus 2.

Moreover, as shown in a state ST2b, in a case where the mobile communication terminal 3 is moved diagonally downward to the right from the state ST1b by a distance DT1b, i.e., a half of a distance DT1a, the mobile communication terminal 3 displays the terminal-use map M2 showing a region located the distance DT1b away to a diagonally lower right side (i.e., more southern) from a position, shown in the state ST1b, on the vehicle-use map M1 displayed on the vehicle-mounted apparatus 2. In a case of an example shown in FIG. 44, like the example shown in FIG. 43, the mobile communication terminal 3 displays the terminal-use map M2 showing the region near “airport” located in the south of “Tokyo Station.”

Further, as shown in a state ST3b, in a case where the mobile communication terminal 3 is moved diagonally upward to the right from the state ST2b by a distance DT2b, i.e., a half of the distance DT2a, the mobile communication terminal 3 displays the terminal-use map M2 showing a region located the distance DT2b away to a diagonally upper right side (i.e. more northeast) from a position, shown in the state ST2b, on the terminal-use map M2 shown in the state ST2a. In a case of an example shown in FIG. 44, the mobile communication terminal 3 displays the terminal-use map M2 showing a region near “theme park” located in the southeast of “Tokyo Station.”

As described above, in the example shown in FIG. 44, the moved distance of the mobile communication terminal 3 is a half of the moved distance of the mobile communication terminal 3 in the example shown in FIG. 43. However, since the scrolled distance of the map displayed on the mobile communication terminal 3 to the moved distance of the mobile communication terminal 3 is set to 2:1 (double), the substantially same region is displayed as the terminal-use map M2 on the mobile communication terminal 3 as the example in FIG. 43.

Therefore, in the case where the ratio of the scrolled distance of the map displayed on the mobile communication terminal 3 to the moved distance of the mobile communication terminal 3 is set to a ratio greater than equal, the map displayed on the mobile communication terminal 3 is scrolled greater than the moved distance of the mobile communication terminal 3. In this case, even if a destination is located a long distance away from a region near the vehicle 9, the use can see the destination easily by moving the mobile communication terminal 3 by a small distance.

In the case where the ratio of the scrolled distance of the map displayed on the mobile communication terminal 3 to the moved distance of the mobile communication terminal 3 is set to a ratio smaller (but greater than 0) than equal, the map displayed on the mobile communication terminal 3 is scrolled less than the moved distance of the mobile communication terminal 3. In this case, since the map displayed on the mobile communication terminal 3 is scrolled less than the moved distance of the mobile communication terminal 3 (since the map moves slowly), the use can see an area near the destination in detail.

<1-2-2. Terminal Map of Wide-Area Map>

The position of the mobile communication terminal 3 is defined based on a center position of the screen of the display 22 of the vehicle-mounted apparatus 2. In other words, the center position of the screen of the display 22 is deemed as a reference position SP and the position of the mobile communication terminal 3 is derived as a relative position to the reference position SP. Moreover, the moved distance and the moved direction of the mobile communication terminal 3 are derived based on the motion of the mobile communication terminal 3 detected by the motion sensor 33.

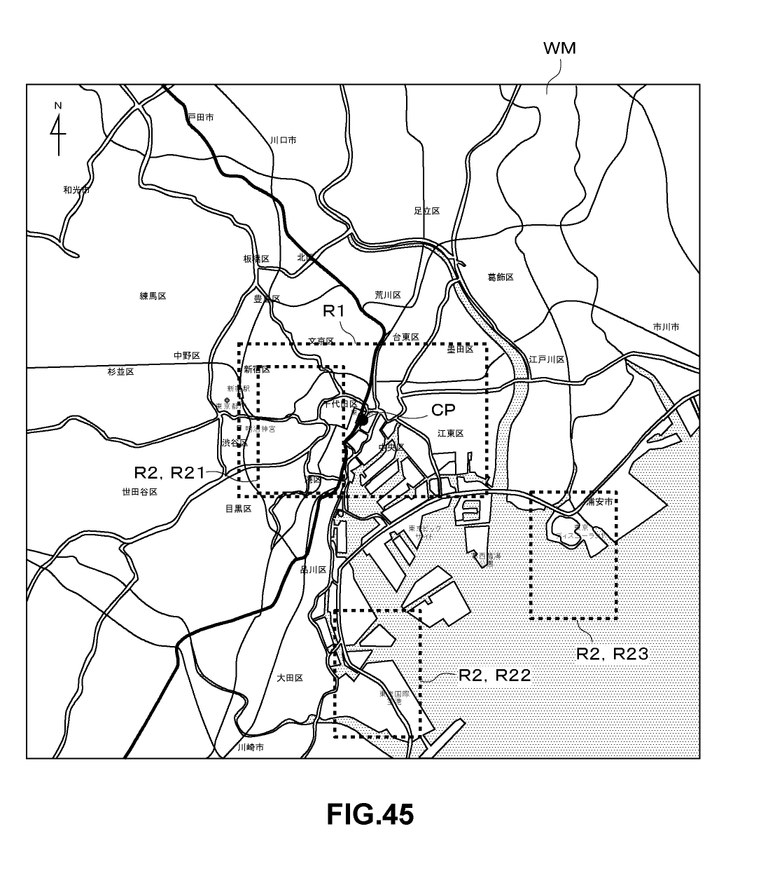

When such a terminal-use map M2 is displayed, a wide-area map that is a virtual map wider than the vehicle-use map M1 is generated. FIG. 45 illustrates an example of such a wide-area map WM. A center position CP of the wide-area map WM (hereinafter referred to as “map center”) is positioned in the center position of the screen of the display 22 of the vehicle-mounted apparatus 2 (i.e., the reference position SP). Therefore, in this embodiment, the map center CP is the current location where the vehicle 9 is currently located. The vehicle-use map M1 displayed on the vehicle-mounted apparatus 2 is generate by clipping, from the wide-area map WM, a region R1 such that the current location is in the center position of the vehicle-use map M1.

On the other hand, the terminal-use map M2 displayed on the mobile communication terminal 3 is generated by clipping, from the wide-area map WM, a region R2 corresponding to the position of the mobile communication terminal 3. The region R2 clipped from the wide-area map WM as the terminal-use map M2 is hereinafter referred to as “terminal-use map region.”

A relative position of the terminal-use map region R2 to the map center CP substantially corresponds to an actual relative position of the mobile communication terminal 3 to the reference position SP. In other words, a direction of the terminal-use map region R2 relative to the map center CP substantially corresponds to an actual direction of the mobile communication terminal 3 relative to the reference position SP. Moreover, a displayed distance from the map center CP to the terminal-use map region R2 on the map corresponds to an actual distance from the reference position SP to the mobile communication terminal 3. The displayed distance from the map center CP to the terminal-use map region R2 on the map is derived in consideration of resolution and a size of a screen of the display 32 of the mobile communication terminal 3. Thus, the mobile communication terminal 3 displays the terminal-use map M2 showing the region corresponding to the relative position of the mobile communication terminal 3 to the reference position SP.

For example, in the state ST1a shown in FIG. 43 and in the state ST1b shown in FIG. 44, the mobile communication terminal 3 is located on a left side of the reference position SP. Therefore, in the state ST1a and in the state ST1b, a region R21 left to the map center CP of the wide-area map WM shown in FIG. 45 is clipped as the terminal-use map region R2 and is displayed as the terminal-use map M2.

Moreover, in the state ST2a shown in FIG. 43 and in the state ST2b in FIG. 44, the mobile communication terminal 3 is located lower than the reference position SP. Therefore, in the state ST2a and in the state ST2b, a region R22 lower than the map center CP of the wide-area map WM shown in FIG. 45 is clipped as the terminal-use map region R2 and is displayed as the terminal-use map M2.

Further, in the state ST3a shown in FIG. 43 and in the state ST3b in FIG. 44, the mobile communication terminal 3 is located on a lower right side of the reference position SP. Therefore, in the state ST3a and in the state ST3b, a region R23 lower right to the map center CP of the wide-area map WM shown in FIG. 45 is clipped as the terminal-use map region R2 and is displayed as the terminal-use map M2.

<11-3. Process>

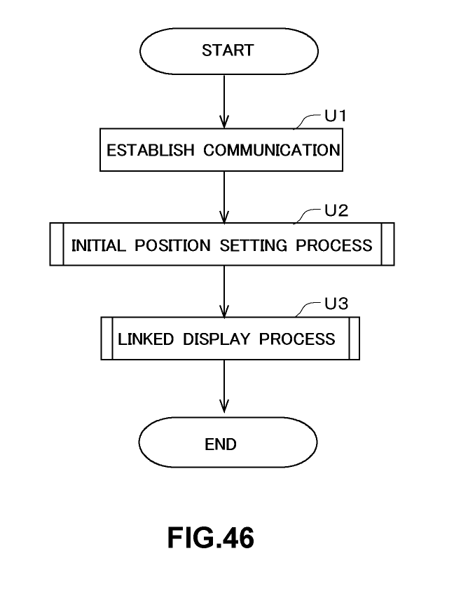

Next explained is a flow of the linked operation that is performed by the communication system 10. FIG. 46 illustrates a flow of a basic process of the linked operation. At a start point of the flow, a predetermined application for linking the mobile communication terminal 3 to the vehicle-mounted apparatus 2 has been already executed in the mobile communication terminal 3. Thus, the motion detector 30a, the signal sender 30b and the display controller 30c of the mobile communication terminal 3 are activated.

First, a negotiation for connection between the vehicle-mounted apparatus 2 and the mobile communication terminal 3 is performed and communication between the vehicle-mounted apparatus 2 and the mobile communication terminal 3 is established (a step U1). After this step, the vehicle-mounted apparatus 2 and the mobile communication terminal 3 are ready to send/receive the signals to/from each other.

Next, an initial position setting process that sets an initial position of the mobile communication terminal 3 is performed (a step U2). In the initial position setting process, the position of the mobile communication terminal 3 at the start point of the linked operation is set as an initial position.

Next, a linked display process that displays the map by linked operation between the vehicle-mounted apparatus 2 and the mobile communication terminal 3 (a step U3). The linked display process causes the mobile communication terminal 3 to display the terminal-use map M2 showing the region corresponding to the relative position of the mobile communication terminal 3 to the reference position SP, as described above.

Detailed flows of the initial position setting process and the linked display process are hereinafter described.

<11-3-1. Initial Position Setting Process>

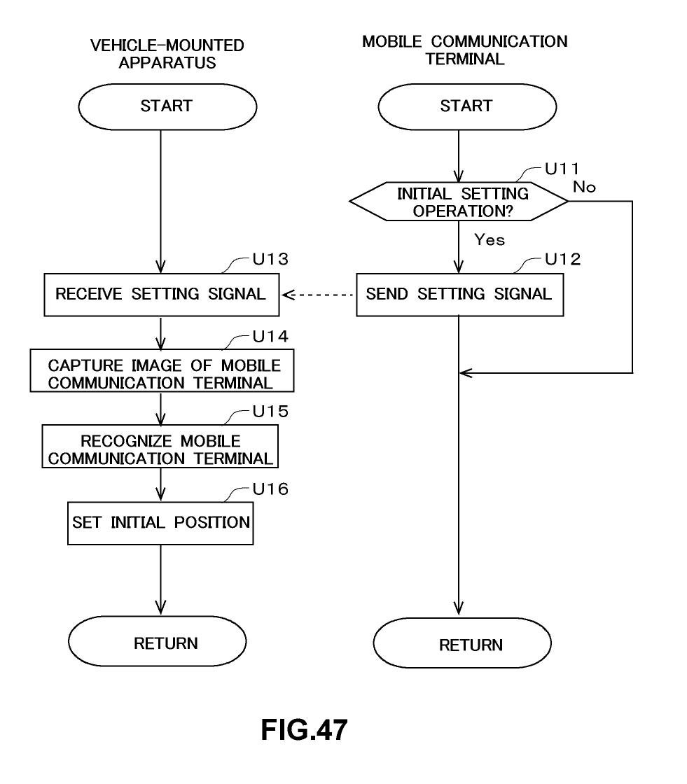

First explained is a flow of the initial position setting process (the step U2 in FIG. 46) that sets the initial position of the mobile communication terminal 3. A flow on a left side in FIG. 47 is performed by vehicle-mounted apparatus 2 and a flow on a right side in FIG. 47 is performed by the mobile communication terminal 3.

First, the signal sender 30b of the mobile communication terminal 3 determines whether or not the user has performed an initial setting operation for setting the initial position (a step U11). The user performs the initial setting operation by touching a command button on the display 32 functioning as the touch panel. The user moves the mobile communication terminal 3 to the front of the screen of the display 22 and then performs such an initial setting operation.

In a case where the initial setting operation has been performed (Yes in the step U11), the signal sender 30b controls the data communicating part 38 to send to the vehicle-mounted apparatus 2 a setting signal representing that the initial setting operation has been performed (a step U12).

The data communication part 28 of the vehicle-mounted apparatus 2 receives the setting signal sent from the mobile communication terminal 3 (a step U13). Once the data communication part 28 receives the setting signal, the initial position setting part 20c of the vehicle-mounted apparatus 2 controls the camera 25 to capture an image of the mobile communication terminal 3 located in front of the screen of the display 22 (a step U14). Thus, the initial position setting part 20c acquires the captured image including the image of the mobile communication terminal 3.

Next, the initial position setting part 20c recognizes an image of the mobile communication terminal 3 in the acquired captured image (a step U15). The initial position setting part 20c is configured to recognize the image of the mobile communication terminal 3 in the captured image by a well-known method, such as pattern matching.

Next, the initial position setting part 20c sets the initial position of the mobile communication terminal 3 based on a position of the image of the mobile communication terminal 3 in the captured image (a step U16). The initial position setting part 20c derives a direction and a degree of a difference of the actual position of the mobile communication terminal 3, i.e., a degree of deviation, from the reference position (the center position of the screen of the display 22) SP based on a difference of the position of the image of the mobile communication terminal 3 from a center in the captured image. Thus, the initial position setting part 20c sets the initial position of the mobile communication terminal 3 based on the reference position SP.

<11-3-2. Linked Display Process>

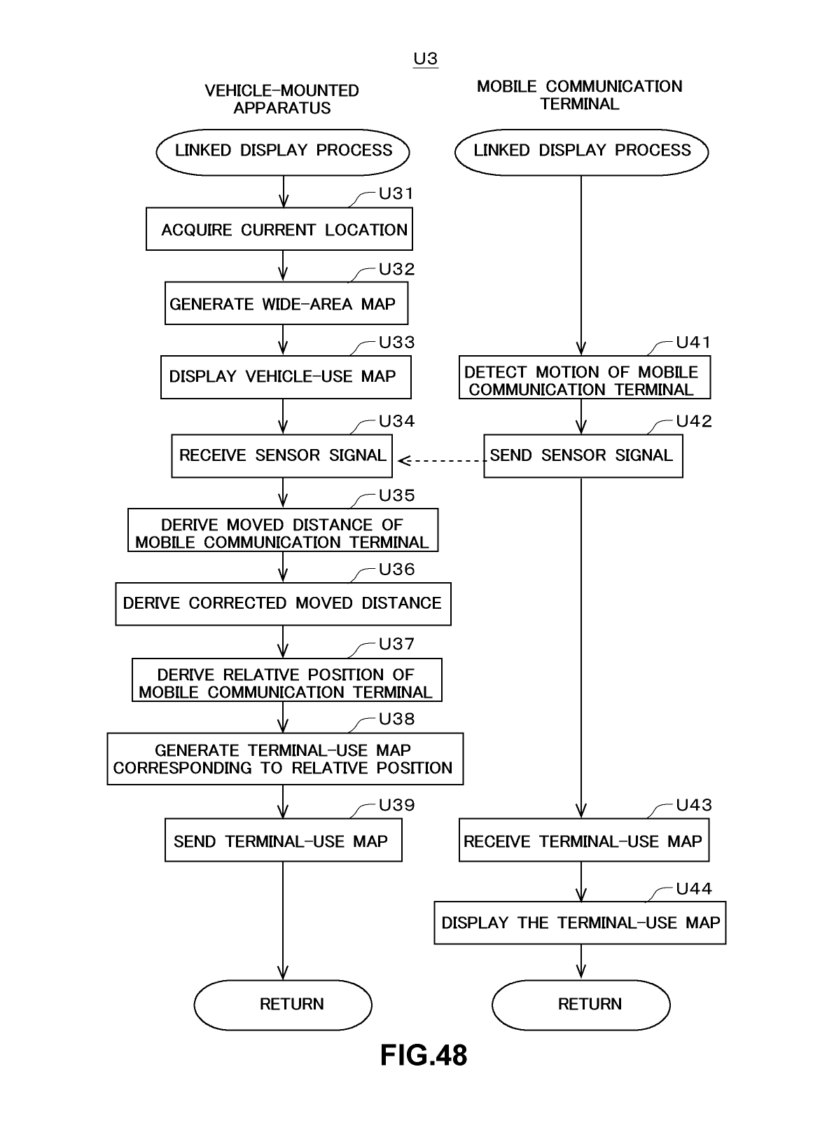

Next explained is a flow of the linked display process (the step U3 in FIG. 46) that causes the map to be displayed by linked operation between the vehicle-mounted apparatus 2 and the mobile communication terminal 3. FIG. 48 illustrates the flow of the linked display process. A flow on a left side in FIG. 48 is performed by vehicle-mounted apparatus 2 and a flow on a right side in FIG. 48 is performed by the mobile communication terminal 3. The processes shown in FIG. 48 are performed repeatedly at a predetermined cycle (e.g. 1/30 second-cycle).

First, the vehicle-use map controller 20a of the vehicle-mounted apparatus 2 controls the GPS part 24 to acquire the current location where the vehicle 9 is located on the map (a step U31).

Next, the vehicle-use map controller 20a generates the wide-area map WM wider than the vehicle-use map M1 (a step U32). The vehicle-use map controller 20a generates the wide-area map WM, as shown in FIG. 5, using the map data 29b stored in the memory 29, such that the current location is in the map center CP of the wide-area map WM.

Next, the vehicle-use map controller 20a generates the vehicle-use map M1 and causes the display 22 to display the generated vehicle-use map M1 (a step U33). The vehicle-use map controller 20a generates the vehicle-use map M1 by clipping the region R1 from the wide-area map WM, such that the current location of the vehicle 9 on the wide-area map WM is in the center of the region R1. The vehicle-use map controller 20a controls the display 22 to display the generated vehicle-use map M1.

Thus, the vehicle-use map M1 having the current location in the center is displayed on the vehicle-mounted apparatus 2. In a case where the destination is set, the route guiding part 20b superimposes a route leading to the destination on the vehicle-use map M1 before the vehicle-use map M1 is displayed on the display 22. As a result, the user (mainly the driver) can see a region around the current location and the route leading to the destination by seeing the vehicle-use map M1 displayed on the vehicle-mounted apparatus 2.

While the vehicle-use map M1 is displayed on the vehicle-mounted apparatus 2 as described above, the motion sensor 33 of the mobile communication terminal 3 detects the motion of the mobile communication terminal 3 (a step U41). The motion detector 30a controls the motion sensor 33 to acquire from the motion sensor 33 the sensor signal representing the motion of the mobile communication terminal 3. The sensor signal represents accelerations and angular speeds along/around the three axes.

Next, the signal sender 30b of the mobile communication terminal 3 controls the data communicating part 38 to send the sensor signal to the vehicle-mounted apparatus 2 as the terminal signal corresponding to the motion of the mobile communication terminal 3 (a step U42).

The data communication part 28 of the vehicle-mounted apparatus 2 receives the sensor signal sent from the mobile communication terminal 3 (a step U34). The terminal position deriving part 20d of the vehicle-mounted apparatus 2 derives the moved distance of the mobile communication terminal 3 along each of the three axes from a position derived in a previous linked display process (a series of process in FIG. 48), based on the accelerations along the three axes represented by the sensor signal (a step U35).

Next, the terminal position deriving part 20d retrieves the correction data 29c from the memory 29 and derives a corrected moved distance by multiplying a value represented by the correction data 29c by the derived moved distance (a step U36). The correction data 29c is a real number that is greater than 0. Therefore, in a case where the correction data 29c is “2,” the corrected moved distance is derived by multiplying the moved distance by 2. Moreover, in a case where the correction data 29c is “0.5,” the corrected moved distance is a half of the moved distance. In a case where the correction data 29c is “1,” the corrected moved distance is a distance derived by multiplying the moved distance by 1, i.e., the corrected moved distance is the moved distance.

Moreover, the terminal position deriving part 20d derives the moved distance of the mobile communication terminal 3 from the initial position along the three axes by accumulating the moved distances of the mobile communication terminal 3 derived in the linked display process repeated before. As described above, the initial position is set based on the reference position SP in the initial position setting process. Therefore, the terminal position deriving part 20d derives the relative position of the mobile communication terminal 3 to the reference position SP, based on the initial position set based on the reference position SP and the moved distance of the mobile communication terminal 3 on the wide-area map WM from the initial position (a step U37).

Next, the terminal-use map controller 20e sets as the terminal-use map M2 a region around the relative position on the wide-area map WM of the mobile communication terminal 3 to the reference position SP. Then, the terminal-use map controller 20e generates the terminal-use map M2 by clipping the set terminal-use map region R2 from the wide-area map WM (a step U38).

Next, the terminal-use map controller 20e controls the data communication part 28 to send the generated terminal-use map M2 to the mobile communication terminal 3 (a step U39). Thus, the terminal-use map controller 20e causes the terminal-use map M2 to be displayed on the mobile communication terminal 3.

The data communicating part 38 of the mobile communication terminal 3 receives the terminal-use map M2 sent from the vehicle-mounted apparatus 2 (a step U43). Once the data communicating part 38 receives the terminal-use map M2, the display controller 30c of the mobile communication terminal 3 controls the display 32 to display the terminal-use map M2 received from the vehicle-mounted apparatus 2 (a step U44). Thus, the mobile communication terminal 3 displays the terminal-use map M2 showing the region corresponding to the relative position to the reference position SP.

As described above, in the communication system 10, the mobile communication terminal 3 detects the motion of the mobile communication terminal 3 and sends to the vehicle-mounted apparatus 2 the sensor signal corresponding to the motion of the mobile communication terminal 3. The vehicle-mounted apparatus 2 receives the sensor signal from the mobile communication terminal 3 and performs a process corresponding to the motion of the mobile communication terminal 3, based on the sensor signal.

As described above, since the vehicle-mounted apparatus 2 performs the process corresponding to the motion of the mobile communication terminal 3, the user other than the main user (the driver) of the vehicle-mounted apparatus 2 can causes the vehicle-mounted apparatus 2 to perform a desired operation by moving the mobile communication terminal 3.

Moreover, the display 22 of the vehicle-mounted apparatus 2 displays the vehicle-use map M1 generated by clipping the region R1 including the current location from the wide-area map WM. In addition, the terminal position deriving part 20d of the vehicle-mounted apparatus 2 derives the relative position of the mobile communication terminal 3 to the reference position SP, based on the motion of the mobile communication terminal 3. Then, the terminal-use map controller 20e of the vehicle-mounted apparatus 2 generates the terminal-use map M2 by clipping, from the wide-area map WM, the terminal-use map region R2 corresponding to the relative position of the mobile communication terminal 3. The terminal-use map controller 20e sends the terminal-use map M2 to the mobile communication terminal 3 and causes the terminal-use map M2 to be displayed on the display 32 of the mobile communication terminal 3.

Therefore, different regions of the wide-area map WM are displayed on the vehicle-mounted apparatus 2 and the mobile communication terminal 3. The user can see the terminal-use map M2 that is a desired region of the wide-area map WM, on the display 32 of the mobile communication terminal 3 by moving the mobile communication terminal 3. Moreover, displaying of the terminal-use map M2 on the mobile communication terminal 3 has no influence on the vehicle-use map M1 on the vehicle-mounted apparatus 2.

Moreover, in the case where the ratio between the moved distance of the mobile communication terminal 3 and the scrolled distance of the map displayed on the mobile communication terminal 3 is set to a predetermined ratio, the user can see easily a destination, located even a long distance away from an area around the vehicle 9, by moving the mobile communication terminal 3 by a short distance.

### 12. Eleventh Embodiment

### 12-1. Outline

Next, an eleventh embodiment is explained. A configuration and processes of a communication system 10 in the eleventh embodiment are partially the same as the configuration and the processes of the communication system 10 in the tenth embodiment. Therefore, a difference from the tenth embodiment is mainly hereinafter explained.

As described above, in the 10th embodiment, the map is moved (scrolled) according to the moved distance of the mobile communication terminal 3 at the predetermined ratio. Thus, the user can see even a region a long distance away from the current location by moving the mobile communication terminal 3 by a shorter distance than an initially-set distance.

On the other hand, in the eleventh embodiment, a map is moved based on a distance specified by a user. In other words, the user specifies two spots on the map displayed on a vehicle-mounted apparatus 2 and then moves a mobile communication terminal 3 by a certain distance. After that, the map is moved by a distance between the two spots specified by the user. Then, the moved map is displayed on the mobile communication terminal 3. The distance between the two spots is a distance on a display 22 but not a distance at a scale of the map. Therefore, the largest value of the distance between the two spots is a distance between diagonal corners of the display 22. However, the distance between the two spots may be an actual distance based on a scale of the map.

For example, in a case where the distance between the two spots specified by the user is 10 cm and where a moved distance of the mobile communication terminal 3 corresponding to the distance between the two spots is 5 cm, the map is moved 10 cm on the display by moving the mobile communication terminal 3 only by 5 cm.

Thus, since the map is moved by the distance specified by the user, the user can see a desired region easily. Especially, as compared to the case where the map is moved by a distance at a predetermined ratio based on a correction value, the user can set a moved distance of the map visually. Therefore, the user can visually understand the moved distance of the map corresponding to the moved distance of the mobile communication terminal 3.

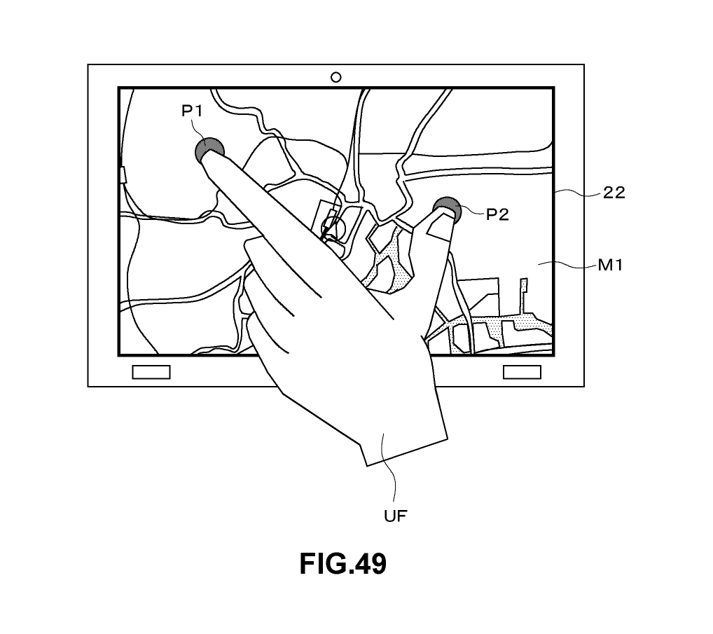

FIG. 49 illustrates a state where two spots are specified by the user on a vehicle-use map M1 displayed on the display 22 of the vehicle-mounted apparatus 2. The user specifies two spots P1 and P2 by touching a touch panel 22a of the vehicle-mounted apparatus 2 with fingers UF.

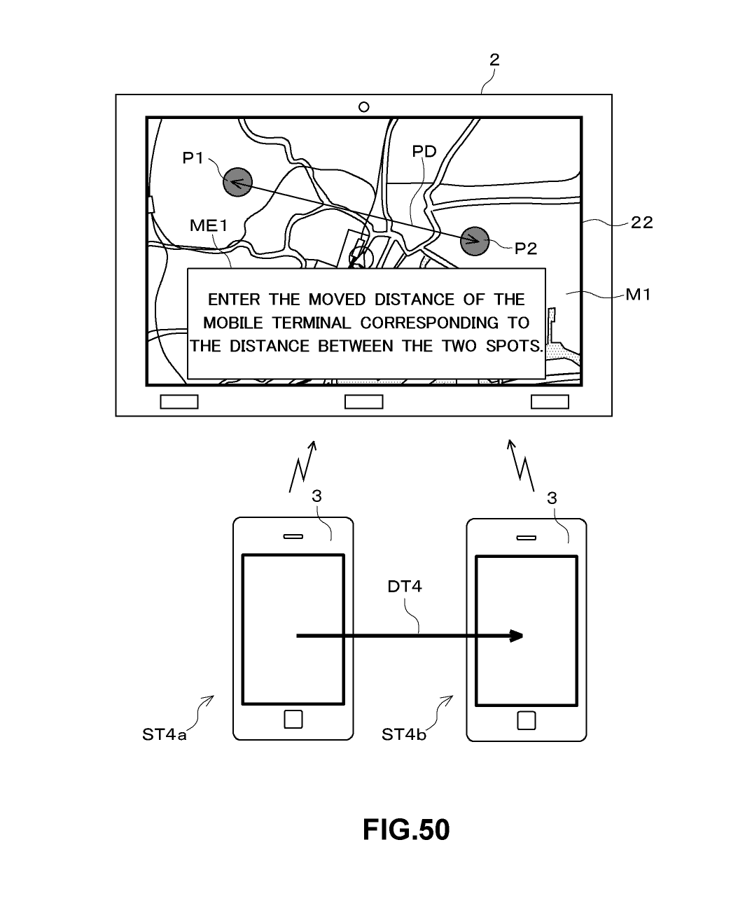

FIG. 50 illustrates a setting, by the user, of the moved distance of the mobile communication terminal 3 corresponding to a distance PD between the two spots P1 and P2 by moving the mobile communication terminal 3 by a certain distance after specifying the two spots P1 and P2. After the spots P1 and P2 are specified by the user, the vehicle-mounted apparatus 2 causes the display 22 to display a message ME1 to induce the user to set the moved distance of the mobile communication terminal 3 corresponding to the distance PD, by moving the mobile communication terminal 3. An example of the message ME1 is that “Enter the moved distance of the mobile terminal corresponding to the distance between the two spots.”

In a case where the user moves the mobile communication terminal 3 from a state ST4a to a state ST4b, the mobile communication terminal 3 moves by a distance DT4. By pressing a predetermined button on the mobile communication terminal 3 while moving the mobile communication terminal 3, the user can send to the vehicle-mounted apparatus 2 a signal representing that the mobile communication terminal 3 is being moved. In other words, a distance that the mobile communication terminal 3 is moved while the button is being pressed is sent to the vehicle-mounted apparatus 2 and is set as the moved distance DT4 of the mobile communication terminal 3, corresponding to the distance PD. However, the user may input a numerical value into the mobile communication terminal 3 with a touch panel 32a of the mobile communication terminal 3.

Once the distance PD between the two spots and the moved distance DT4 of the mobile communication terminal 3 are input, the vehicle-mounted apparatus 2 derives, based on the distances, the correction value that is used to calculate the distance to move the map by using an arithmetic expression (1) below.

Correction value=distance PD between two spots/moved distance DT4 (1)

In other words, in a case where the distance PD between the two spots is 10 cm and where the moved distance DT4 is 5 cm, the correction value is set to “2 (double).” Thus, in a case where the user moves the mobile communication terminal 3 by 5 cm, the map is moved double, i.e., 10 cm. In a case where the distance PD4 between the two spots is 5 cm and where the moved distance DT4 is 10 cm, the correction value is set to “0.5.” In this case where the user moves the mobile communication terminal 3 by 10 cm, the map is scrolled by 5 cm, a half of 10 cm. Thus, the user can see the map in detail.

### 12-2. Configuration

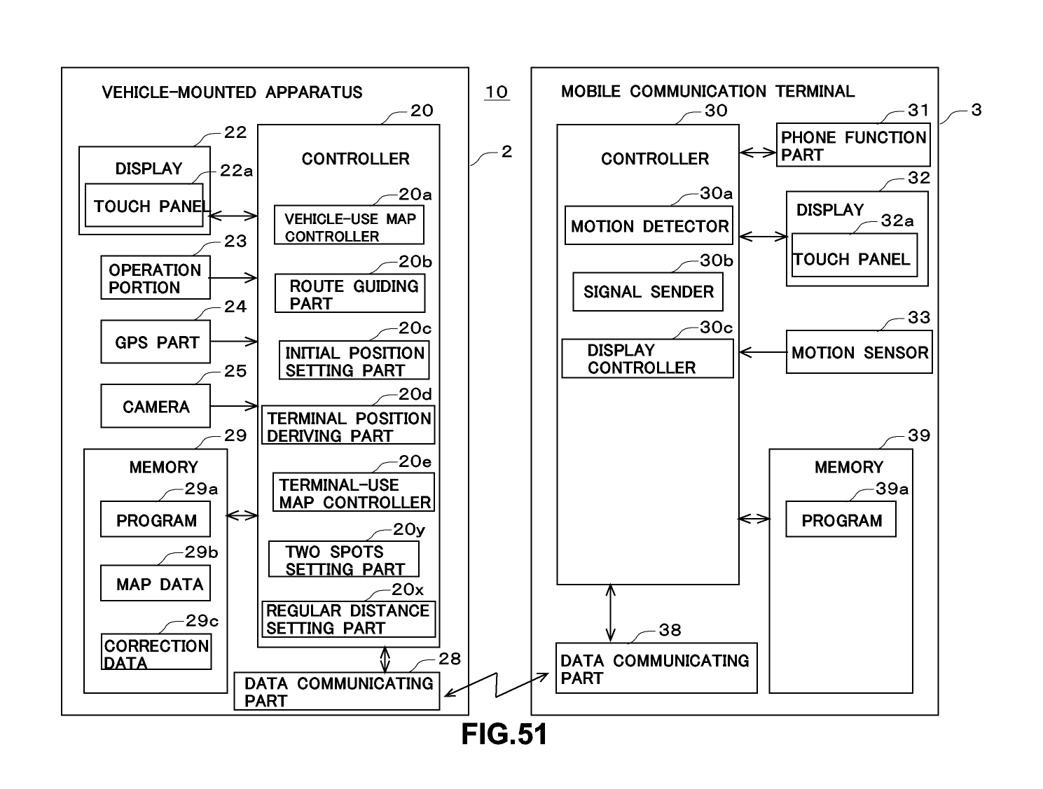

FIG. 51 illustrates the configuration of the communication system 10 in the eleventh embodiment. A controller 20 of the vehicle-mounted apparatus 2 includes a two spots setting part 20y and a regular distance setting part 20x.

In a case where the two spots on the touch panel 22a are touched, the two spots setting part 20y derives the distance between the touched two spots.

Once the user touches the two spots on the touch panel 22a, the regular distance setting part 20x derives the moved distance of the mobile communication terminal 3 as a regular distance corresponding to the distance between the two spots. The regular distance setting part 20x derives a distance of the mobile communication terminal 3 moved while the predetermined button of the vehicle-mounted apparatus 2 or the mobile communication terminal 3 is being pressed after the user touches the two spots on the touch panel 22a. Thus, the regular distance setting part 20x determines whether the user moves the mobile communication terminal 3 to move the map or the user moves the mobile communication terminal 3 to specify the regular distance corresponding to the distance between the two spots. A different determining method may be used as long as a start and an end of moving the mobile communication terminal 3 are clear to specify the regular distance.

Once setting the regular distance corresponding to the distance between the two spots, the regular distance setting part 20x derives the correction value for moving the map based on the arithmetic expression (1). Then, the regular distance setting part 20x stores the derived correction value in a memory 29 as correction data 29c.

### 12-3. Process

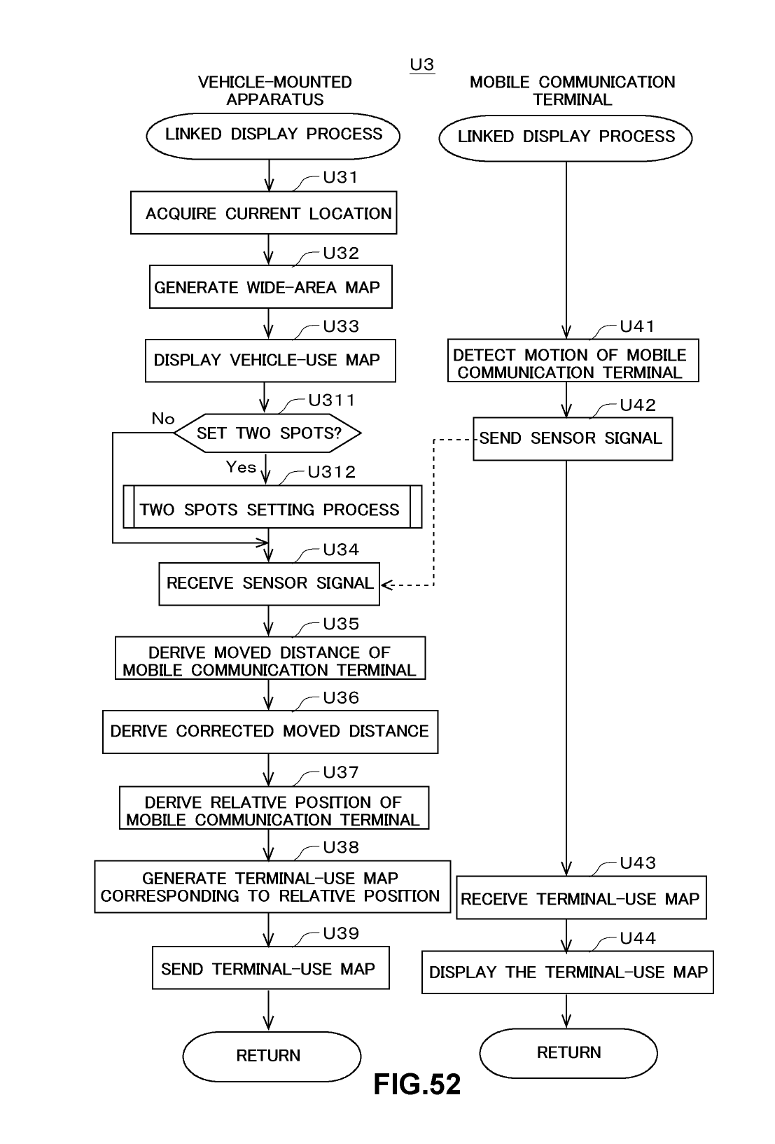

FIG. 52 illustrates a flow of a linked display operation (the step U3 in FIG. 46) performed in the eleventh embodiment. Once the step U33 is performed, the two spots setting part 20y determines whether or not to set the two spots on the map, i.e., to set the regular distance that corresponds to the distance between the two spots and that is defined by the moved distance of the mobile communication terminal 3 (a step U311). The vehicle-mounted apparatus 2 causes a message to be displayed on the display 22 to induce the user to make a determination about the setting, and the user may input whether or not to set the two spots, with the touch panel 22a.

In a case where the two spots setting part 20y determines that the user does not set the two spots (No in the step U311), a step U34 is performed.

On the other hand, the two spots setting part 20y determines that the user sets the two spots (Yes in the step U311), a step U312 is performed.

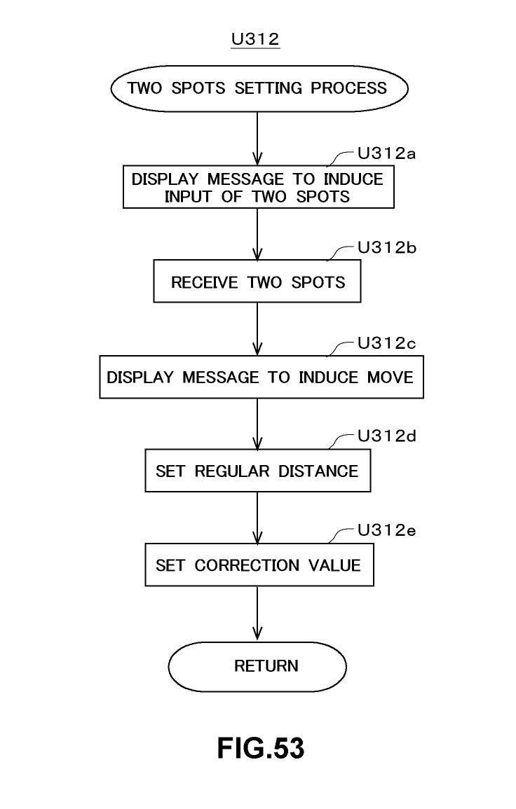

FIG. 53 illustrates a flow in the step U312. First, the two spots setting part 20y causes a message to be displayed on the display 22 to induce the user to input the two spot on the displayed map (a step U312a). An example of the message is that “Touch two points on the screen.”

Once the two spots setting part 20y causes the message to be displayed, the touch panel 22a receives a touch input by the user (a step U312b) and derives positions of the touched two spots on the display 22 and then sends the distance between the touched two spots to the controller 20.

Once the touch panel 22a receives the touch input by the user, the regular distance setting part 20x causes a message to be displayed on the display 22 to induce the user to set the regular distance that corresponds to the distance between the two spots and that is defined by the moved distance of the mobile communication terminal 3 (a step U312c). After seeing the message, the user moves the mobile communication terminal 3 in hand by a desired distance.

Once receiving a sensor signal from the mobile communication terminal 3, the regular distance setting part 20x derives the moved distance of the mobile communication terminal 3 and sets the derived distance as the regular distance (a step U312d).

Once setting the regular distance, the regular distance setting part 20x derives the correction value based on the foregoing arithmetic expression (1) and stores the derived correction value in the memory 29 (a step U312e).

Once the step U312e is performed, the process moves back to the flow in FIG. 52 and the step U34 and the subsequent steps are performed.

As mentioned above, once the user specifies the two spots on the map displayed on the vehicle-mounted apparatus 2 and then moves the mobile communication terminal 3 by the regular distance, the map is moved by the distance between the specified two spots. Then the moved map is displayed on the mobile communication terminal 3.

In other words, after the regular distance that is the moved distance of the mobile communication terminal 3 is associated with the distance between the two spots on the map specified by the user, if the mobile communication terminal 3 is moved by the regular distance, the map is moved by the distance between the two spots and is displayed on the mobile communication terminal 3. Moreover, the map is moved by a distance based on a ratio between the distance between the two spots and the regular distance, and the moved map is displayed on the mobile communication terminal 3.

Thus, the user can move the map based on the distance specified by the user on the map and can cause a desired region of the map to be displayed easily. Especially, by setting the distance between the two spots on the map shorter than the regular distance of the mobile communication terminal 3, when the user sees a region a long distance away from the current location, the user can move the mobile communication terminal 3 less, and thus convenience is improved. Moreover, by specifying the two spots on the map, the user can understand the specified distance visibly so that the user instinctively understands the specified distance. In this case, as compared to inputting of the distance in a numerical value, incorrect input can be prevented.

### 13. Twelfth Embodiment

### 13-1. Outline

Next, a twelfth embodiment is explained. A configuration and processes of a communication system 10 in the twelfth embodiment are partially the same as the configuration and the processes of the communication system 10 in the 10th embodiment. Therefore, a difference from the tenth embodiment is mainly hereinafter explained.

As described above, in the 10th embodiment, the map is moved according to the moved distance of the mobile communication terminal 3 at the predetermined ratio. Thus, the user can see even a region a long distance away from the current location by moving the mobile communication terminal 3 by a shorter distance than an initially-set distance.

On the other hand, in the twelfth embodiment, a map is moved based on a selection distance that is a distance on a map selected by a user. In other words, the user selects a desired distance on the map and the selected distance (selection distance) is associated with a regular distance by which a mobile communication terminal 3 is moved. Thus, when the mobile communication terminal 3 is moved by the regular distance, the map is moved by the selection distance. Then, the moved map is displayed on the mobile communication terminal 3. The selection distance is a distance at a scale of the map, not a distance on a display. Therefore, a numerical value, such as 5 km and 10 km, is selected as the selection distance.

For example, in a case where the user selects 5 km as the selection distance and where a moved distance of the mobile communication terminal 3 associated with the selection distance is 30 cm, the user can move the map by a distance equivalent to 5 km on the map, by moving the mobile communication terminal 3 by 30 cm. Even if a scale of the map is changed, the selection distance is 5 km. Therefore, in a case where the map displayed on a vehicle-mounted apparatus 2 is zoomed in (close-up map), a moved distance of the map on the mobile communication terminal 3 seems greater. On the other hand, in a case where the map displayed on the vehicle-mounted apparatus 2 is zoomed out (long-shot map), a moved distance of the map on the mobile communication terminal 3 seems smaller.

Thus, the user moves the map by the distance selected on the map and causes a desired region to be displayed easily. Especially, since the user has a concrete idea about the distance by which the map is moved by moving the mobile communication terminal 3, the user can see the desired region smoothly.

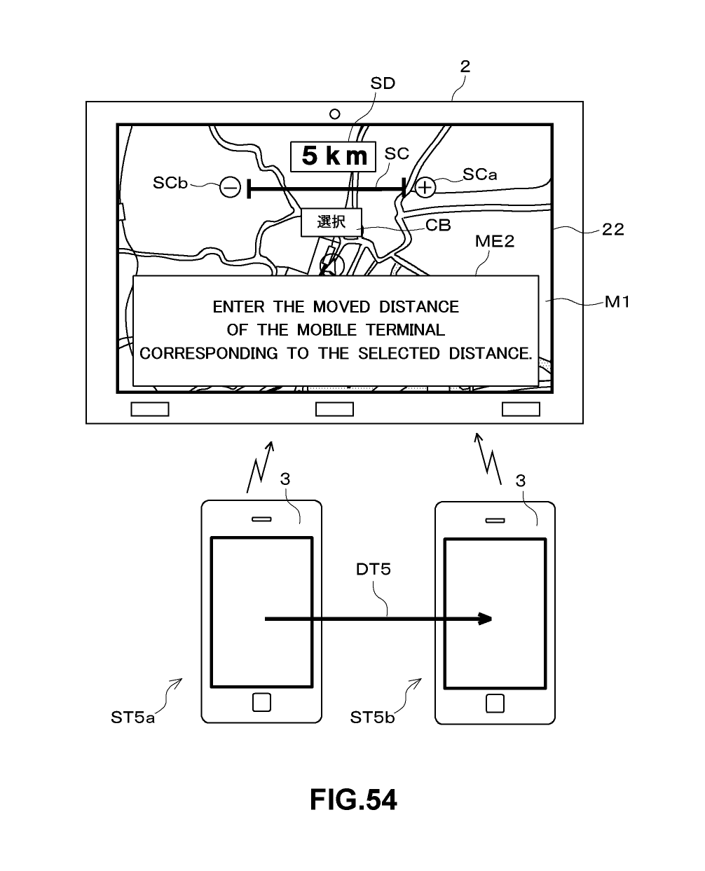

FIG. 54 illustrates setting of a regular distance DT 5 of the mobile communication terminal 3 by moving the mobile communication terminal 3. The regular distance DT5 corresponds to a selection distance SD selected on the vehicle-use map M1.

The vehicle-mounted apparatus 2 causes a scale SC to be displayed on the display 22. The scale SC indicates the selection distance SD for selection by the user. The user operates an increase button SCa and/or a decrease button SCb such that the selection distance SD is a desired distance, and then the user presses a select button CB.

Once the user determines the selection distance SD, the vehicle-mounted apparatus 2 causes a message ME2 to be displayed on the display 22 to induce the user to set the moved distance of the mobile communication terminal 3 corresponding to the selection distance SD, by moving the mobile communication terminal 3. An example of the message ME2 is that “Enter the moved distance of the mobile terminal corresponding to the selected distance.”

In a case where the user moves the mobile communication terminal 3 from a state ST5a to a state ST5b, the mobile communication terminal 3 moves by a moved distance DT5. Once the selection distance SD and the moved distance DT5 of the mobile communication terminal 3 are input, the vehicle-mounted apparatus 2 derives, based on the distances, the correction value that is used to calculate a distance to move the map by using an arithmetic expression (2) below.

Correction value=selection distance SD/moved distance DT5 (2)

In other words, in a case where the selection distance SD is 5 km and where the moved distance DT5 is 50 cm, the correction value is set to “10,000 (times).” Thus, in a case where the user moves the mobile communication terminal 3 by 50 cm, the map is moved by a distance equivalent to 5 km that is 10,000 times of 50 cm. On the other hand, also, in a case where the selection distance SD is smaller than the moved distance DT5, a correction value is derived by using the arithmetic expression (2) above. It is possible to calculate, but it is not practical because the map is moved to show only a vicinity of the current location and the moved distance is very small.

### 13-2. Configuration

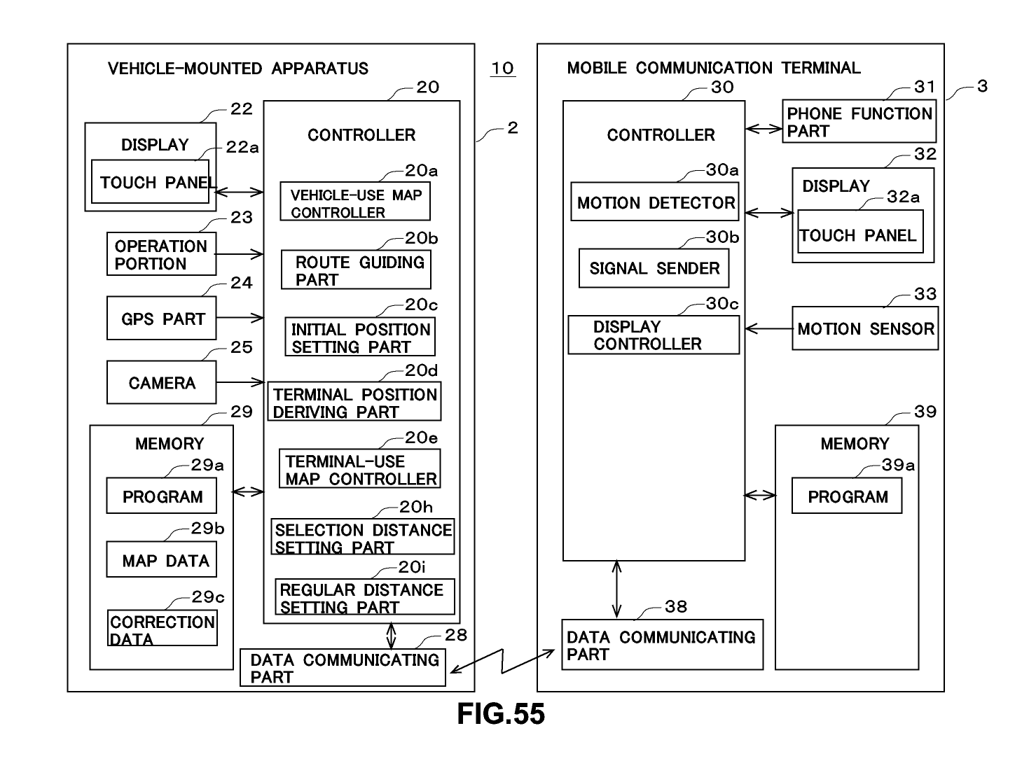

FIG. 55 illustrates the configuration of the communication system 10 in the twelfth embodiment. A controller 20 of the vehicle-mounted apparatus 2 includes a selection distance setting part 20h and a regular distance setting part 20i.

The selection distance setting part 20h sets the moved distance of the map corresponding to the moved distance of the mobile communication terminal 3. The selection distance setting part 20h sets a distance selected by a user operation with a touch panel 22a, as the selection distance.

Once the user selects the selection distance, the regular distance setting part 20i derives the moved distance of the mobile communication terminal 3 as the regular distance corresponding to the selection distance. The method of deriving the regular distance used in the eleventh embodiment is also used in this twelfth embodiment.

Once setting the regular distance corresponding to the selection distance, the regular distance setting part 20i derives, based on the arithmetic expression (2) above, the correction value that is used to move the map. The regular distance setting part 20i stores the derived correction value in a memory 29 as correction data 29c.

### 13-3. Process

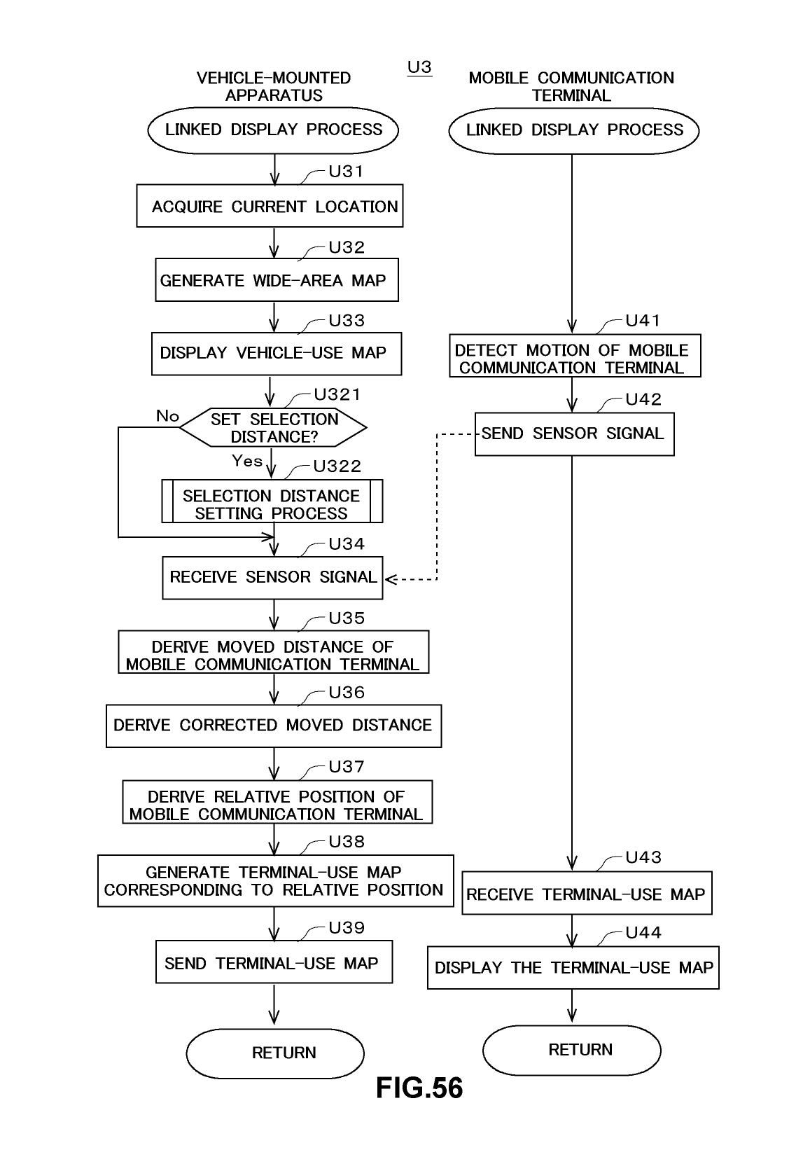

FIG. 56 illustrates a flow of a linked display operation (the step U3 in FIG. 46) performed in the twelfth embodiment. Once the step U33 is performed, the selection distance setting part 20h determines whether or not to set the selection distance, i.e., to set the regular distance that corresponds to the distance selected by the user on the map and that is defined by the moved distance of the mobile communication terminal 3 (a step U321). The vehicle-mounted apparatus 2 causes a message to be displayed on the display 22 to induce the user to make a determination about the setting, and the user may input whether or not to set the selection distance, with the touch panel 22a.

In a case where the selection distance setting part 20h determines that the user does not set the selection distance (No in the step U321), a step U34 is performed.

On the other hand, in a case where the selection distance setting part 20h determines that the user sets the selection distance (Yes in the step U321), a step U322 is performed.

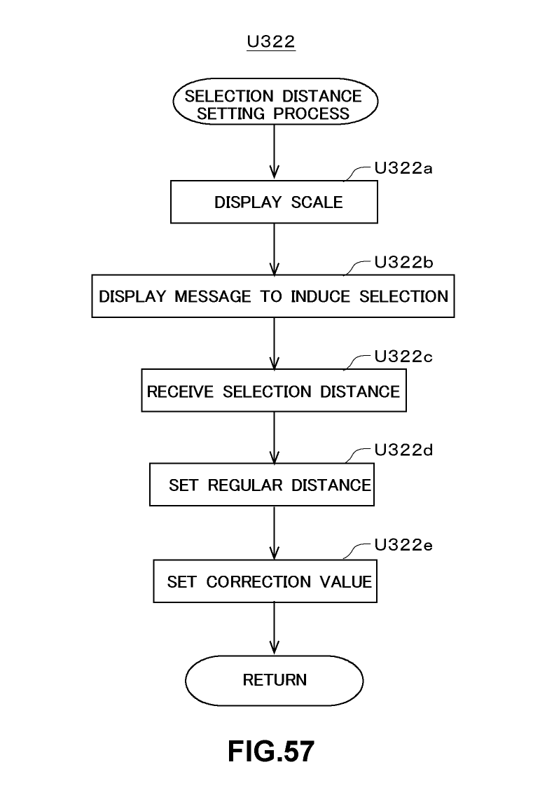

FIG. 57 illustrates a detailed flow of the step U322. First, the selection distance setting part 20h causes the scale indicating a distance on the map to be displayed on the display 22 (a step U322a). A numerical value representing the distance on the map is added to the scale. The user can increase and/or decrease the distance on the map for the selection distance, seeing the scale.

Once the scale is displayed, the selection distance setting part 20h causes a message to be displayed on the display 22 to induce the user to select the distance (a step U322b). After seeing the message, the user sets the scale to a desired distance and presses the select button CB on the touch panel 22a.

Once the user presses the select button CB, the selection distance setting part 20h receives the distance indicated by the scale as the selection distance (a step U322c). The selection distance setting part 20h stores the received selection distance in a memory of the controller 20. The selection distance may be also stored to the memory 29 in addition to the memory of the controller 20. In this case, the selection distance may be retrieved from the memory 29 and may be used at a time of a next start of the vehicle-mounted apparatus 2.

Once the selection distance setting part 20h receives the selection distance, the regular distance setting part 20i causes a message to be displayed on the display 22 to induce the user to set the regular distance that corresponds to the selection distance and that is defined by the moved distance of the mobile communication terminal 3. After seeing the message, the user moves the mobile communication terminal 3 in hand by a desired distance.

Once receiving a sensor signal from the mobile communication terminal 3, the regular distance setting part 20i derives the moved distance of the mobile communication terminal 3 and sets the derived distance as the regular distance (a step U322d).

Once setting the regular distance, the regular distance setting part 20i derives the correction value based on the foregoing arithmetic expression (2) and stores the derived correction value in the memory 29 (a step U322e).

Once the step U322e is performed, the process moves back to the flow in FIG. 56 and the step U34 and the subsequent steps are performed.

As mentioned above, in the twelfth embodiment, the selection distance selected on the map is associated with the regular moved distance of the mobile communication terminal 3. When the mobile communication terminal 3 moves by the regular distance, the map is moved by the selection distance. Moreover, the map is moved at a ratio between the selection distance and the regular distance and is displayed on the mobile communication terminal 3.

Thus, the user can cause a desired region long distance away from the current distance to be displayed easily on the mobile communication terminal 3. Especially, since the user selects the selection distance, the user has a concrete idea about the distance that the map is moved by moving the mobile communication terminal 3 and the user can see the desired region smoothly.

### 14. Thirteenth Embodiment

### 14-1. Outline

Next, a thirteenth embodiment is explained. A configuration and processes of a communication system 10 in the thirteenth embodiment are partially the same as the configuration and the processes of the communication system 10 in the tenth embodiment. Therefore, a difference from the tenth embodiment is mainly hereinafter explained.

As for the communication system 10 in the tenth embodiment, the display range of the map is fixed to the wide-area map WM.

On the other hand, as for the communication system 10 in the thirteenth embodiment, a display range of the map is determined by a user operation and then the display range is associated with a moved distance of the mobile communication terminal 3. Thus, a user can see a desired range of a wide-area map WM, by moving the mobile communication terminal 3 by a desired distance.

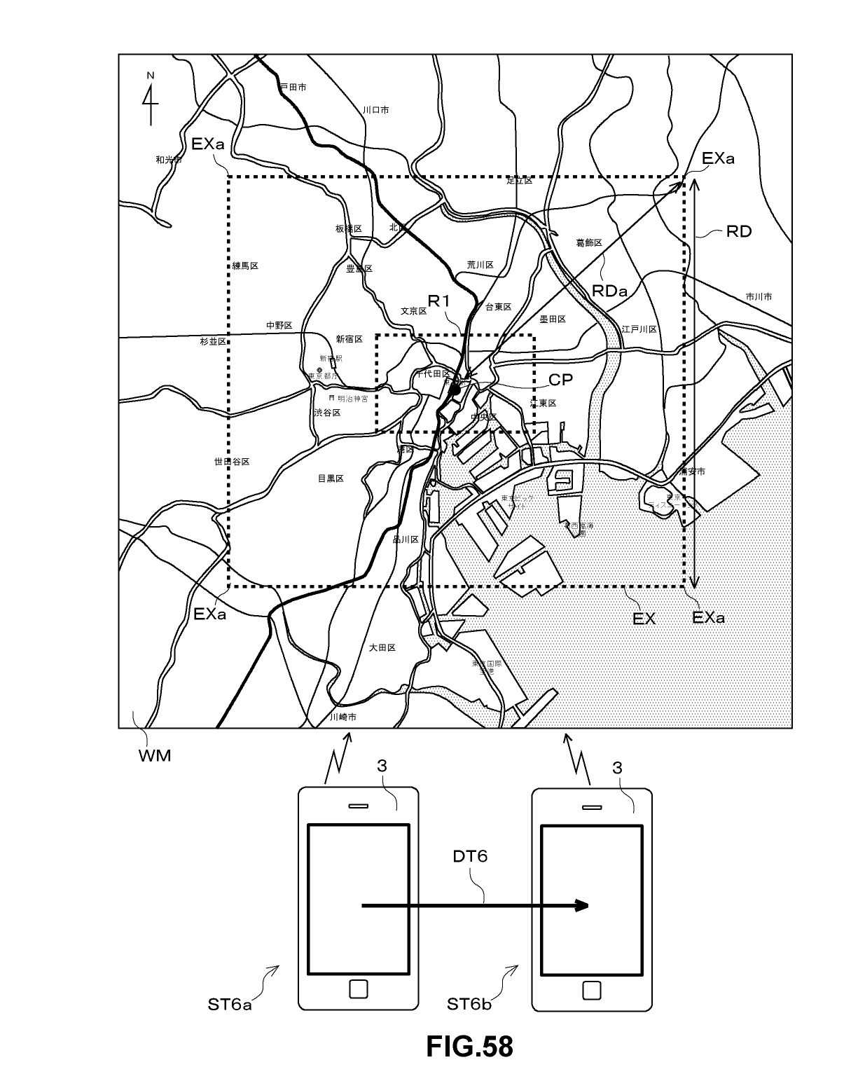

FIG. 58 illustrates a display range EX of a map determined by a user operation, a distance RDa from a center position of the display range EX to a position EXa that is a furthest position from the center position, and a regular distance DT6 of the mobile communication terminal 3.

The user inputs a numerical value with a touch panel 22a, etc., as a distance RD that is a length on one side of the desired display range. For example, the numerical value is 20 km. Once the user inputs the distance RD, the vehicle-mounted apparatus 2 sets a square display range, 20 km on a side, on the wide-area map WM such that a current location is in a center of the display range.

The regular distance DT6 from a state ST5a to a state ST5b is the moved distance of the mobile communication terminal 3 and is associated with the distance RDa from the center position of the display range EX to the furthest position EXa from the center position.

Therefore, after the display range EX is set, if the mobile communication terminal 3 is moved by the regular distance DT6, the map displayed on the mobile communication terminal 3 is moved by a distance equivalent to the distance RDa.

The moved distance of the map by moving the mobile communication terminal 3 is derived based on a ratio between the regular distance DT6 and a distance from the furthest position EXa to the center position CP of the display range EX. For example, in a case where the distance to the position EXa is 10 km and where the regular distance DT6 is 50 cm, the ratio thereof is 20,000:1. Therefore, the mobile communication terminal 3 is moved by 10 cm, the map is moved by a distance equivalent to 2 km, 20 thousand times of 10 cm, and the moved map is displayed. The ratio is derived as a correction value based on an arithmetic expression (3) below.

Correction value=distance RDa/regular distance DT6 (3)

Thus, a user can see the desired range of the wide-area map WM based on the desired moved distance of the mobile communication terminal 3.

After the regular distance is set, the distance RD that is the one side of the display range may be input and then the distance RDa may be associated with the regular distance DT6.

### 14-2. Configuration

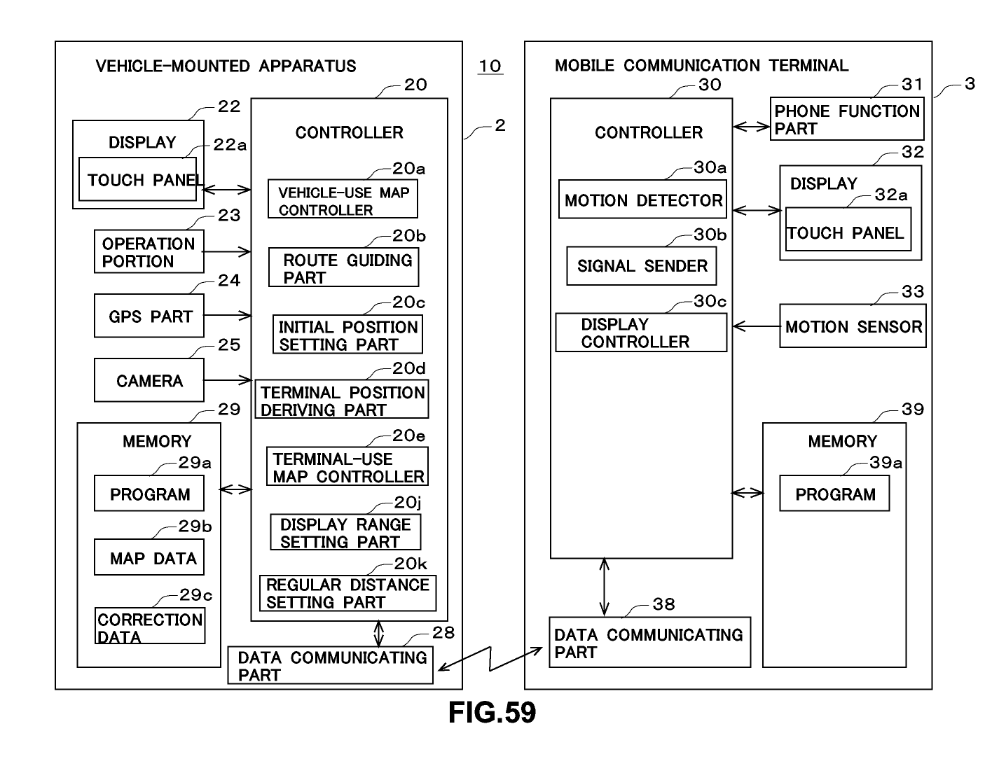

FIG. 59 illustrates the configuration of the communication system 10 in the thirteenth embodiment. A controller 20 of the vehicle-mounted apparatus 2 includes a display range setting part 20j and a regular distance setting part 20k.

Once the user inputs the distance that is the one side of the display range, the display range setting part 20j sets the square display range of which the one side has the input distance, in the wide-area map WM such that the current location is in the center of the display range. Moreover, the regular distance set by the regular distance setting part 20k, described later, is associated with the distance from the center position of the display range to a furthest position from the center position.

Once the display range is determined, the regular distance setting part 20k derives the moved distance of the mobile communication terminal 3 as the regular distance. The method of deriving the regular distance used in the eleventh embodiment is also used in this thirteenth embodiment.

### 14-3. Process

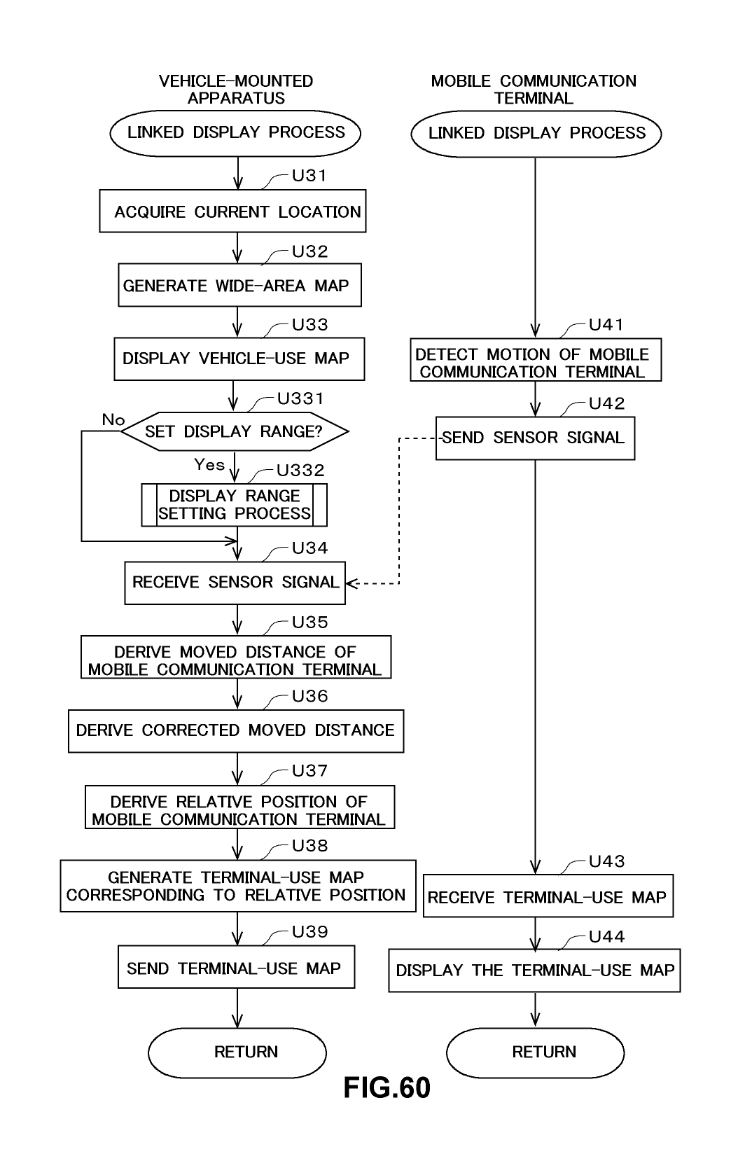

FIG. 60 illustrates a flow of a linked display operation (the step U3 in FIG. 46) performed in the thirteenth embodiment. Once the step U33 is performed, the display range setting part 20j determines whether or not to set the desired display range of the user on the wide-area map WM (a step U331). The vehicle-mounted apparatus 2 determines based on whether or not, for example, the user operates a predetermined button.

In a case where the display range setting part 20j determines that the user does not set the display range (No in the step U331), a step U34 is performed.

On the other hand, in a case where the display range setting part 20j determines that the user sets the display range (Yes in the step U331), a step U332 is performed.

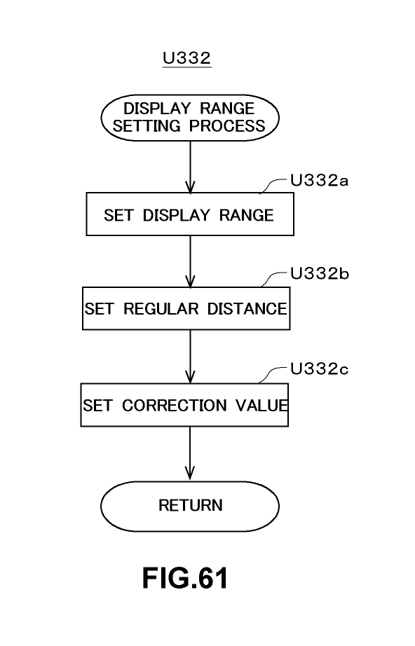

FIG. 61 illustrates a detailed flow of the step U332.

First, once receiving an input of the distance by the user, the display range setting part 20j sets the display range on the wide-area map WM (a step U332a).

Next, the regular distance setting part 20k derives the moved distance of the mobile communication terminal 3 and sets the derived moved distance as the regular distance (a step U332b).

The display range setting part 20j derives the correction value based on the foregoing arithmetic expression (3) and stores the derived correction value in a memory 29 (a step U332c).

Once the step U332c is performed, the process moves back to the process in FIG. 60 and the step U34 and the subsequent steps are performed.

As described above, in the thirteenth embodiment, the display range of the map is determined by the user operation and then the display range is associated with the moved distance of the mobile communication terminal 3. Thus, the user can see the desired range of the wide-area map WM based on the moved distance of the mobile communication terminal 3.

### 15. Fourteenth Embodiment

### 15-1. Outline

Next, a fourteenth embodiment is explained. A configuration and processes of a communication system 10 in the fourteenth embodiment are partially the same as the configuration and the processes of the communication system 10 in the tenth embodiment. Therefore, a difference from the tenth embodiment is mainly hereinafter explained.

In the foregoing tenth embodiment, after being moved by a distance derived by multiplying the moved distance of the mobile communication terminal 3 based on the predetermined ratio, the map is displayed on the mobile communication terminal 3. In a case where the ratio at which the map is moved is small and where the region that the user desires to see is a long distance away from the current location, the user has to move the mobile communication terminal 3 by a long distance to see the desired region. If the desired region is beyond a range that the user can move the mobile communication terminal 3, the user has to change the ratio at which the map is moved, to see the desired region. That may be less convenient.

On the other hand, in the fourteenth embodiment, a regular distance from a center position of the user to a limit position that the user can reach is associated with a distance from a center of the map that is a current location to a predetermined position, such as a destination.

Thus, a display range of the map is a circle of which a radius is the distance from the current location to the predetermined position. Within reach of the user, the user can see a desired region in the circular display range including the predetermined position, such as a destination.

The distance from the center of the user to the limit position that the user can reach may not be necessarily associated, as the regular distance of the user, with the distance of the radius of the circular display range. A distance from the center to any point within the reach of the user may be set as the regular distance.

The distance of the radius (hereinafter referred to as “radius distance”) of the circular display range may be set by using a numerical value, such as 10 km and 100 km. A numerical value is also used to set the regular distance. For example, in a case where the regular distance is the distance to the limit position of the reach of the user, a value of some ten centimeters, i.e., a length of an arm of the user is used.

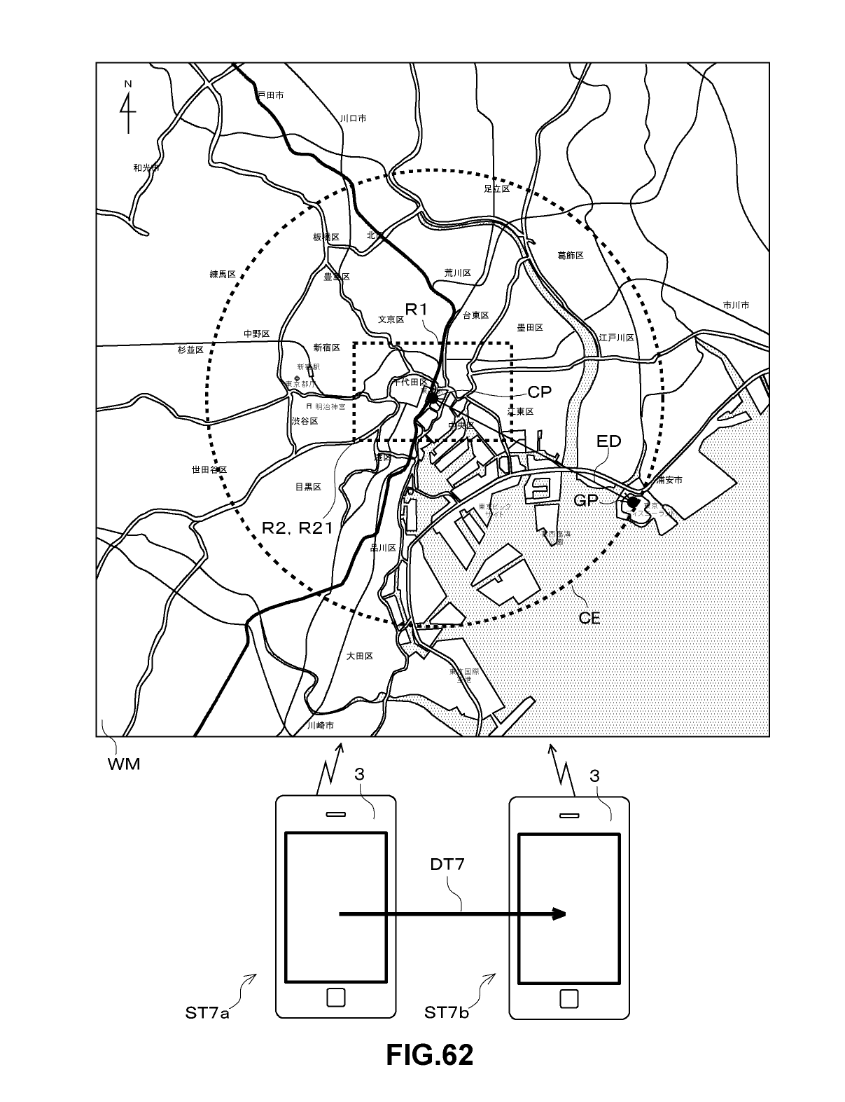

FIG. 62 illustrates a circular display range CE set on a wide-area map WM. The display range CE includes the current location and a destination GP.

A radius distance ED of the circular display range CE is associated with a regular distance DT7 that is the distance from the center position of the user to the limit position of the reach of the user or to a predetermined position within the reach.

A position ST7a of the mobile communication terminal 3 is in the center of the user. A position ST7b of the mobile communication terminal 3 is the limited position of the reach of the user or the predetermined position. The radius distance ED is associated with the regular distance DT7 from the position ST7a to the position ST7b that is the moved distance of the mobile communication terminal 3.

Therefore, after the circular display range CE is set, in a case where the mobile communication terminal 3 is moved by the moved distance DT7, the map displayed on the mobile communication terminal 3 is moved by the radius distance ED and is displayed. Moreover, in a case where the mobile communication terminal 3 is moved by a half of the distance on the wide-area map WM, the map on the mobile communication terminal 3 is also moved by a half of the regular distance DT7. Moreover, the moved distance of the map moved by moving the mobile communication terminal 3 is derived based on a ratio between the radius distance ED and the regular distance DT7. For example, in a case where the radius distance ED is 10 km and where the regular distance DT7 is 50 cm, the ratio between the radius distance ED and the regular distance DT7 is 20,000:1. Therefore, in a case where the mobile communication terminal 3 is moved by 10 cm, the map is moved by a distance equivalent to 2 km that is 20 thousand times of 10 cm. The ratio is derived as a correction value, based on an arithmetic expression (4) below.

Correction value=radius distance ED/regular distance DT7 (4)

Moreover, the user may input a distance from the current location to determine the radius distance ED. In other words, the distance from the current location to the touched desired spot may be set as the radius distance ED by a touch of the user on a desired spot on the map. In a case where the user does not input the distance, a distance from the current location to a destination may be set as the radius distance ED. The destination is a predetermined spot, such as home of the user.

Thus, the user can see the desired region within the circular display range CE of which the radius is the distance from the current location to the desired spot, such as the destination, by moving the mobile communication terminal 3 within the reach of an arm holding the mobile communication terminal 3 of the user. Therefore, even if the desired spot that the user desires to see, such as the destination, is located a long distance away from the current location, the user can see the desired spot on the map by moving the mobile communication terminal 3 within the reach of the user.

### 15-2. Configuration

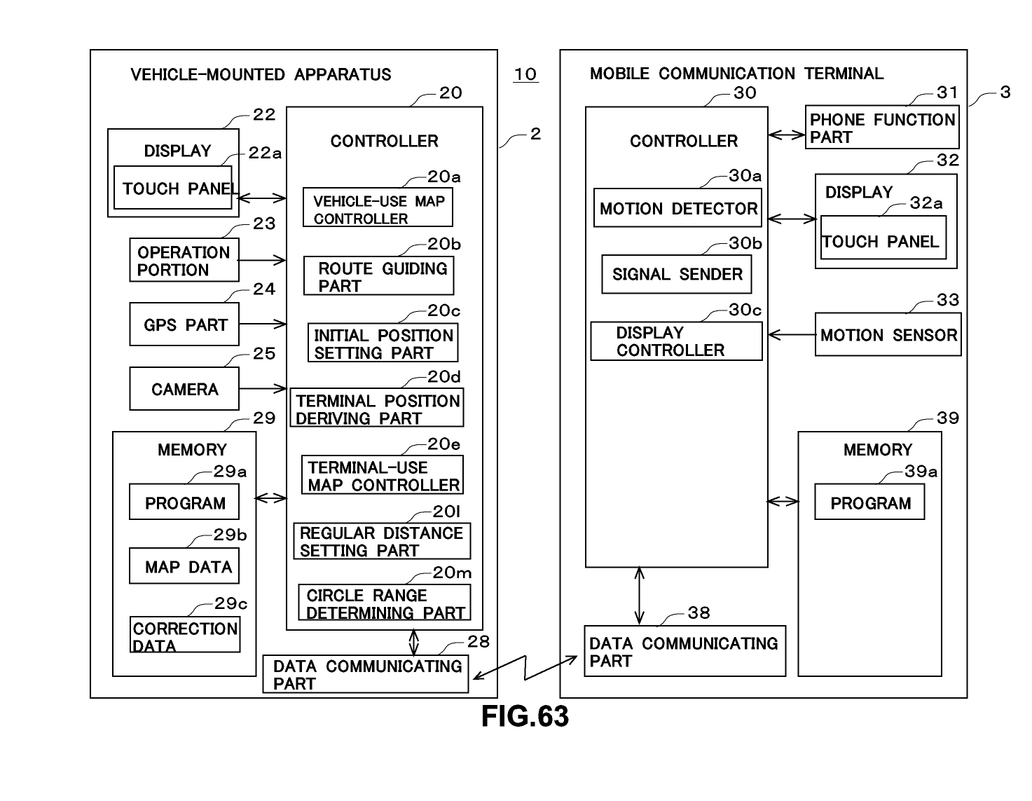

FIG. 63 illustrates the configuration of the communication system 10 in the fourteenth embodiment. A controller 20 of a vehicle-mounted apparatus 2 includes a regular distance setting part 201 and a circular range determining part 20m.

Once the user selects the selection distance, the regular distance setting part 201 derives the moved distance of the mobile communication terminal 3 as the regular distance corresponding to the selection distance. The method of deriving the regular distance used in the eleventh embodiment is also used in this fourteenth embodiment.

Once the user inputs a predetermined spot on the map, the circular range determining part 20m: derives the distance (radius distance) from the current location to the predetermined spot; sets the circular range such that the current location is in the center position of the circular range of which the radius distance is the distance from the current location to the predetermined spot; and sets the circular range as the display range of a map on the mobile communication terminal 3.

Moreover, the circular range determining part 20m associates the regular distance derived by the regular distance setting part 201 with the radius distance. In other words, the regular distance setting part 201 derives, based on the arithmetic expression (4) above, the correction value that is used to move the map. The regular distance setting part 20i stores the derived correction value in a memory 29 as correction data 29c.

### 15-3. Process

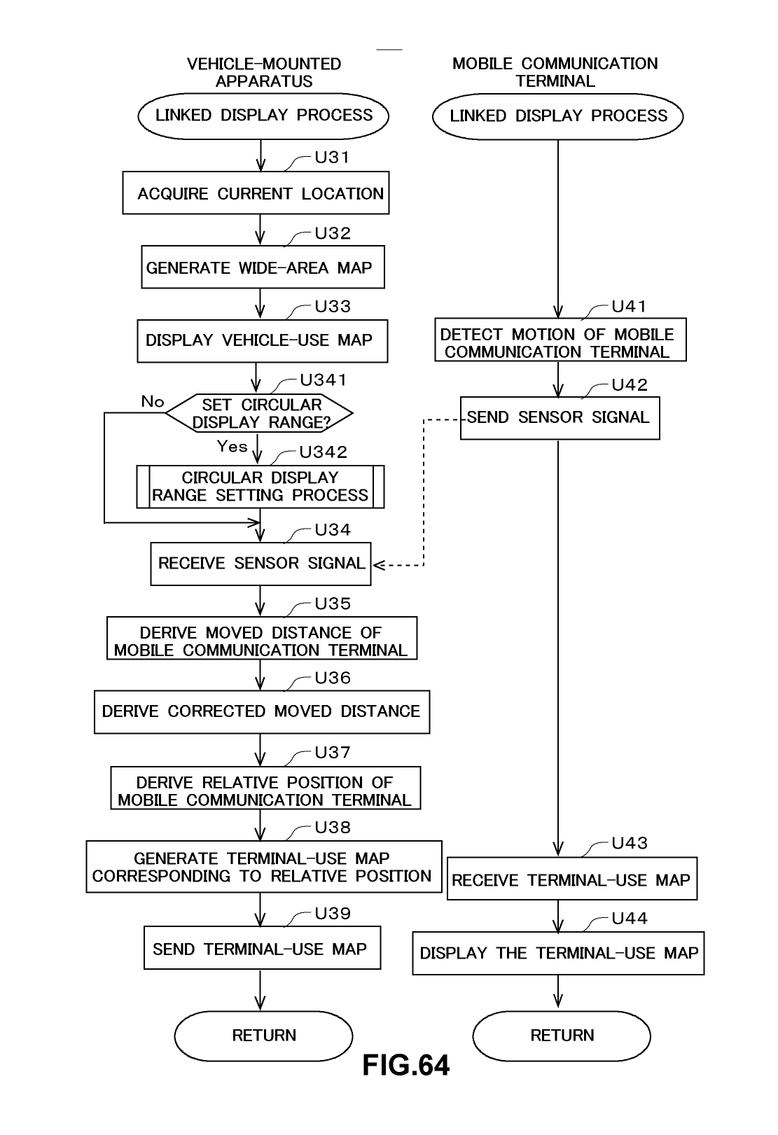

FIG. 64 illustrates a flow of a linked display operation (the step U3 in FIG. 46) performed in the fourteenth embodiment. Once the step U33 is performed, the circular range determining part 20m determines whether or not to set the circular display range on the wide-area map WM (a step U341). The vehicle-mounted apparatus 2 causes a message to be displayed on a display 22 to induce the user to make a determination about the setting, and the user may input whether or not to set the circular display range, with a touch panel 22a. Moreover, the circular display range may be set immediately by a user operation with a predetermined button and the like.

In a case where the circular range determining part 20m determines that the user does not set the circular display range (No in the step U341), a step U34 is performed.

On the other hand, in a case where the circular range determining part 20m determines that the user sets the circular display range (Yes in the step U341), a step U342 is performed.

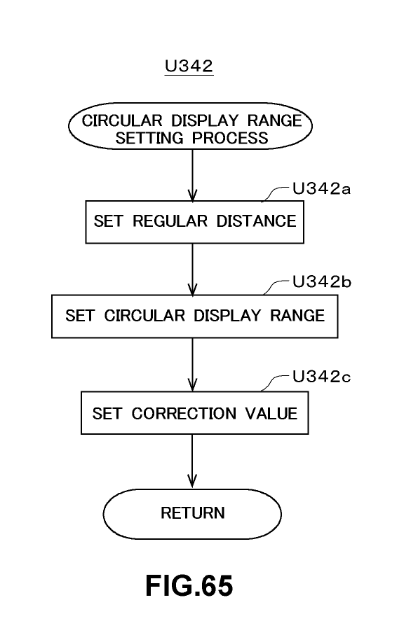

FIG. 65 illustrates a detailed flow of the step U342. First, the regular distance setting part 201 derives the moved distance of the mobile communication terminal 3 and sets the derived moved distance as the regular distance (a step U342a). In order to set the moved distance of the mobile communication terminal 3, the user moves the mobile communication terminal 3 from the center of the user to the limit position of the reach of the user.

Once the regular distance setting part 201 sets the regular distance, the circular range determining part 20m sets the circular display range on the wide-area map WM (a step U342b). In other words, the circular range determining part 20m sets the circular display range such that the current location is in the center position of the circular range of which the radius distance is the distance from the current location to the predetermined spot. In a case where there is an input operation by the user, the radius distance may be a distance from the current location to the spot specified by the user.

Once setting the circular display range, the circular range determining part 20m derives the correction value based on the foregoing arithmetic expression (4) and stores the derived correction value to the memory 29 (a step U342c).

Once the step U342c is performed, the process moves back to the flow in FIG. 64 and the step U34 and the subsequent steps are performed.

As described above, in the fourteenth embodiment, based on the regular distance to the limit position of the reach of the user or to the predetermined spot, the circular range is set such that the current location is in the center position of the circular range of which the radius distance is the distance from the current location to the predetermined spot. Moreover, the regular distance is associated with the distance to be defined as the radius of the circular display range. Thus, the user can see the desired region within the display range of which the radius is the distance from the current location to the desired spot, such as the destination, by moving the mobile communication terminal 3 within the reach of the arm holding the mobile communication terminal 3 of the user. Therefore, even if the desired spot that the user desires to see, such as the destination, is located a long distance away from the current location, the user can see the desired spot on the map by moving the mobile communication terminal 3 within the reach of the user.

### 16. Fifteenth Embodiment

Next, a fifteenth embodiment is explained. A configuration and processes of a communication system 10 in the fifteenth embodiment are partially the same as the configuration and the processes of the communication system 10 in the tenth embodiment. Therefore, a difference from the tenth embodiment is mainly hereinafter explained.

In the foregoing eleventh to the fourteenth embodiments, the regular distance (DT4 to DT7) that is the moved distance of the mobile communication terminal 3 is used as a fixed value after an input of the moved distance by the user.

On the other hand, in the fifteenth embodiment, after being set, the regular distance (DT4 to DT7) is changeable.

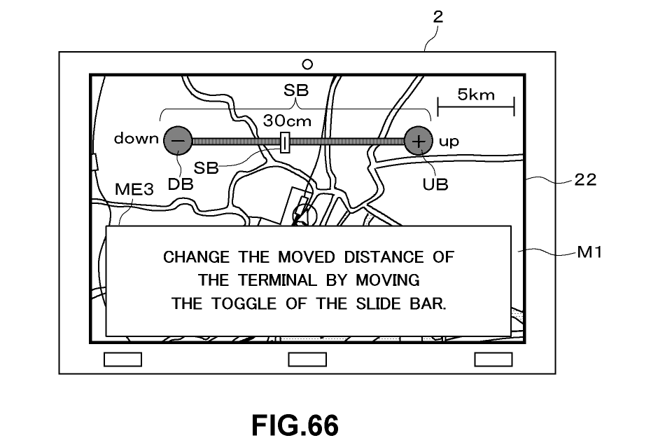

FIG. 66 illustrates changing of a regular distance that is a moved distance of a mobile communication terminal 3, after an input of the regular distance by a user.

A numerical value representing a length of the regular distance currently set is displayed on a display 22 in addition to a slide bar SB, an increase button UB and a decrease button DB. The numerical value representing the length of the regular distance is increased and decreased by an operation with a toggle of the slide bar SB, the increase button UB and the decrease button DB.

Moreover, a message ME3 is displayed to induce the user to change the regular distance. An example of the message ME3 is that “Change the moved distance of the terminal by moving the toggle of the slide bar.”

The user sees the numerical value representing the length of the regular distance currently set and then inputs a desired distance by operating the slide bar SB, the increase button UB and the decrease button DB on a touch panel 22a.

A controller 20 of a vehicle-mounted apparatus 2 changes (rewrites and stores) the numerical value of the regular distance stored in a memory, based on the operation by the user with the increase button UB and the like.

Moreover, “ratio,” “distance between the two spots,” “distance of the display range” and “radius distance of the circular display range” may also be changeable. In that case, values thereof may be changed by an operation with the slide bar SB, the increase button UB and the decrease button DB, as shown in FIG. 66.

As described above, in the fifteenth embodiment of the invention, the regular distance that is the moved distance of the mobile communication terminal 3 is changeable after an input of the moved distance by the user. Thus, in a case where the user desires to change the regular distance, the user does not have to move the mobile communication terminal 3 again. Therefore, the convenience is improved.

### 17. Sixteenth Embodiment

Next, a sixteenth embodiment is explained. The sixteenth embodiment explains a linked wide-area display function of linking display on a vehicle-mounted apparatus 2 and display on a mobile communication terminal 3 to each other by the display on the mobile communication terminal 3 based on a position of the mobile communication terminal 3. By using the function of linking the display on the vehicle-mounted apparatus 2 and the display on the mobile communication terminal 3 to each other, a spot on a map on the mobile communication terminal 3 can be set as a destination on the vehicle-mounted apparatus 2 from the mobile communication terminal 3.

Moreover, at a time of setting the destination, an image for a mark for setting the destination is transferred to the vehicle-mounted apparatus 2 from a position on the map of the mobile communication terminal 3. In other words, when the destination on the vehicle-mounted apparatus 2 is set after the setting of the destination is requested via the mobile communication terminal 3, the image that is used for the mark of the destination is transferred from a current location (a center of a screen of the vehicle-mounted apparatus 2) to the destination, and the transferred image is displayed on the vehicle-mounted apparatus 2. The map is scrolled along with move of the mark. A speed of the moving mark may be changeable based on a set moving speed of the mobile communication terminal 3 or a set moving speed (scrolling speed) of the map on the mobile communication terminal 3. Moreover, an arrow is recommended for the image for the mark because the mark moves to a predetermined position as the destination.

Thus, the display showing the current location on the vehicle-mounted apparatus 2 is scrolled until the display shows the destination requested to be set via the mobile communication terminal 3. A viewer of the vehicle-mounted apparatus 2 can easily understand a direction and a distance of the set destination from the current location.

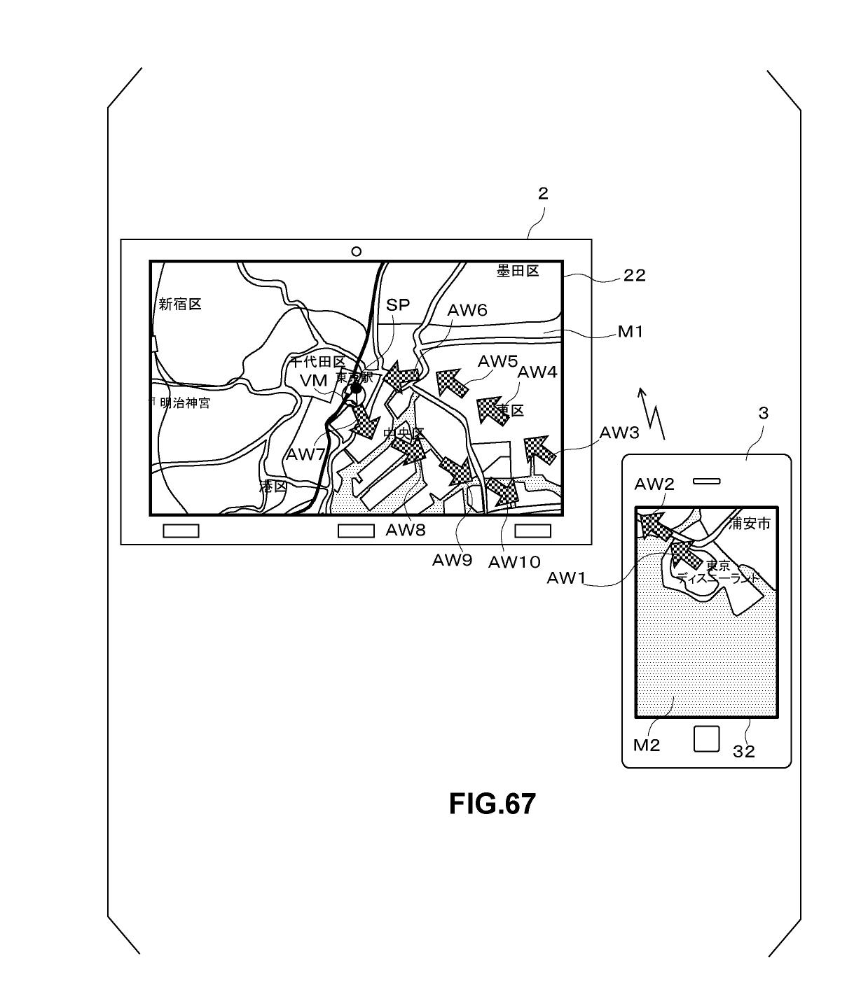

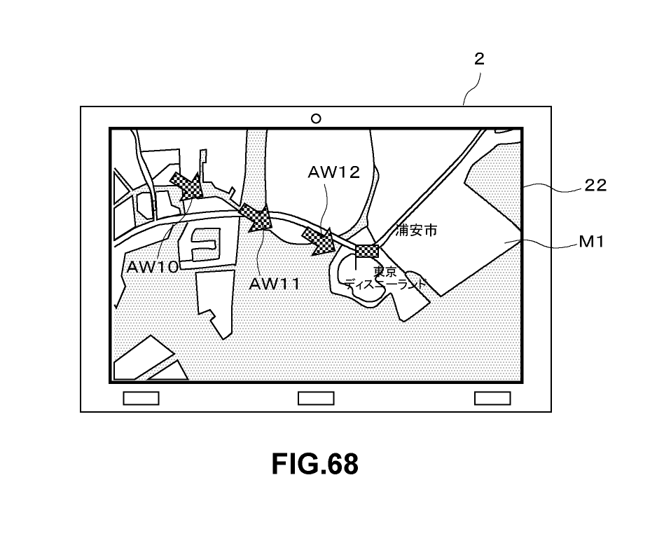

FIG. 67 and FIG. 68 illustrate traveling of an arrow AW1 to an arrow AW12 from the mobile communication terminal 3 to the vehicle-mounted apparatus 2. Each of those arrows represents a position of the destination set via the mobile communication terminal 3. For easy explanation of the traveling and display of the arrow AW1 to the arrow AW12, those arrows are numbered in a time series.

First, the setting of the destination is requested via the mobile communication terminal 3. The arrow AW1 moving in a direction of the current location from the position of the destination displayed on the mobile communication terminal 3 is displayed (the arrow AW1 to the arrow AW2 in FIG. 67).

Once entering a display range on the vehicle-mounted apparatus 2, the arrow moves to the current location (the arrow AW3 to the arrow AW6 in FIG. 67). Then, when arriving near the current location, the arrow moves back to the destination (the arrow AW7 to the arrow AW10 in FIG. 67). During the traveling of the arrows, the display on the vehicle-mounted apparatus 2 is scrolled such that the arrow is in the center of the display. When the arrow arrives at the destination, the destination is set as a destination of a route guidance (the arrow SW10 to the AW12 in FIG. 68).

As described above, since the display on the vehicle-mounted apparatus 2 showing the current location is scrolled until the destination requested via the mobile communication terminal 3 is displayed, the viewer of the vehicle-mounted apparatus 2 can easily understand the direction and the distance of the set destination from the current location.

### 18. Seventeenth Embodiment

Next, a seventeenth embodiment is explained. In the seventeenth embodiment, in a case where plural mobile communication terminals 3 are used, a moving speed is set by each of the plural mobile communication terminals 3. Moreover, a destination and the like are transferred between the plural mobile communication terminals 3 in addition to between a vehicle-mounted apparatus 2 and the mobile communication terminal 3. In this case, the information is transferred only to one or more mobile terminals 3 that are allowed to receive the information.

It is recommended that in a case where the destination is set by the plural mobile communication terminals 3, an arrow and the like should be displayed in manners (1) to (5) below.

(1) An arrow is displayed and moves from a direction in which a sender of destination information is located in a cabin of a vehicle. In this case, the sender of the destination information can be identified easily.

(2) A face picture of the sender of the destination information is attached to the arrow. Instead of the face picture, an illustration or an image of a mascot, etc. may be used. In this case, the sender of the destination information can be visually identified.

(3) A color of the arrow is changed for each sender of the destination information. In this case, the sender of the destination information can be identified based on the color.

(4) Effective sound is produced for each sender of the destination information. Turning-on, turning-off, sound tone, etc. may be changed for each sender. In this case, the sender of the destination information can be audibly identified.

(5) A shape of the arrow may be changed for each type of setting, such as a destination. For example, an arrow, a musical note, a moving image icon and a telephone (mail) mark are displayed for position information, music information, moving image information and address information, respectively. In this case, types of the transferred information can be identified visually.

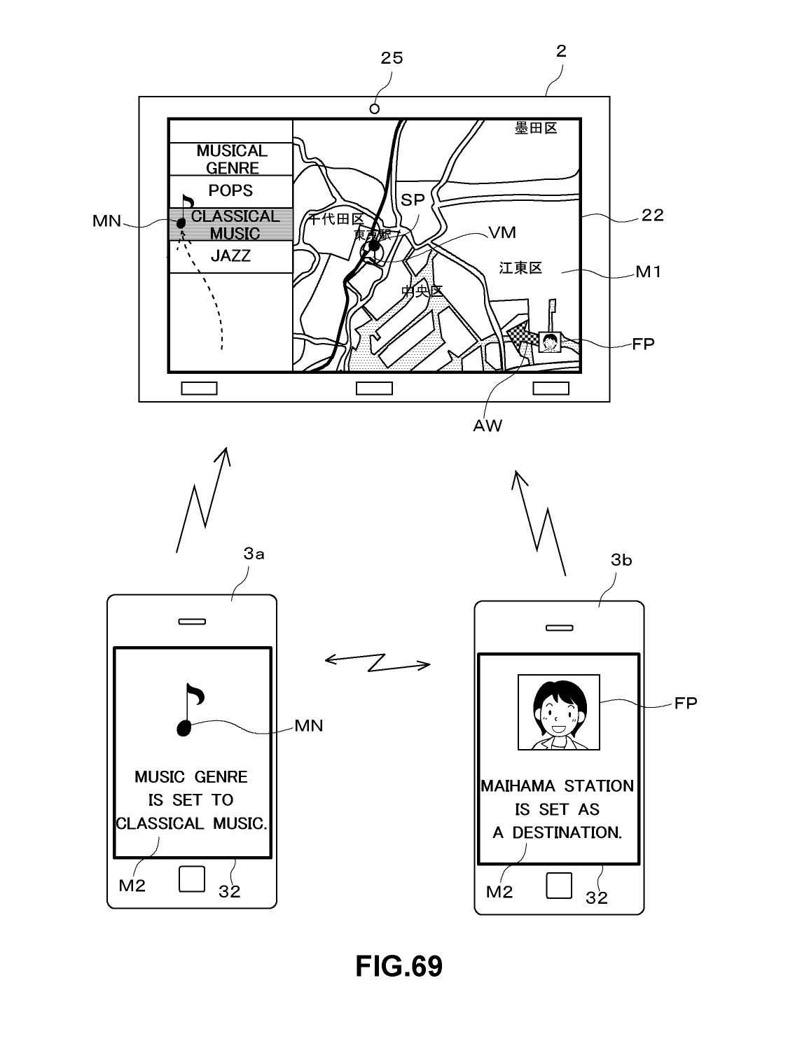

FIG. 69 illustrates information transferred from the plural mobile communication terminals 3 to the vehicle-mounted apparatus 2.

In a case where a user of a mobile communication terminal 3a in a left side seat in the vehicle gives a command to set musical genre to classical music, a musical note MN moves from a left lower side of a display 22 of the vehicle-mounted apparatus 2 and arrives in a portion corresponding to classical music on a music genre screen. Thus, a viewer of the vehicle-mounted apparatus 2 can understand that the user in the left side seat in the vehicle has given the command to set musical genre to classical music.

In a case where a user of a mobile communication terminal 3b in a right side seat in the vehicle gives a command to set a destination, a face picture FP of the user of the mobile communication terminal 3b, in addition to an arrow AW, moves from the destination to the current location on the display 22 of the vehicle-mounted apparatus 2. Thus, the viewer of the vehicle-mounted apparatus 2 can understand that the user of the mobile communication terminal 3b has given the command to set the destination.

### 19. Modifications of Tenth Embodiment to Seventeenth Embodiment

The tenth to the seventeenth embodiment are explained above. However, various modifications of the tenth to the seventeenth embodiments are possible. Such modifications are hereinafter explained. Any of all forms including the foregoing tenth to the seventeenth embodiments and modifications below can be combined with another appropriately.

In the tenth to the seventeenth embodiments, the map is moved at the predetermined speed. However, by an operation with an acceleration button and/or a slowing-down button provided to the mobile communication terminal 3, the map may be moved at a set speed only during the operation. For example, the map may be moved twice as fast as the predetermined speed. A user may freely set the set speed with a touch panel and the like.

Moreover, the moved speed of the map may be increased based on a moved distance of the mobile communication terminal 3. For example, in a case where the mobile communication terminal 3 is moved by 0 cm to 10 cm from a current location, the map is set to be moved at the same speed as the predetermined speed, and in a case where the mobile communication terminal 3 is moved by 10 cm to 20 cm from the current location, the map is set to be moved twice as fast as the predetermined speed. The set speed may be reset to one time by a predetermined operation with the mobile communication terminal 3.

Moreover, the moved speed of the map may be increased based on a moved speed of the mobile communication terminal 3. In this case, the correction data 29c may be updated based on the moved speed of the mobile communication terminal 3.

Moreover, an operation with the vehicle-mounted apparatus 2, such as setting of a destination, is not allowed during driving a vehicle. However, the operation may be performed with the mobile communication terminal 3. Therefore, it is possible to move a displayed image, such as a map, by moving the mobile communication terminal 3 (the moving speed of the image is the set speed). Moreover, it is possible to set a destination via the mobile communication terminal 3. However, an arrow and the like are not displayed on the vehicle-mounted apparatus 2 in a dynamic display in which the arrow and the like are moving, but a destination is statically set and displayed (only switching of displayed maps, etc.). Thus, a driver can comply with driving regulations, such as a setting of a destination, relating to the vehicle-mounted apparatus 2.

Further, information other than setting of a destination may be sent and received between the vehicle-mounted apparatus 2 and the mobile communication terminal 3. Examples of the information are a music file, a moving image file, a music list, a moving image list and a music cover image. Further, educational data may be sent from the mobile communication terminal 3 to the vehicle-mounted apparatus 2 and the sent educational data may be read out by the vehicle-mounted apparatus 2. Further, news and a mail may be sent as text data for read-out from the mobile communication terminal 3 to the vehicle-mounted apparatus 2 and the data may be read out by the vehicle-mounted apparatus 2. Further, address information may be sent from the mobile communication terminal 3 to the vehicle-mounted apparatus 2 and a telephone call may be made via the vehicle-mounted apparatus 2. Further, a cash voucher or a coupon may be sent from the mobile communication terminal 3 to the vehicle-mounted apparatus 2 and the sent cash voucher or the sent coupon may be used for payment of an application and a content bought via the vehicle-mounted apparatus 2. Further, a content and a license bought via the mobile communication terminal 3 may be sent to the vehicle-mounted apparatus 2 (in this case, the bought content, license, etc. is paid via the mobile communication terminal 3).

Further, in the foregoing tenth to seventeenth embodiments, an electronic apparatus for the liked operation with the mobile communication terminal 3 is the vehicle-mounted apparatus 2. However, the electronic apparatus may be a different apparatus, such as a television set and a personal computer, that is used at home or in office.

In the foregoing tenth to seventeenth embodiments, the motion sensor 33 detects the motion of the mobile communication terminal 3. However, the motion of the mobile communication terminal 3 may be detected by using a different method, such as an optical flow method. For example, in a case of the optical flow method, by extracting characteristic points from each of plural captured images (frames) captured by a camera included in the mobile communication terminal 3, the motion of the mobile communication terminal 3 can be detected based on a direction of an optical flow representing movement of the characteristic points in the plural captured images.

Further, in the foregoing tenth to seventeenth embodiments, the map center CP on the map placed in the center position of the screen of the display 22 of the vehicle-mounted apparatus 2 is defined as the current location where the vehicle 9 is currently located. On the other hand, the map center CP may be changed from the current position to a different position by a user operation with the vehicle-mounted apparatus 2. In a case, like this, where the map center CP is changed to a different position from the current location, the changed map center CP may be used as the reference position for setting the terminal-use map region R2 to be displayed as the terminal-use map M2, instead of the current location. In addition, the user may choose either of the map center CP and the current position as a reference position for setting the terminal-use map region R2.

Further, in the foregoing tenth to seventeenth embodiments, the content to be displayed is a map. However, the displayed content may be any content, such as an image, a web page and an electronic program guide (EPG), as long as a region of the content is displayed on the screen and the other region of the content is displayed by scrolling the content. For example, in a case where an EPG is the content to be displayed, generally, a region including programs broadcasted in a time period including a current time (region including currently broadcasted programs) is mainly displayed on the screen from the EPG and the remaining region of the EPG for the other time period are scrolled to be displayed. Therefore, in this case, while the region of the EPG showing the programs broadcasted in the time period including the current time is displayed on the vehicle-mounted apparatus 2, the user can cause a region of the EPG showing a desired different time period to be displayed on the screen of the mobile communication terminal 3.

Further, the communication system in the foregoing tenth to seventeenth embodiments may receive a user operation with the mobile communication terminal 3 as an operation relating to a content displayed on the mobile communication terminal 3. Thus, operability by the user operation can be improved. For example, in the communication system including a navigation function, in a case where a user operation to specify a location is performed while the terminal-use map M2 is being displayed on the mobile communication terminal 3, the communication system may register a point (institution) on the terminal-use map M2 specified by the user as a registered point (registered institution). Moreover, for example, in a communication system including a digital TV reception function, in a case where a user operation to select a program is performed while an electronic program guide is being displayed on the mobile communication terminal 3, the communication system may cause the program selected by the user to be displayed or reserved (receiving reservation or recording reservation). In such a case, the communication system may identify the point or the program selected by the user based on a region of the content displayed on the mobile communication terminal 3 and a position of the user operation performed with a touch panel 32a.

Further, in the foregoing tenth to seventeenth embodiments, a position of the mobile communication terminal 3, i.e., in a portrait position or a landscape position, is not considered. However, the terminal-use map region R2 displayed as the terminal-use map M2 may be set in consideration of the position.

Further, in the foregoing first to seventeenth embodiments, the scale of the terminal-use map M2 displayed on the mobile communication terminal 3 is the same as the scale of the vehicle-use map M1 displayed on the vehicle-mounted apparatus 2. However, the scale of the terminal-use map M2 may be changed by the user to be a different scale from the scale of the vehicle-use map M1.

Further, in the foregoing tenth to seventeenth embodiments, the motion (position) of the mobile communication terminal 3 is detected by the camera 25 of the vehicle-mounted apparatus 2 and by the motion sensor 33 of the mobile communication terminal 3. However, images of the mobile communication terminal 3 are captured by a camera (anti-theft camera or driver/passenger monitoring camera) provided in a cabin of a vehicle and the motion (position) of the mobile communication terminal 3 may be detected by using the captured images acquired by capturing the images of the mobile communication terminal 3.

Further, in the foregoing tenth to seventeenth embodiments, the terminal-use map region R2 is clipped from the wide-area map WM by the vehicle-mounted apparatus 2. However, the mobile communication terminal 3 may clip the terminal-use map region R2 from the wide-area map WM. In this case, the vehicle-mounted apparatus 2 may send the wide-area map WM to the mobile communication terminal 3 beforehand.

In the aforementioned embodiment, the various functions are implemented by software by the CPU executing the arithmetic processing in accordance with the program. However, a part of the functions may be implemented by an electrical hardware circuit.

While the invention has been shown and described in detail, the foregoing description is in all aspects illustrative and not restrictive. It is therefore understood that numerous other modifications and variations can be devised without departing from the scope of the invention.

What is claimed is:

1. An electronic system that includes a mobile communication terminal and an electronic apparatus configured to communicate with the mobile communication terminal, the electronic system comprising:
a display controller that causes display, on a screen of the mobile communication terminal, of an image corresponding to a position of the mobile communication terminal on a virtual wide-area image that is a virtual image wider than a display range of the electronic apparatus;
a detector that detects a positional relationship between a displayed image on the electronic apparatus and a displayed image on the mobile communication terminal; and
a generator that generates a position indicating image that shows the positional relationship between the displayed image on the electronic apparatus and the displayed image on the mobile communication terminal, wherein
the display controller also causes display of the position indicating image on the screen of the mobile communication terminal.

2. A mobile communication terminal configured to communicate with an electronic apparatus, the mobile communication terminal comprising:
a display controller that causes display, on a screen of the mobile communication terminal, of an image corresponding to a position of the mobile communication terminal on a virtual wide-area image that is a virtual image wider than a display range of the electronic apparatus,
the display controller also causing display, on the screen of the mobile communication terminal, of an image that shows a positional relationship between a displayed image on the electronic apparatus and a displayed image on the mobile communication terminal.

3. The mobile communication terminal according to claim 2, wherein
the display controller causes display of the image that shows the positional relationship, as an image on which a positional relationship between the electronic apparatus and the mobile communication terminal is similar to a size of the mobile communication terminal.

4. An electronic apparatus configured to communicate with a mobile communication terminal, the electronic apparatus comprising:
a display controller that causes a first image to be displayed on a screen of the mobile communication terminal, the first image corresponding to a position of the mobile communication terminal on a virtual wide-area image that is a virtual image wider than a display range of the electronic apparatus,
the display controller also causing a second image to be displayed on the screen of the mobile communication terminal, the second image showing a positional relationship between a displayed image on the electronic apparatus and the displayed first image on the mobile communication terminal.

5. The electronic apparatus according to claim 4, wherein
the virtual wide-area image is a map image and shows a positional relationship among the displayed image on the electronic apparatus, the displayed first image on the mobile communication terminal and a destination of a route guidance.

6. A non-transitory computer-readable recording medium that stores a program to be executed by a computer in an electronic apparatus configured to communicate with a mobile communication terminal, the program causing the computer to execute the steps of:
(a) displaying, on a screen of the mobile communication terminal, an image corresponding to a position of the mobile communication terminal on a virtual wide-area image that is a virtual image wider than a display range of the electronic apparatus;
(b) detecting a positional relationship between a displayed image on a screen of the electronic apparatus and the displayed image on the mobile communication terminal;
(c) generating a position indicating image that shows the positional relationship between the displayed image on the electronic apparatus and the displayed image on the mobile communication terminal; and
(d) displaying the position indicating image on at least one of the screen of the mobile communication terminal and the screen of the electronic apparatus.

7. An electronic system that includes a mobile communication terminal and an electronic apparatus configured to communicate with the mobile communication terminal, the electronic system comprising:
an apparatus display that is provided to the electronic apparatus and that displays a first region that is a part of a to-be-displayed image larger than a displayable size of the apparatus display;
a terminal display that is provided to the mobile communication terminal and that displays a second region that is a part of the to-be-displayed image corresponding to a relative position of the mobile communication terminal to the electronic apparatus; and
a position displaying controller that causes a position indicating image to be displayed on at least one of the apparatus display and the terminal display, the position indicating image showing a positional relationship between the first region and the second region on the to-be-displayed image.

8. A mobile communication terminal configured to communicate with an electronic apparatus that includes an apparatus display that displays a first region that is a part of a to-be-displayed image larger than a displayable size of the apparatus display, the mobile communication terminal comprising:
a terminal display that displays a second region that is a part of the to-be-displayed image corresponding to a relative position of the mobile communication terminal to the electronic apparatus; and
a position displaying controller that causes a position indicating image to be displayed on the terminal display, the position indicating image showing a positional relationship between the first region and the second region on the to-be-displayed image.

9. The mobile communication terminal according to claim 8, wherein
the position indicating image shows the positional relationship by using a mark similar to a screen of the apparatus display and a mark similar to a screen of the terminal display.

10. An electronic apparatus configured to communicate with a mobile communication terminal, the electronic apparatus comprising:
an apparatus display that displays a first region that is a part of a to-be-displayed image larger than a displayable size of the apparatus display; and
a display controller that causes a second region to be displayed on the mobile communication terminal, the second region being a part of the to-be-displayed image corresponding to a relative position of the mobile communication terminal to the electronic apparatus,
the display controller also causing a position indicating image to be displayed on the mobile communication terminal, the position indicating image showing a positional relationship between the first region and the second region on the to-be-displayed image.

11. The electronic apparatus according to claim 10, wherein
the to-be-displayed image is a map image that includes a guiding route to a destination and
the position indicating image shows a positional relationship among the first region, the second region and the destination.

12. The electronic apparatus according to claim 10, wherein
a figure that is formed by connecting the first region, the second region and a position of the destination on the to-be-displayed image is similar to a figure that is formed by connecting a mark representing the first region, a mark representing the second region and a mark representing the destination on the position indicating image.

13. A non-transitory computer-readable recording medium that stores a program to be executed by a computer in an electronic apparatus configured to communicate with a mobile communication terminal, the program causing the computer to execute the steps of:
(a) causing a first region to be displayed on an apparatus display of the electronic apparatus, the first region being a part of a to-be-displayed image larger than a displayable size of the apparatus display;
(b) causing a second region to be displayed on a terminal display of the mobile communication terminal, the second region being a part of the to-be-displayed image corresponding to a relative position of the mobile communication terminal to the electronic apparatus; and
(c) causing a position indicating image to be displayed on the terminal display of the mobile communication terminal, the position indicating image showing a positional relationship between the first region and the second region on the to-be-displayed image.
